(19) United States
(12) Patent Application Publication
(10) Pub. No.: US 2017/0053329 A1
(43) Pub. Date: Feb. 23, 2017

(54) SYSTEMS AND METHODS FOR PROVIDING VENDOR MANAGEMENT AND CUSTOM PROFILES

(71) Applicant: Venminder, Inc., Elizabethtown, KY (US)

(72) Inventor: Dana Bowers, Elizabethtown, KY (US)

(21) Appl. No.: 15/241,338

(22) Filed: Aug. 19, 2016

Related U.S. Application Data
(60) Provisional application No. 62/208,073, filed on Aug. 21, 2015.
(60) Provisional application No. 62/348,847, filed on Jun. 10, 2016.

(51) Int. Cl. G06Q 30/06

(52) U.S. Cl. CPC G06Q 30/0609; G06Q 30/0641

(57) ABSTRACT

Methods and systems are presented herein for managing contracts between a financial institution and its vendors, for preparation of associated vendor oversight reports, and for securing subscriptions for a financial institution/vendor relationship management system. In one aspect, the invention is directed to a method for providing centralized management of vendor questionnaires. In another aspect, the invention is directed to a computer-implemented method for managing contracts between a financial institution and its vendors. In another aspect, the invention is directed to a financial institution/vendor relationship management system for managing contracts between a financial institution and its vendors and for preparation of associated vendor oversight reports. In yet another aspect, the invention is directed to a method for securing subscriptions for a financial institution/vendor relationship management system for managing contracts between a financial institution and its vendors, and for preparation of associated vendor oversight reports.

### CROSS-REFERENCE TO RELATED APPLICATIONS

This application claims priority to and the benefit of U.S. Provisional Patent Application Ser. No. 62/208,073, filed Aug. 21, 2015, entitled “Systems and Methods for Providing Vendor Management and Custom Profiles,” and U.S. Provisional Patent Application Ser. No. 62/348,847, filed Jun. 10, 2016, entitled “Systems and Methods for Providing Vendor Management and Custom Profiles,” the disclosures of which are incorporated herein by reference in their entireties.

### FIELD OF THE INVENTION

This invention relates generally to systems and methods for managing client/vendor relationships. More particularly, in certain embodiments, the invention relates to systems and methods for providing vendor management and custom profiles.

### BACKGROUND

Financial institutions such as banks and credit unions are increasingly relying on third-party vendors to perform various important functions. While this improves efficiency and reduces cost for the financial institution, there are various risks posed by such outsourcing. A financial institution must establish a vendor oversight program to mitigate such risks, comply with various regulations, and pass examination by auditors. Generally, maintaining oversight of different vendors and vendor products requires a coordination of large amounts of oversight requirements, tasks, documents, results, due dates, and individuals.

The vendor management process has historically been disjointed, messy, and time-consuming. A single financial institution may have numerous vendors to manage, and there may be many individuals within a given financial institution who deal with a given vendor and must coordinate collection of documents and data regarding the corresponding vendor products. Furthermore, the terms of various contracts between a financial institution and its vendors must be carefully monitored.

Moreover, financial institutions may wish to maintain different types of information about the vendors and vendor products with which they are associated. Traditional vendor management systems provide financial institutions to maintain information according to a predetermined set of fields.

There is a need for a consolidated, efficient system for managing contracts between a financial institution and its vendors and for preparation of associated vendor oversight reports. There is also a need for customizable vendor profiles that allow new fields of information to be maintained for each vendor. Moreover, there is a need for providing oversight management in a way that information about vendors, products, tasks, results, due dates, and the like can be centrally viewed, updated and output to compliance officers, board members and others.

### SUMMARY

Methods and systems are presented herein for managing contracts between a financial institution and its vendors, for preparation of associated vendor oversight reports, and for securing subscriptions for a financial institution/vendor relationship management system.

In one aspect, the invention is directed to a method for providing centralized management of vendor questionnaires, the method comprising the steps of: causing to display, by the processor of the enterprise system, one or more graphical user interfaces (GUIs) associated with the one or more vendor questionnaire modules, the vendor questionnaire modules comprising one or more members selected from the group consisting of: (i) a template management module for managing questionnaire templates; (ii) a questionnaire management module for managing questionnaires; (iii) a send questionnaire module for sending questionnaires to one or more vendors; and (iv) a vendor response module for managing responses from one or more vendors; and receiving, by a processor of an enterprise system, a first input from a first client (e.g., said first client having been authorized to access the enterprise system, e.g., said first client one member of a network of subscribed clients), the first input comprising instructions to access a selected module of the one or more vendor questionnaire modules; receiving, by the processor of the enterprise system, subsequent input from the first client specific to the selected vendor questionnaire module; and updating, in a memory of the enterprise system, vendor questionnaire management information stored in association with the first client, based on the subsequent input.

In some embodiments, the method comprises instructions to access the template management module, and wherein the subsequent input comprises custom data field information for a vendor questionnaire template (e.g., received via a graphical user interface widget), the custom data field information including a confidentiality statement and/or an introduction statement.

In some embodiments, the method comprises creating, by the processor, one or more questionnaire templates incorporating the confidentiality statement and/or the introduction statement.

In some embodiments, first input comprises instructions to access the questionnaire management module, and the subsequent input comprises a questionnaire selection.

In some embodiments, the first input comprises instructions to access the questionnaire management module, and the subsequent input comprises custom data field information for a vendor questionnaire template (e.g., received via a graphical user interface widget), the custom data field information including edits to a questionnaire.

In some embodiments, a subsequent input comprises a questionnaire selection, wherein the selected questionnaire is created from a questionnaire template or by cloning an existing questionnaire.

In some embodiments, the first input comprises instructions to access the send questionnaire module, and the subsequent input comprises a recipient vendor selection (e.g., an in-network, authorized, or otherwise registered vendor).

In some embodiments, a subsequent input comprises a questionnaire selection.

In some embodiments, the method comprises providing, to a user, an editable email template.

In some embodiments, a subsequent input comprises custom data field information for an email template (e.g., received via a graphical user interface widget), the custom data field information including edits to an email.

In some embodiments, a subsequent input comprises a send command (e.g., received via a graphical user interface widget), and the method comprises attaching, by the processor, a selected questionnaire to an email message and sending, via a network, said email message to the selected vendor having a vendor email address.

In some embodiments, the method comprises searching, by the processor, prior to sending the email message, the vendor email address in a database of vendor email addresses of known contacts and, if (e.g., and only if) a match is found, releasing the email message to be sent to the vendor email address; and optionally, if no match is found, preventing the email message from being sent to the vendor email address.

In some embodiments, the method comprises providing functionality to the email message that prevents the email message from being forwarded to an unauthorized recipient.

In some embodiments, the method comprises providing functionality to the email message that prevents the email message from being sent to a generic email address (e.g. @gmail.com, @hotmail.com).

In some embodiments, the first input comprises instructions to access the vendor response module, and the subsequent input comprises custom data field information for a vendor questionnaire template (e.g., received via a graphical user interface widget), the custom data field information including user comment text.

In some embodiments, the method comprises providing, (e.g., via the vendor response GUI), status information of each sent questionnaire (e.g., sent, completed, in progress).

In some embodiments, the method comprises displaying, via a vendor response GUI, a grid comprising a sortable list of sent questionnaires.

In one aspect, the invention is directed to a computer-implemented method for managing contracts between a financial institution and its vendors, the method comprising the steps of: (a) providing, by a processor of a computing device, a first graphical user interface (e.g., main dashboard or vendor dashboard) configured to display, for a given financial institution, a listing of vendor products and, upon selection of a listed vendor product by a user, to display details regarding the selected vendor product; (b) providing, by the processor, a second graphical user interface (e.g., upload widget) configured to facilitate uploading, by the user, of one or more contracts (and/or other documents) associated with the selected vendor product (e.g., for archival in the cloud, or other decentralized or centralized storage/archival server); (c) providing, by the processor, a third graphical user interface (e.g., guided exam prep workflow, series of widgets) configured to guide a user in preparation of a vendor oversight report associated with the selected vendor product (e.g., or associated with multiple products from a selected vendor); and (d) displaying, by the processor, a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In some embodiments, the method comprises determining, by the processor, whether one or more uploaded contracts associated with the selected vendor product has an upcoming critical date (e.g., renewal date), activating an alert if a threshold in relation to the critical date and current date is met (e.g., critical date is 6 months away, 3 months away, etc.), and displaying an alert widget corresponding to the activated alert.

In some embodiments, the method comprises providing, by the processor, a graphical user interface configured to display one or more prompts for user entry of one or more of the following items corresponding to a selected vendor product or an associated uploaded contract: a contract renewal deadline, a vendor benchmark, a risk rating, a performance rating, a performance comment, a status (e.g., In-Term, Renewal Negotiation, Auto-Renew, Cancelled, or Replace), and contact information (e.g., name, email address, phone number) of a collaborator. In some embodiments, the one or more items prompted for user entry comprises a performance rating and a performance comment associated with the selected vendor product, wherein the entered performance rating is received anonymously (e.g., without association with the user entering the rating) and is compiled in a set of performance ratings received for the given vendor product by a plurality of users, wherein the method comprises displaying a composite performance rating and/or a listing of one or more performance comments received from users of the given vendor product (e.g., wherein the plurality of users represent a plurality of financial institutions). In some embodiments, the method comprises displaying, by the processor, the composite performance rating and/or the listing of one or more performance comments received from users of the given vendor product and/or one or more corresponding products provided by one or more different vendors. In some embodiments, the method comprises displaying, by the processor, one or more of the following corresponding to a given performance comment: a “like” prompt, a “dislike” prompt, a flag to identify inappropriate content. In some embodiments, the method comprises displaying a listing of a plurality of performance comments received from users of the given vendor product, wherein the listing is ordered on the graphical user interface according to popularity (e.g., number of “likes” received for each of the performance comments).

In some embodiments, the method comprises providing a graphical communication portal (e.g., a ‘private message’ window) allowing a user to anonymously solicit a textual message regarding a given vendor product by the vendor and/or to anonymously solicit a textual message regarding a given performance rating or performance comment by the user who provided the given performance rating or performance comment.

In some embodiments, the method comprises storing the one or more contracts and/or other documents associated with the selected vendor product (e.g., in the cloud, or other decentralized or centralized storage/archival server), and displaying icons and/or text corresponding to a set of folders for organizing the documents associated with the selected vendor product. In some embodiments, the set of folders for organizing the documents associated with the selected vendor product comprises a compliance document folder with text indicating it contains compliance documents. In some embodiments, selection by the user of the compliance document folder results in presentation, by the processor, of a set of subfolders, wherein the set of subfolders comprises text indicating one or more of the following categories: Audit/IT, Business Continuity, Financial, Insurance, Miscellaneous, Policy, and Product Management.

In some embodiments, the one or more items prompted for user entry comprises contact information (e.g., name, email address, phone number) of one or more collaborators for the selected vendor product. In some embodiments, the method comprises restricting access to stored documents and/or other information (e.g., reminders, notes, emails, etc.) regarding the selected vendor product, and/or restricting ability to upload documents and/or other information (e.g., reminders, notes, emails, etc.) pertaining to the selected vendor product, to a group of collaborators at a given financial institution named for that vendor product.

In some embodiments, step (c) comprises providing, by the processor, a guided workflow configured to guide a user in preparation of a vendor oversight report associated with the selected vendor product, wherein the guided workflow comprises a series of widgets (e.g., where a widget is a window, a text box, a button, a hyperlink, a drop-down list, a list box, a combo box, a check box, a radio button, a cycle button, a datagrid, a spinner, a menu, a menu bar, a toolbar, an icon, a tree view, a grid view, a link, a tab, and/or a scroll bar) prompting entry (e.g., sequential entry) or upload of one or more of the following: (i) the risk level associated with the selected vendor product; (ii) a date of next regulatory exam (e.g., wherein the method provides, by the processor, one or more reminder notification emails to the user based on the date of next regulatory exam); (iii) a selection of agency(ies) that apply to the financial institution user (e.g., CFPBC, FDIC, FED, NCUA, OCC, e.g., wherein the method provides, by the processor, a format for and/or fillable content for the vendor oversight report based on the selected agency(ies)); (iv) documents for use in preparation of the vendor oversight report (e.g., wherein the method displays, by the processor, a listing of previously uploaded documents associated with the selected vendor product alongside a listing of suggested document types for inclusion in the vendor oversight report, said suggested document types identified based on the risk level associated with the selected vendor product, e.g., wherein the method provides a widget that facilitates, by the processor, a drag-and-drop by the user of items from the listing of uploaded documents onto a corresponding suggested document type to identify said uploaded document as a document of said type, for inclusion of the linked uploaded document in the vendor oversight report); (v) textual commentary regarding the selected vendor product and/or the vendor of the selected vendor product; and (vi) a request for assistance (e.g., assistance by a collaborator associated with the selected vendor product or by another worker at the financial institution of the user). In some embodiments, the guided workflow displays a current status of the vendor oversight report associated with the selected vendor product (e.g., Not Started, Waiting on expert, Waiting for documents, Skipped, In Progress, or Complete). In some embodiments, the guided workflow displays a visual checklist of documents the financial institution has received from the vendor regarding the selected vendor product, and documents remaining to be obtained from the vendor prior to completion of the vendor oversight report associated with the selected vendor product.

In some embodiments, the method is a computer-implemented method for managing contracts between a financial institution and its vendors and for preparation of associated vendor oversight reports as part of a financial institution/vendor relationship management system.

In some implementations, the method may include providing, by the processor, a graphical user interface configured to display one or more prompts for a user entry associated with a risk assessment of a given vendor product (e.g., wherein the given vendor product is related to at least one of Information Access, Operational and Financial Dependency, and Regulatory Exposure). The user entry may be in response to a set of questionnaires.

In some implementations, the graphical user interface may provide a dashboard that displays all of the existing risk-assessment evaluation and the completed risk-assessment evaluation performed by a given organization associated to an end-user. The graphical user interface may display a first list of vendor products having never had a risk assessment completed, a second list of vendor products having an annual risk assessment due, and a third list of vendor products that are currently being assessed or have been completed within the last year.

In some implementations, the method may include determining, by the processor, whether a request to initiate risk assessment for the given vendor product is a duplicate of an existing risk-assessment evaluation or a completed risk-assessment evaluation. The method may include preventing, by the processor, the request from initiating a new risk-assessment evaluation for the same product.

In another aspect, the invention is directed to a financial institution/vendor relationship management system for managing contracts between a financial institution and its vendors and for preparation of associated vendor oversight reports, the system comprising: a data management module configured to store data (e.g., documents and/or information) pertaining to a set of vendor products for a financial institution, said data accessible by a computing device (e.g., a portable computing device), the computing device comprising: a processor; and a non-transitory computer readable medium storing instructions thereon, wherein the instructions, when executed, cause the processor to: (a) provide a first graphical user interface (e.g., main dashboard or vendor dashboard) to display on the computing device, for a given financial institution, a listing of vendor products and, upon selection of a listed vendor product by a user via the computing device, to display details regarding the selected vendor product; (b) provide a second graphical user interface (e.g., an upload widget) on the computing device to facilitate uploading, by the user, of one or more contracts (and/or other documents) associated with the selected vendor product via the computing device (e.g., for archival in the cloud, or other decentralized or centralized storage/archival server); (c) provide a third graphical user interface (e.g., guided exam prep workflow, series of widgets) on the computing device to guide a user in preparation of a vendor oversight report associated with the selected vendor product (e.g., or associated with multiple products from a selected vendor); and (d) display on the computing device a graphical user interface widget configured to allow selection of a risk level associated with the selected vendor product, the widget configured such that selection of a risk level results in display, by the third graphical user interface, of a listing of suggested compliance documents for use in the preparation of the vendor oversight report, the listing of suggested compliance documents being associated with the selected risk level.

In another aspect, the invention is directed to a method for securing subscriptions for a financial institution/vendor relationship management system for managing contracts between a financial institution and its vendors and for preparation of associated vendor oversight reports, the method comprising the steps of: (a) providing, by a processor of a computing device, a web-based graphical user interface that facilitates uploading by a vendor of compliance documentation; (b) displaying, by the processor, one or more widgets (e.g., where a widget is a window, a text box, a button, a hyperlink, a drop-down list, a list box, a combo box, a check box, a radio button, a cycle button, a data-grid, a spinner, a menu, a menu bar, a toolbar, an icon, a tree view, a grid view, a link, a tab, and/or a scroll bar) prompting secure upload (e.g., to the cloud, or other decentralized or centralized storage/archival server) of compliance documents associated with a given vendor product owned by a financial institution identified by the vendor and/or prompting entry, by the vendor, of one or more of: (i) compliance data, and (ii) financial institution contact information (e.g., email address) associated with the given vendor product; and (c) sending, by the processor, an email notification to the financial institution identified by the vendor that compliance data and/or compliance documents have been uploaded by the vendor, wherein the email notification comprises an invitation to the financial institution to enter into a subscription to retrieve the uploaded data and/or documents via the relationship management system. In some embodiments, the method comprises displaying, by the processor, an invitation to a user at the financial institution an offer to upgrade the subscription (e.g., where an initial subscription is free, and an upgrade is available to manage more than one vendor product and/or to expand available storage space for archival of uploaded data and/or documents corresponding to a vendor product. In some embodiments, the subscription includes use of the financial institution/vendor relationship management system.

In some embodiments, a method is provided for centralized vendor management, comprising: receiving, by a processor of an enterprise system, a first input from a first client device, the first input comprising first instructions to access one or more management widgets; causing to display, by the processor of the enterprise system, one or more graphical user interfaces associated with the one or more management widgets, the management widgets being selected from the group consisting of: (i) a vendor profile widget for managing vendor profiles; (ii) an oversight grid widget for providing grid-based oversight of oversight requirements; (iii) a task widget managing tasks associated with oversight requirements; (iv) an oversight management widget for managing tasks and oversight requirements associated with vendors and/or vendor products; (v) a document widget for managing documents associated with tasks;

(vi) an administrator widget for managing users; (vii) a dashboard widget for managing outstanding tasks and vendor products associated with users; and (viii) a reports widget for generating status, task and/or vendor reports; receiving, from the first client device, one or more widget inputs via the management widgets; and updating, in a memory of the enterprise system, vendor management information stored in association with the first client device, based on the one or more widget inputs.

In some example embodiments, the first instructions are instructions to select at least the vendor profile widget, the vendor management information associated with the first client device includes vendor profiles corresponding to vendors, the method further comprises receiving, in a widget input via the vendor profile widget, custom data field information, the custom data field information including at least a label and answer format, and the updating the vendor management information comprises adding the custom data field information to at least a portion of the vendor profiles.

In some example embodiments, the vendor management information includes a vendor category corresponding to each of one or more vendors.

In some example embodiments, the oversight grid widget comprises one or more oversight requirements associated with one or more vendors.

In some example embodiments, the oversight grid widget comprises, for each of the one or more vendors, an indication of whether each of the oversight requirements is required.

In some example embodiments, if one of the one or more oversight requirements is required for at least one of the vendors, the method further comprises: causing to display, by the processor of the enterprise system, the task widget; receiving, via the task widget, task information associated with the one of the one of the one or more oversight requirements and the at least one of the vendors; and updating the vendor management information stored in association with the first client device to include the task information.

In some example embodiments, the first client device corresponds to (e.g., is operated by, is managed by, is owned by) a user of the enterprise system.

In some example embodiments, a single graphical user interface associated with a plurality of the management widgets is caused to be displayed.

In some example embodiments, the oversight management information comprises vendor information associated with one or more vendors, the vendor information associated with each of the one or more vendors including a corresponding one or more of a task, task description, owner and status, the oversight management widget comprises a table of tasks and the corresponding vendor information.

In some example embodiments, the first instructions are instructions to select at least the reports widget, the reports widget is used to generate one or more of a status report, a task report, and a vendor report based at least in part on the vendor management information, and wherein the vendor management information includes, in association with one or more vendors or vendor products, one or more of: a vendor name, product name, category, critical vendor indicator, risk rating, national provider identifier (NPI) access indicator, contact information, best current practices information (e.g., last completed, next due), contract review information (e.g., last completed, next due), and oversight item.

In some example embodiments, a system is provided for centralized vendor management, comprising: at least one memory operable to store vendor management information in association with a first client device; and a processor communicatively coupled to the at least one memory, the processor being operable to: receive a first input from the first client device, the first input comprising first instructions to access one or more management widgets; cause to display one or more graphical user interfaces associated with the one or more management widgets, the management widgets being selected from the group consisting of: (i) a vendor profile widget for managing vendor profiles; (ii) an oversight grid widget for providing grid-based oversight of oversight requirements; (iii) a task widget managing tasks associated with oversight requirements; (iv) an oversight management widget for managing tasks and oversight requirements associated with vendors and/or vendor products; (v) a document widget for managing documents associated with tasks; (vi) an administrator widget for managing users; (vii) a dashboard widget for managing outstanding tasks and vendor products associated with users; and (viii) a reports widget for generating status, task and/or vendor reports; receive, from the first client device, one or more widget inputs via the management widgets; and update the vendor management information stored in association with the first client device, based on the one or more widget inputs.

In some example embodiments, the first instructions are instructions to select at least the vendor profile widget, the vendor management information associated with the first client device includes vendor profiles corresponding to vendors, the method further comprises receiving, in a widget input via the vendor profile widget, custom data field information, the custom data field information including at least a label and answer format, and wherein the updating the vendor management information comprises adding the custom data field information to at least a portion of the vendor profiles.

In some example embodiments, the vendor management information includes a vendor category corresponding to each of one or more vendors.

In some example embodiments, the oversight grid widget comprises one or more oversight requirements associated with one or more vendors.

In some example embodiments, the oversight grid widget comprises, for each of the one or more vendors, an indication of whether each of the oversight requirements is required.

In some example embodiments, if one of the one or more oversight requirements is required for at least one of the vendors, and wherein the processor is further operable to: cause to display, by the processor of the enterprise system, the task widget; receive, via the task widget, task information associated with the one of the one of the one or more oversight requirements and the at least one of the vendors; and update the vendor management information stored in association with the first client device to include the task information.

In some example embodiments, the first client device corresponds to (e.g., is operated by, is managed by, is owned by) a user of an enterprise system.

In some example embodiments, a single graphical user interface associated with a plurality of the management widgets is caused to be displayed.

In some example embodiments, the oversight management information comprises vendor information associated with one or more vendors, the vendor information associated with each of the one or more vendors including a corresponding one or more of a task, task description, owner and status, and wherein the oversight management widget comprises a table of tasks and the corresponding vendor information.

In some example embodiments, the first instructions are instructions to select at least the reports widget, and wherein the reports widget is used to generate one or more of a status report, a task report, and a vendor report based at least in part on the vendor management information, and wherein the vendor management information includes, in association with one or more vendors or vendor products, one or more of: a vendor name, product name, category, critical vendor indicator, risk rating, national provider identifier (NPI) access indicator, contact information, best current practices information (e.g., last completed, next due), contract review information (e.g., last completed, next due), and oversight item.

The description of elements of the embodiments with respect to one aspect of the invention can be applied to another aspect of the invention as well. For example, features described in a claim depending from an independent method claim may be applied, in another embodiment, to an independent system claim.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a block diagram of an example system for managing contracts between a financial institution and its vendors.

FIG. 2 is a block diagram of the example system for managing contracts between the financial institution and its vendors in accordance with an embodiment of the invention.

FIG. 3 is an example main dashboard in accordance with an embodiment of the invention.

FIG. 4 is an example vendor dashboard in accordance with an embodiment of the invention.

FIG. 5 is an example document storage page in accordance with an embodiment of the invention.

FIG. 6 is an example workflow of the system in guiding an end-user in preparing a vendor oversight report associated with one or more selected vendor products in accordance with an embodiment of the invention.

FIG. 7 is an example vendor exam preparation workspace in accordance with an embodiment of the invention.

FIG. 8 is an example workspace for collecting documents by matching collected end-user's document to a list of suggested documents in accordance with an embodiment of the invention.

FIG. 9 is an example workspace for collecting documents by prompting the end user for selection of actions for unassigned documents that have been provided by the end user in accordance with an embodiment of the invention.

FIG. 10 is an example workspace for collecting documents by prompting the end user for selection of actions for unassigned suggested documents in accordance with an embodiment of the invention.

FIG. 11 is an example workspace for preparing a collected document for the examination report in accordance with an embodiment of the invention.

FIG. 12 is an example workspace for uploading document to be attached and included in the examination in accordance with an embodiment of the invention.

FIG. 13 is an example workspace to previewing contents to be included in the examination report.

FIG. 14 is an example workspace to review vendor products in accordance with an embodiment of the invention.

FIG. 15 is an example display for viewing product review in accordance with an embodiment of the invention.

FIG. 16 is an example alert and information display in accordance with an embodiment of the invention.

FIG. 17 is an example workspace for performing a risk-assessment evaluation of a vendor product in accordance with an embodiment of the invention.

FIG. 18 is an example workspace to initiate a new risk assessment of a vendor product in accordance with an embodiment of the invention.

FIG. 19 is an example workspace to view risk assessments that are in-progress in accordance with an embodiment of the invention.

FIG. 20 is an example workspace to view completed risk-assessment evaluations in accordance with an embodiment of the invention.

FIG. 21 is an example dashboard to manage risk-assessment evaluation of vendors and vendor products in accordance with an embodiment of the invention.

FIG. 22 is an example risk-assessment workspace in accordance with an embodiment of the invention.

FIG. 23 is an example invitation-workspace 2300 to invite peers to contribute to a risk-assessment evaluation in accordance with an embodiment of the invention.

FIG. 24 is an example request-message for peer collaborative input for a given risk-assessment evaluation in accordance with an embodiment of the invention.

FIG. 25 illustrates a vendor profile GUI and/or widget according to an exemplary embodiment.

FIG. 26A illustrates a GUI and/or widget for customizing fields in a vendor profile, according to an exemplary embodiment.

FIG. 26B illustrates a GUI and/or widget for adding custom data fields to a vendor profile, according to an exemplary embodiment.

FIG. 27 illustrates a GUI and/or widget for providing oversight management in a profile grid, according to an exemplary embodiment.

FIG. 28A illustrates a task GUI and/or widget for adding oversight tasks, according to an exemplary embodiment.

FIG. 28B illustrates a task GUI and/or widget for adding oversight tasks, according to an exemplary embodiment.

FIG. 29A illustrates a GUI and/or widget for customizing items and/or tasks associated with an oversight requirement, according to an exemplary embodiment.

FIG. 29B illustrates a GUI and/or widget for customizing items and/or tasks associated with an oversight requirement, according to an exemplary embodiment.

FIG. 30 illustrates an oversight management GUI and/or widget according to an exemplary embodiment.

FIG. 31 illustrates a snooze GUI and/or widget for “snoozing” a task according to an exemplary embodiment.

FIG. 32 illustrates an expanded task GUI and/or widget according to an exemplary embodiment.

FIG. 33 illustrates an expanded task GUI and/or widget according to an exemplary embodiment.

FIG. 34 illustrates a GUI and/or widget for managing documents associated with oversight tasks, according to an exemplary embodiment.

FIG. 35 illustrates a GUI and/or widget for collecting documents according to an exemplary embodiment.

FIG. 36A illustrates a GUI and/or widget for providing executive level analysis of oversight requirements according to an exemplary embodiment.

FIG. 36B illustrates a GUI and/or widget for providing executive level analysis of oversight requirements according to an exemplary embodiment.

FIG. 37 illustrates a GUI and/or widget for managing users according to an exemplary embodiment.

FIG. 38A illustrates a GUI and/or widget for reassigning a single task or work item to another user, according to an exemplary embodiment.

FIG. 38B illustrates a GUI and/or widget for reassigning all oversight management work items associated with one user to another user, according to an exemplary embodiment.

FIG. 39 illustrates an enterprise dashboard GUI and/or widget, according to an exemplary embodiment.

FIG. 40 illustrates a GUI and/or widget of a weekly overview according to an exemplary embodiment.

FIG. 41A illustrates a GUI and/or widget for generating an oversight status report according to an exemplary embodiment.

FIG. 42A illustrates a GUI and/or widget for generating a task report according to an exemplary embodiment.

FIG. 43A illustrates a GUI and/or widget for generating a vendor dashboard report for a particular vendor, according to an exemplary embodiment.

FIG. 43B illustrates a GUI and/or widget for generating a vendor dashboard report for a particular vendor, according to an exemplary embodiment.

FIG. 43C illustrates a GUI and/or widget for generating a vendor dashboard report for a particular vendor, according to an exemplary embodiment.

FIG. 44 illustrates a Main Dashboard GUI according to an exemplary embodiment, including a tab to navigate to a questionnaire function.

FIG. 45 illustrates a Questionnaire Landing Page GUI according to an exemplary embodiment.

FIG. 47 illustrates a Manage Questionnaires GUI to manage questionnaires according to an exemplary embodiment.

FIG. 48 illustrates a Create Questionnaire GUI to create a questionnaire according to an exemplary embodiment.

FIG. 49 illustrates a GUI and/or widget to preview a questionnaire according to an exemplary embodiment.

FIG. 50 illustrates a Create Questionnaire Landing Page GUI according to an exemplary embodiment.

FIG. 51 illustrates a GUI and/or widget for a saved but unpublished questionnaire grid listing according to an exemplary embodiment.

FIG. 52 illustrates a GUI and/or widget for publishing a questionnaire (Publish Confirmation Modal) according to an exemplary embodiment.

FIG. 53 illustrates an Edit Questionnaire GUI for editing and constructing a questionnaire e.g., adding, deleting, or rearranging sections and/or questions, according to an exemplary embodiment.

FIG. 54 illustrates a GUI and/or widget for cloning a questionnaire (Clone Confirmation Modal) according to an exemplary embodiment.

FIG. 55 illustrates a GUI and/or widget for deleting a questionnaire and optionally confirming deletion (Delete Confirmation Modal) according to an exemplary embodiment. A user can navigate here, e.g., by clicking “Delete” on the Manage Questionnaires GUI.

FIG. 56 illustrates a Send Questionnaire GUI to send a questionnaire according to an exemplary embodiment.

FIG. 57 illustrates a GUI and/or widget for adding a new vendor (Add New Vendor Contact Modal) according to an exemplary embodiment.

FIG. 58 illustrates a GUI and/or widget for sending a questionnaire and selecting a questionnaire to be sent (Send Questionnaire selection screen) according to an exemplary embodiment.

FIG. 59 illustrates a GUI and/or widget for entering a display name and/or rename a questionnaire according to an exemplary embodiment.

FIG. 60A illustrates a GUI and/or widget for providing a custom message (Custom Messages) according to an exemplary embodiment.

FIG. 60B illustrates a GUI and/or widget to preview and send a questionnaire according to an exemplary embodiment.

FIG. 61A illustrates a GUI and/or widget to confirm that a questionnaire is to be sent (Send Confirmation Modal) according to an exemplary embodiment.

FIG. 61b illustrates a GUI and/or widget to confirm that a questionnaire has been sent (Send Acknowledgement Modal) according to an exemplary embodiment.

FIG. 62 illustrates a Vendor Responses GUI to monitor status and/or select individual responses to review or edit according to an exemplary embodiment.

FIG. 63 illustrates a View Vendor Response GUI according to an exemplary embodiment.

FIG. 64 illustrates a GUI and/or widget to generate and/or download a file (Download (Generate) Confirmation Modal or Download Generating Modal) according to an exemplary embodiment.

FIG. 65 illustrates a GUI and/or widget to save a file (Save Questionnaire Confirmation Modal/Save to File Confirmation Modal) according to an exemplary embodiment.

FIG. 66 illustrates a GUI and/or widget to view vendor comments (Vendor Comments) according to an exemplary embodiment.

FIG. 67A illustrates a Document Storage GUI according to an exemplary embodiment.

FIG. 67B illustrates a Document Storage GUI according to an exemplary embodiment.

FIG. 68 illustrates a Vendor Home Page/Vendor Dashboard GUI according to an exemplary embodiment.

FIG. 69 illustrates a Vendor Questionnaire Grid GUI according to an exemplary embodiment.

FIG. 70 illustrates an Edit Vendor Questionnaire GUI, where a vendor can supply answers to the questions presented in a questionnaire, according to an exemplary embodiment. A user navigates here by selecting Edit on the Vendor Questionnaire Grid GUI.

FIG. 71A illustrates a GUI and/or widget to invite contributors (Invite Contributor Modal) according to an exemplary embodiment.

FIG. 71B illustrates a GUI and/or widget to add new contact and/or user according to an exemplary embodiment.

FIG. 72 illustrates a GUI and/or widget to cancel an operation (Cancel Modal) according to an exemplary embodiment.

FIG. 73 illustrates a GUI and/or widget to mark a questionnaire as complete (Complete Questionnaire Confirmation Modal) according to an exemplary embodiment.

FIG. 74 illustrates a GUI and/or widget to decline to complete a questionnaire (Decline Questionnaire Confirmation Modal) according to an exemplary embodiment.

FIG. 75 illustrates a GUI and/or widget to view a vendor questionnaire (View Vendor Questionnaire) according to an exemplary embodiment.

FIG. 76 is a block diagram of an example network environment for use in the methods and systems for analysis of spectrometry data, according to an illustrative embodiment.

FIG. 77 is a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Methods and systems are presented herein for managing contracts between a financial institution and its vendors, for preparation of associated vendor oversight reports, and for securing subscriptions for a financial institution/vendor relationship management system.

In certain embodiments, a web-based system is provided for improved vendor contract management, enhanced collaboration within a financial institution, and organized, step-by-step vendor oversight report preparation. For example, the contract management feature allows financial institutions to store contracts, enter key terms and other information in order to set reminders and benchmark against like vendors. The collaboration feature allows multiple users of a given financial institution to store documentation, set reminders, make notes, upload emails, and the like, for purposes of managing various aspects of a vendor relationship, including day-to-day service management, accounts payable, and risk management. The vendor rate-and-review feature allows financial institutions to rate and review individual vendor products and see the ratings and reviews that other financial institutions have provided. In certain embodiments, a star rating system is employed, and open comments may be provided by name or anonymously. Inappropriate comments may be flagged, and listings of reviews may be ranked by popularity.

In certain embodiments, the examination preparation feature provides a guided workflow-driven process for building a complete report for auditors and examiners. It provides a process for matching risk ratings to suggested risk management content that a financial institution should review annually for at least their high-to-moderate risk vendors. Then, vendor documentation is matched to suggested content, creating a visual checklist of what the financial institution has received from the vendor and what they are missing and may still need to collect. This allows for general, more strategic level comments at the vendor and product level, and supports specific review of each document provided by the vendor. A financial institution user may invite an expert (from within the same financial institution) for help with complex document reviews such as IT audits or financials. Output is a compiled report of all financial institution comments, supporting documentation, and vendor documents.

Embodiments of the system architecturally bridge relationships between financial institutions and their vendors so that there is only ever a single instance of a given financial institution or vendor in the system. This allows aggregation of information for vendors providing similar products, financial institutions with similar characteristics, and provides for other synergies. There is a high degree of user-friendliness, because backbone data can be shared (e.g., primary financial institution and vendor records), without compromising private data that an individual financial institution or vendor enters that should not be exposed to others.

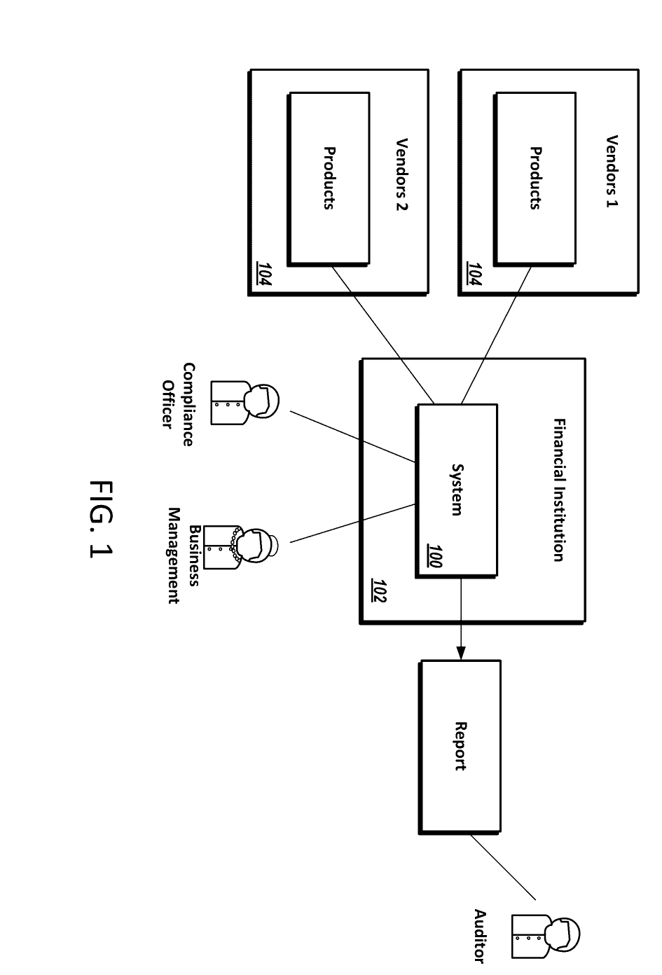

FIG. 1 is a block diagram of an example system 100 to assist financial institutions 102 to manage vendors 104 in accordance with an embodiment of the invention. In some implementations, the system 100 provides guided workflow i) to manage contracts with a given vendor 104, to provide a guided workflow to assist the financial institution 102 to prepare for an compliance or contract audit examination, ii) to provide a rating system of the vendors 104 and their products and services, iii) to provide a risk-assessment rating-system for the vendors 104, and iv) to provide mechanisms for collaboration, the tracking of communication, and document storage.

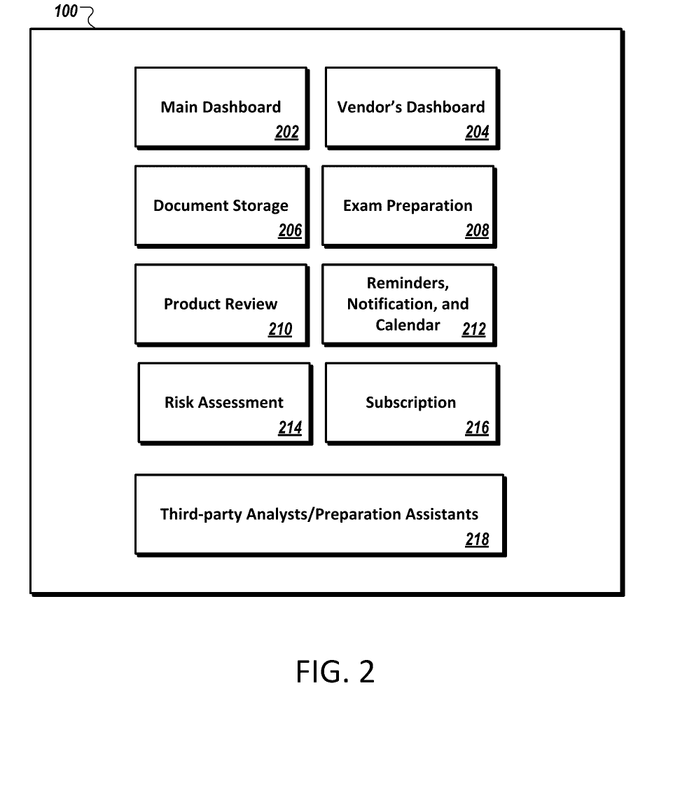

FIG. 2 is a block diagram of the example system 100 for managing contracts between the financial institution and its vendors in accordance with an embodiment of the invention. The system 100 may include a main dashboard 202 for managing actions associated with a given vendor 104 and to track such actions. The system 100 may include a vendor dashboard 204 to view and manage products and vendors associated with a given financial institution. The system 100 may include a document storage page 206 to view and manage documents associated with the vendors and their products. In some implementations, the document storage page 206 may be accessible via the main dashboard 202 and the vendor dashboard 204.

The system 100 may include a reminder, notification, and/or calendar function 212. The function 212 may manage and store a list of dates associated with expiration of a given document or contract as well as a list of personal reminders provided by the end-users. The function 212 may display such reminders in a calendar display. The function 212 may send notifications to the end-user based on pre-defined rules associated with an examination. The rules may be related to the expiration date of a given product or agreement, a scheduled examination, a risk-assessment evaluation, and etc.

The function 212 may include an alert and/or information feed (e.g., new documents uploaded, new reviews added, status update on a given examination or preparation process, etc.). The alert may include a progress bar to indicate a given end-user progress with a given task.

The alert may include an experience bar to indicate a given end-user usage level associated with the various functions of the system 100.

The system 100 may include a risk-assessment module 214 to guide an end-user in assigning a risk rating for a given vendor and/or product. The risk-rating may be utilized as part of the reporting of the compliance and/or contract audit examination. In some implementations, the risk rating may be used to determine the types of information and the types of documents to include in the examination report.

The system 100 may include a subscription module 216. The subscription module 216 may manage and maintain usage by the end-user of the various system's components (e.g., 202, 204, 206, 208, 210, 212, and 214) for a given financial institution. The system 100 may monitor the end-user's action, such as the usage of complimentary tools and document storage, purchases of additional tools and document storage, purchases of enterprise features, among others.

In some example embodiments, the system may include one or more modules for executing, providing and/or causing to display one or more graphical user interfaces (GUIs) and/or widgets. The GUIs and/or widgets may include a vendor profile widgets for, among other things, managing vendor profiles; oversight grid widgets for, among other things, providing grid-based oversight of oversight requirements; task widgets for, among other things, managing tasks associated with oversight requirements; oversight management widgets for, among other things, managing tasks and oversight requirements associated with vendors and/or vendor products; document widgets for, among other things, managing documents associated with tasks; administrator widgets for, among other things, managing users; dashboard widgets for, among other things, managing outstanding tasks and vendor products associated with users; and reports widgets for, among other things, generating status, task and/or vendor reports.

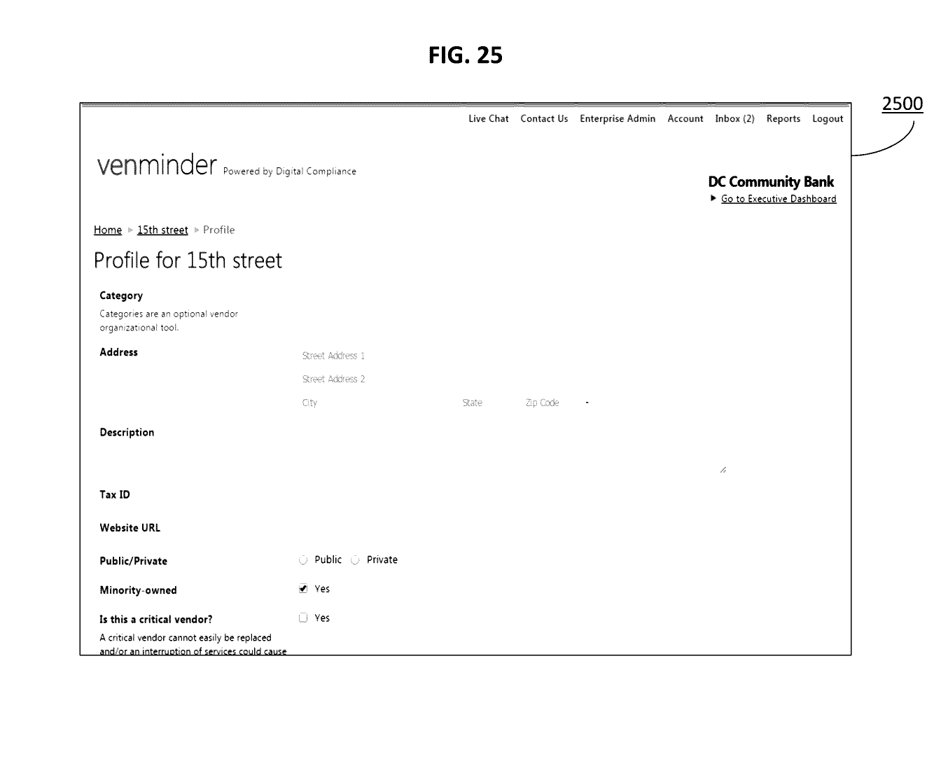

In some example embodiments, data associated with vendors (e.g., vendor management information), which is used by the GUIs and/or widgets, may be stored in a memory of the system 100 or of a client computing device associated with the system 100. In some example embodiments, the system 100 is an enterprise system with which one or more enterprise client computing devices are connected. The GUIs and/or widgets are described in further detail below with reference to FIGS. 25-44.

Main Dashboard

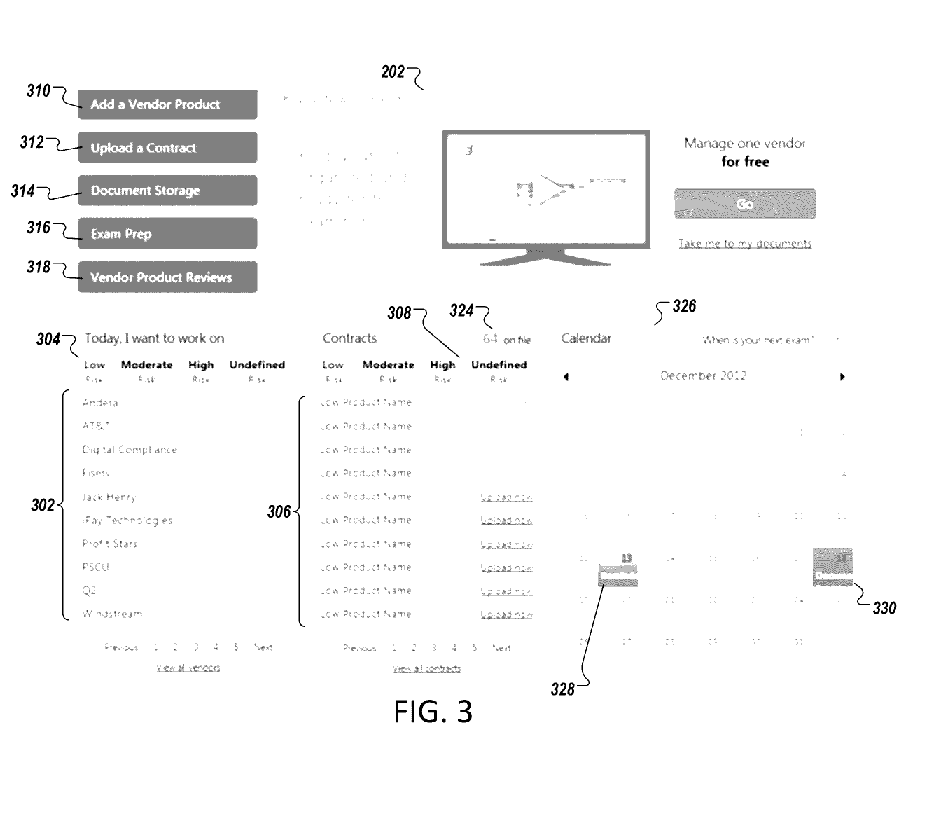

FIG. 3 is an example main dashboard 202 in accordance with an embodiment of the invention. The main dashboard 202 may be used to initiate the various functions, as described in relation to FIG. 2. The main dashboard 202 may display a vendor list 302, which may be organized and filtered by a vendor's risk level 304 (e.g., low, medium, high, or undefined/unknown). The main dashboard 202 may display a contract list 306, which may also be organized and filtered by risk levels 308. The main dashboard 202 may display a number of contracts on file (324), such as those stored in the document storage 206.

The main dashboard 202 may include a calendar 326 that displays reminder dates 328 and expiration dates 330 of contracts, of risk assessment of vendors and/or products, as well as of upcoming examinations. In some implementations, the calendar 326 may include dates in which notifications will be sent by the system. In some implementations, the calendar 326 may only display the expiration dates for documents that are uploaded by the end-user.

In some implementations, upon selecting a date in the calendar 326, the system 100 may prompt the end-user to create a reminder (e.g., for email communication, SMS-message, and other methods of notification accessible to and specified by the end-user). The system 100 may display a content of a reminder when the end-user hovers the cursor thereover. The calendar may be a part of the reminders, notification, and calendar function 212. The alerts and reminders of the calendar 326 may be employed to notify the end-user of upcoming critical dates (e.g., renewal date). The notification may be generated based on the date of the given activity having met an alert condition (e.g., exceeding a date threshold in relation to the critical date).

The main dashboard 202 may include a function to add a vendor product (310), a function to upload a contract associated with a given product (312), a function to manage stored documents (314), a function to prepare for an examination (316), and a function to review and manage reviews for a given vendor products (318).

The main dashboard 202 may be displayed to the users upon login to the system 100.

In some implementations, when adding a new vendor product (310), the system 100 may present the end user with a list of products. The list may include all products associated to the financial institution, including those that are not currently being managed by any of the end-user of that institution as well as those that do not have a contract loaded. The list of products may be maintain within a database that is managed by the system 100.

When adding a new vendor product, the system 100 may present the end-user with a list of questions associated with the product. The questions may include a request for the vendor name, the product name, the product type, and a risk level. The risk level may be defined as low, medium, high, and undefined (as corresponding to the risk level 304). Alternatively, the risk level may be an input from the risk-assessment module 214.

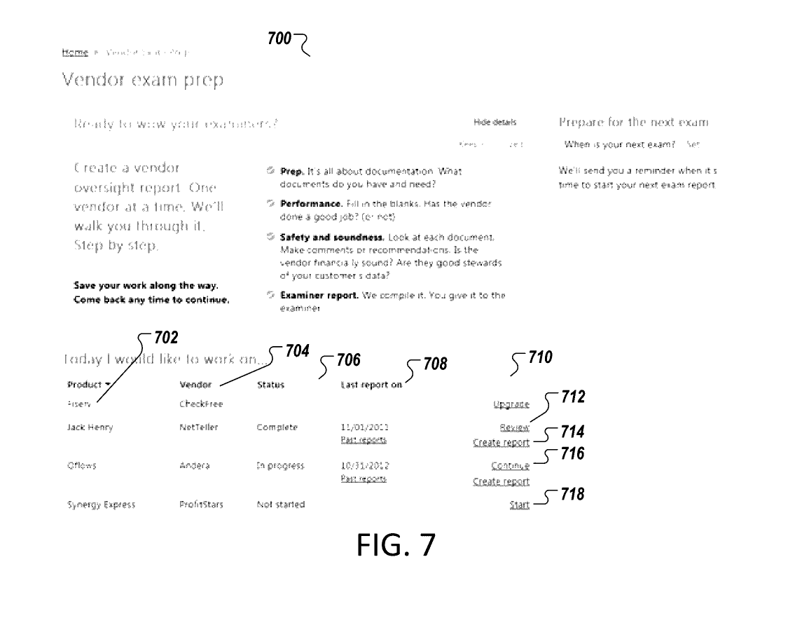

In some implementations, the risk-levels 304, 308 may be used to determine a suggested document 320 (see—see FIG. 8) in the examination-preparation area 322 (not shown—see FIGS. 7-13). Once the vendor product is added, the system 100 may present the end-user with a notification that the product has been added. In the notification, the system 100 may include a link or a selection that allows the end-user to upload a contract associated with the added vendor product. The system may also provide a link or selection to add a collaborator or to add contact information of the vendor.

In some implementations, the system 100 allows more than one person to interact with a vendor. The collaboration function allows the system 100 to receive information from the end-user about co-workers or other people in the end-user's organization that may perform actions or provide reviews for a given vendor and/or vendor product. In some implementations, the collaborator may perform any of the end-user's function (e.g., upload contract, add notes and reminders, save email conversation, and document events), though may not change or undo any of the actions performed by the end-users. Each of the vendor products may be assigned a different point of contact (i.e., a product manager). The system 100 may provide a search function for the end-user to determine if an added collaborator is already registered with the system 100.

In some implementations, when uploading a contract associated with a given product (312), the system 100 may prompt the end-user for a file. Multiple files may be selected and uploaded in a given instance. The system 100 may send a notification to the end-user that the contract has been uploaded and that a notification will be sent when it is ready for review. In some implementations, the contract may be transmitted to a third-party that analyzes and/or prepare the contract for review by the end-user. The system 100 may use aliases table. Examples of tools utilized by the third-party to analyze and prepare the contract are described in Appendices E and F of the U.S. Provisional Patent Application No. 61/805,066, which is incorporated by reference herein in its entirety.

Vendor Dashboard

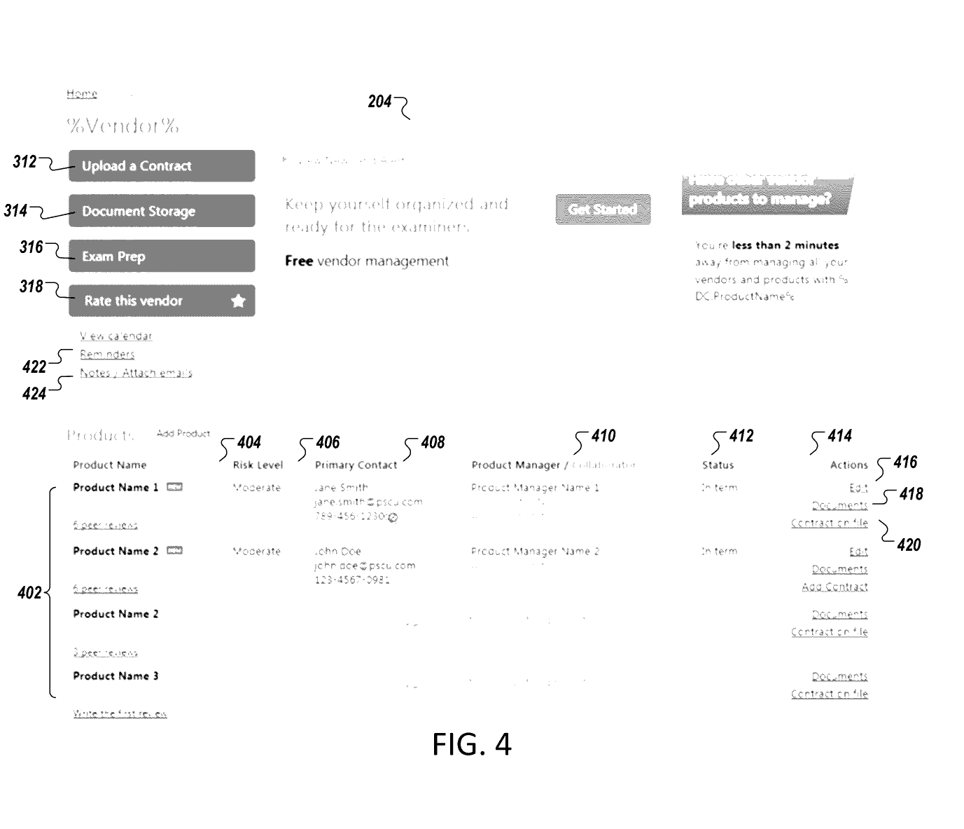

FIG. 4 is an example vendor dashboard 204 in accordance with an embodiment of the invention. In some implementations, the vendor dashboard 204 may be accessed by the end-user when the user selects a vendor from the list of vendors 302 in the main dashboard 202.

In some implementations, the vendor dashboard 204 may include the function to upload a contract associated with a given product (312), the function to manage stored documents (314), the function to prepare for an examination (316), and the function to view and manage reviews for a given vendor products (318).

In some implementations, the vendor dashboard 204 may include a list of vendor products (402) that are associated to the financial institution. The list 402 may include, for example, but not limited to, products that are currently being managed as well as products that are yet to be assigned to a given product manager. For each of the products in the list 402, the system 100 may display a product name 404, a risk level that has been assigned to the product 406, a vendor contact information 408, an assigned product manager (of the financial institution) 410, a status indicator of the product 412, and actionable tasks 414 associated with a given product. The actionable tasks 414 may allow an end-user to edit a given product information (416), to view or manage the document associated with the given product (418), and to add a contract or edit the contract on file associated with the given product (420).

Upon a selection of a product in the list 402, the system 100 may prompt the end-user whether to assign a product-manager for the product. The prompt may further include details and information about the product, including, for example, the vendor name, the product name, the product type, and the source of the product. Upon the end user providing the information, the system 100 may provide options to allow the end-user to upload a contract, to add a collaborator, or to add contact information.

Upon a selection to edit a product (416), the system 100 may display the information about an added product (e.g., the vendor name, the product name, the product type, and a risk level), as described in FIG. 3. The system 100 may also display the vendor's contact-information and/or a list of assigned collaborators.

The system 100 may provide a selection to allow the end-user to remove collaborators from specific products.

Upon a selection to edit a contract (420) associated with a product, the system 100 may display information relating to the contract, including the status of the contract (e.g., “in-term”, “renewal negotiation”, “auto-renew”, “cancelled”, “replaced”, etc.), the contract files (which may include one or more files), the end-user that uploaded the contract, the upload date, the contract date, the contract expiration date, a list of products associated with the contract, and certain key clauses (e.g., whether the contract includes an auto-renewal clause, information relating to the number of days required for a non-renewal notice, and an auto-renewal period). The system 100 may also display information relating to the contract terms (e.g., sale price per unit, etc.), comments associated with the term (e.g., whether the contract is a service-level agreement (SLA)), the vendor signatory, the institution signatory, among others. The system 100 may provide a prompt to the end-user to edit or replace the contract.

In addition, the system 100 may take actions and set reminders. Example actions of the system 100 are summarized in Table 1.

TABLE 1

| Status | Description | Action | Email Communication |
|---|---|---|---|
| In Term | Contract has not reach | No action taken | Initiate communication |
| | expiration date | | six months from |
| | | | expiration date |
| Renewal | Financial Institution is | No action taken | Sent on the expiration |
| negotiation | working on a new contract | | date |
| | terms | | |
| Auto- | Automatically renew terms | Change the contract | Sent on the expiration |
| Renew | of the contract based on the | expiration date based | date |
| | info entered when the | on the terms loaded in | |
| | contract was loaded | the upload contract | |
| | | form | |
| Cancelled | Contract is no longer valid | All products/ | Sent on the expiration |
| | | documents associated | date |
| | | with the contract will | |
| | | also be in cancelled | |
| | | status and archived | |
| Replace | Financial Institution | Move old contract to | |
| | replacing the existing | archives/new | |
| | contract with a new one | contract starts the | |
| | | upload contract | |
| | | process over | |

In addition, upon a selection to edit a contract, the system 100 may provide guidance to the end-user depending on the various selected options. For example, if the end-user specifies “renewal negotiation” (which indicates that the end-user is currently negotiating the contract with the vendor), the system 100 may provide a message that states “By setting a contract to renewal-negotiation, you will no longer receive notices regarding contract expiration and/or auto-renewal. Change your status when you are ready. You can either upload your new contract or cancel your existing contract.” The system 100 may also take action, such as to stop the sending of the contract expiration emails.

In another example, if the end-user specifies “auto-renew” (which indicates that the contract would auto-renew with the terms as originally provided), the system 100 may prompt the end-user for a new expiration date for the contract and a date for new reminders.

In yet another example, if the end-user specifies “cancelled” (which indicates that the contract has been canceled), the system 100 may notify the end-user that the system 100 will cancel all of the selected products, archive all of the uploaded documents, and archive all of the uploaded contracts. The system 100 may also prompt the end-user for new vendor information. The system 100 may also prompt the end-user to upload a new contract or document.

In yet another example, if the end-user specifies “replace contract” (which indicates that the end-user wishes to replace an existing contract with a new contract), the system 100 may prompt the end-user for new documents associated with the new contact. The system 100 may archive the old contract in an archived folder. The old contract may be accessible to the end-user at the document storage page 206. In some implementations, the system 100 may also sent the new document to the third-party 218 for analysis and preparation.

Still looking at FIG. 4, the vendor dashboard 204 may include features to assist the end-user in managing reminders and notes associated with the vendor product. For example, the vendor dashboard 204 may include an option to display all of the reminders (422) associated with a given vendor.

The vendor dashboard 204 may include an option to attach and view notes and correspondences (424) (e.g. electronic mail) associated with the vendor. In some implementations, the system 100 may present the information as a list that includes the dates that the note was created, a title for the note, a note type, a product name, an identifier of the end-user that created the note, a vendor name, a product name, and a note message. The list may be filed, sorted, or organized using the note title, the email information, or by the product information.

Document Storage

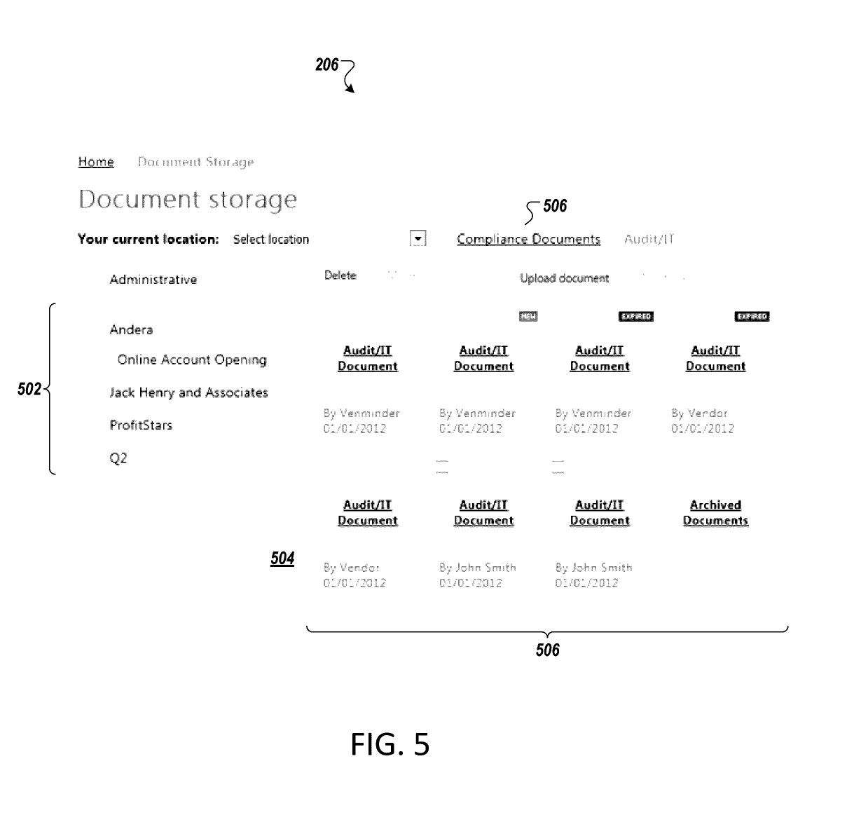

FIG. 5 is an example document storage page 206 in accordance with an embodiment of the invention. The document storage page 206 allows an end-user or product manager to view and manage documents associated with a given vendor.

In some implementations, the document storage page 206 may display a list of product managers 502 and the documents they are managing or collecting. The document storage page 206 may include a workspace 504 for managing and viewing a set of collected documents. The workspace 504 may allow the end-user to organize the set of documents in a set of vendor folders. The vendor folders may include documents and folders associated to a given vendor and vendor product.

In some implementations, the document storage page 206 may include a compliance document folder 506 to be used for the examination preparation effort. The compliance document folder 506 may include folders relating, for example, to “audit/IT”, “business continuity”, “financial”, “insurance”, “miscellaneous”, “policy”, and “product management.”

Upon a selection to upload a new document, the document storage page 206 may prompt the end-user for a file to upload, a document description, a document date, comments, and/or reminders.

The document storage page 206 may restrict the transfer of files. In some implementations, once a document has been uploaded, for example, to the compliance document folder 506, the document storage page 206 may prohibit the end-user from moving these documents to a different folder. To this end, the system 100 may require the end-user to delete the file and re-upload the file to the different folder. In some implementations, the document storage page 206 prohibits the addition of new folders to the compliance document folder 506.

As another example, only documents uploaded by the end-user may be moved by the end-user. The document storage page 206 may indicate to the end-user the documents that they have permission to move. The document storage page 206 may indicate the owner of the document.

The document storage page 206 may label the various uploaded documents. For example, in some implementations, the document storage page 206 may label documents that have been newly uploaded by the third-party 218 or by the vendor as “new”. The label may appear only during a first login session by the end-user, and the label may be removed in subsequent sessions. Other labels may include “expired.”

Exam Preparation

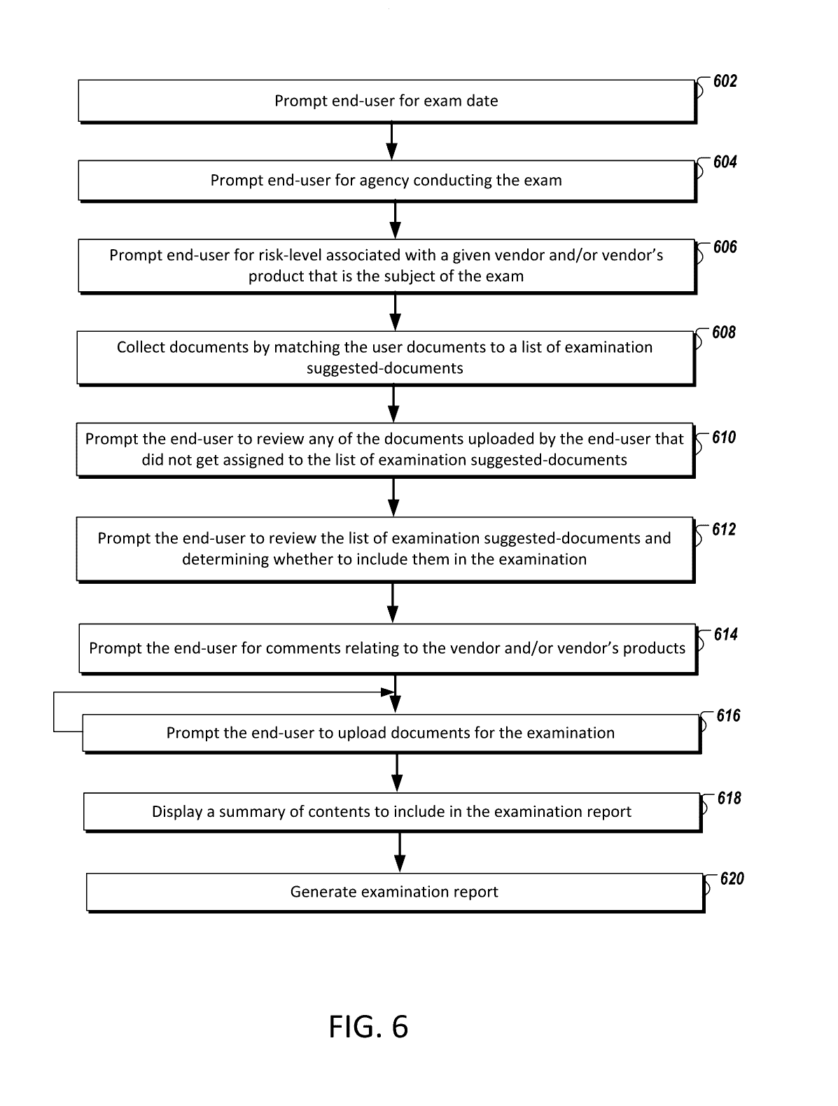

FIG. 6 is an example workflow of the system 100 to guide an end-user to prepare a vendor oversight report associated with one or more selected vendor products in accordance with an embodiment of the invention. The workflow may be referred to as “Exam Prep”. The Exam Prep may be used to assist and guide the users of a financial institutions to prepare, for example, for its annual exam with a given government agency, regulatory body, or auditing process. In some implementations, the Exam Prep may collect all of the documents that will be the subject of the examination. The Exam Prep may collect all of the notes and correspondences associated with a product. The Exam Prep may allow the end-user to review all of these documents. The Exam Prep may allow end-users to invite experts and/or collaborators to assist with the exam preparation. The Exam Prep may create or generate a report for the examiners.

In some implementations, the Exam Prep workflow may be initiated from the main dashboard 202 or the vendor dashboard 204, as described in relation to FIGS. 3 and 4.

Upon initiation of the Exam Prep workflow, the system 100 may prompt the end-user for examination information, including, for example, a date of the next regulatory exam (step 602). The system 100 may use the provided date to track the number of days remaining until the examination and to determine when notification (e.g., by email) regarding the examination may be sent. In some implementations, the system 100 may send, for example, a reminder to an end-user that created the report (and/or the product manager) 90 days before the examination. The reminder may indicate to the end-user that the report is ready for the end-user's review. The system 100 may also send a reminder, when no report has been generated, to an end-user to remind them to start a report.

In the Exam Prep workflow, in some implementations, the system 100 may prompt the user for a list of one or more agencies to be included in the examination (step 604). Examples of the agencies may include, for example, but not limited to, the Consumer Financial Protection Bureau (CFPB), Federal Deposit Insurance Corporation (FDIC), Federal Reserve System (FED), National Credit Union Administration (NCUA), and/or the Office of the Comptroller of the Currency (OCC).

In some implementations, the system 100 may also prompt the end-user for a risk-level (e.g., low, medium, high, and undefined/unknown) associated with the vendor and/or vendor product, if the information has not been provided, for which the examination is being prepared (step 606). The risk-level may be an input from the risk-assessment module 214. The system 100 may use the provided risk-level to determine suggested documents for the examination-preparation process.

FIG. 7 is an example vendor examination-preparation workspace 700 in accordance with an embodiment of the invention. The workspace 700 may display a list of products 702. For each of the products 702, the workspace 700 may display the vendor name (704), the status of the examination (706), the last reported date (708), and actionable tasks 710.

The last reported date 708 may be, for example, the last time a report was created or the last time the product was examined. The status of the examination (706) may include “complete”, “in progress”, and “not started.” A list of the examination status is shown in Table 2.

TABLE 2

| Status | Description | Action |
|---|---|---|
| Complete | All steps have been completed | Review, Preview report |
| In progress | Started but not all steps | Continue, Preview report |
| | completed | |
| Not started | No steps have been started | Start |

The actionable tasks 710 may include reviewing an examination report (712), creating a report (714), continuing a report (716), and starting a report (718).

The system 100 may save all of the work, including all of the actions taken by the end-user. To this end, the end-user can continue from another point in the examination preparation process.

Referring back to FIG. 6, in some implementations, the method 600 may include matching all of the end-user's uploaded documents to a list of examination suggested documents (step 608). The list of examination suggested documents may be a pre-defined list selected from a set of pre-defined list. The pre-defined list may be selected based on the risk-level associated with the given product or vendor subject to the examination.

FIG. 8 is an example workspace 800 for matching collected end-user's document to a list of suggested documents in accordance with an embodiment of the invention. The workspace 800 may display a list of collected documents uploaded by the end-user (802). The list may include documents collected in the compliance document folder, as described in relation to FIG. 5. The workspace 800 may display a list of suggested documents (804) for the examination. The list of suggested documents (804) may be a pre-defined list of documents that is organized by risk levels. The workspace 800 may allow the end-user to select a document from the collected list (802) and “drag and drop” it to a suggested content in the list of suggested documents (804). The action may merely associate the documents in that no files are moved.

The system 100 may display a status of the workflow (806). The status may include an indicia of the current process being performed by the end-user and a status of the other processes (e.g., complete, in-profess, or ready to start) in the workflow.

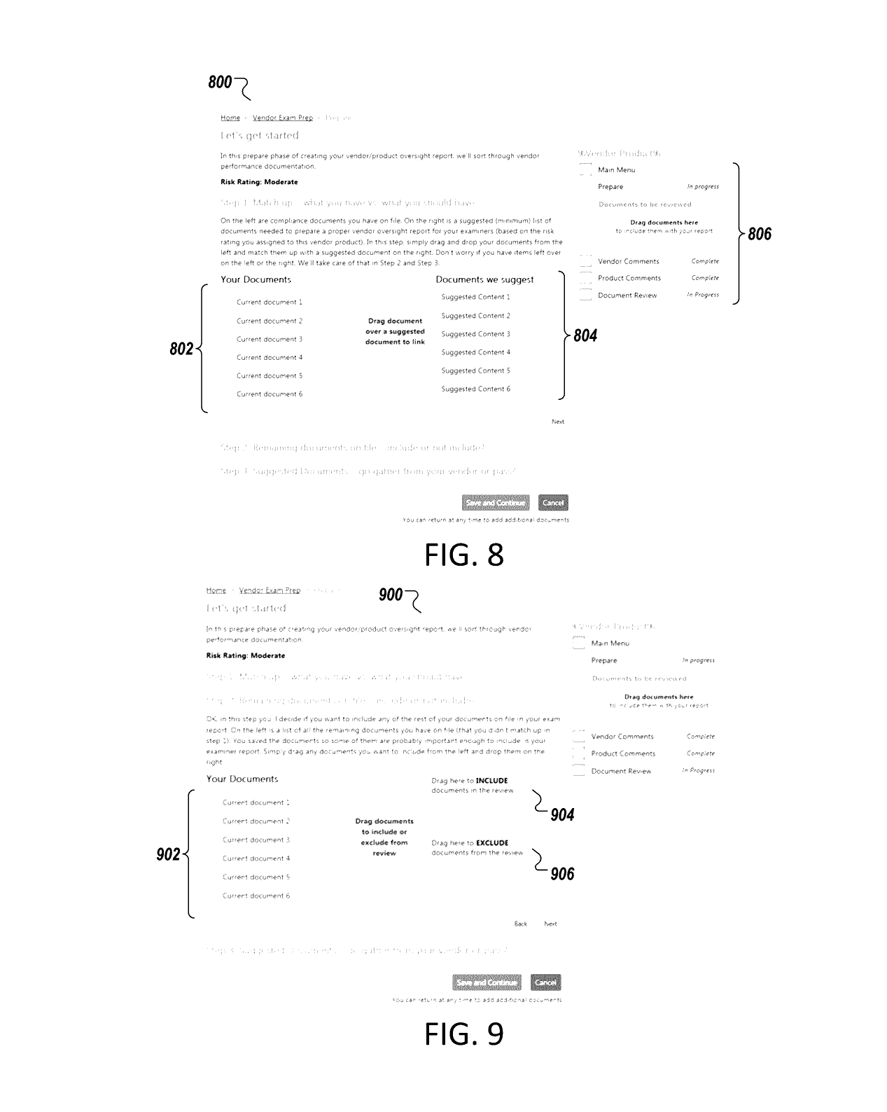

Referring back to FIG. 6, in some implementations, the method 600 may include prompting the end-user to review any of the collected documents uploaded by the end-user that was not assigned to the list of the examination suggested-documents (step 610). FIG. 9 is an example workspace 900 for prompting the end-user to review the unassigned documents 902 that has been collected to the document storage page 206, but has not been assigned in FIG. 8. In some implementations, the system 100 may prompt the end-user to identify each of the unassigned documents as either to include (904) or exclude (906) from the report/examination.

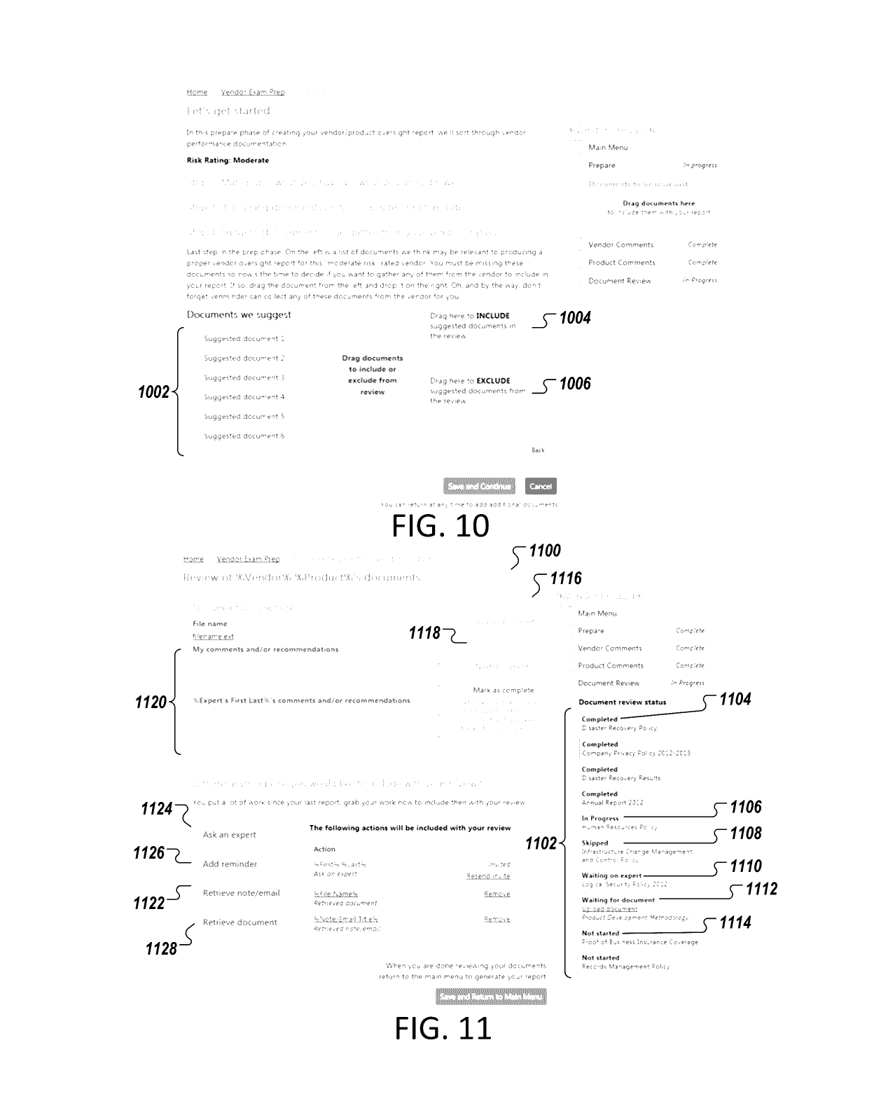

Still looking at FIG. 6, in some implementations, the method 600 may include prompting the end-user to review the list of examination suggested-documents and determining whether to include them in the examination (step 612). FIG. 10 is an example workspace 1000 for prompting the end-user to review the unassigned suggested documents 1002. The system 100 may prompt the end-user to identify each of the unassigned suggested documents as either to include (1004) or exclude (1006) from the report/examination.

Still looking at FIG. 6, in some implementations, the method 600 may include prompting the end-user to provide comments about the vendor (step 614). The comments may be in response to interrogatories, such as (i) “What has the vendor done well since your last exam date,” (ii) “What has not gone well since your exam date,” and (iii) “What actions are you going to take before your exam date.” The system 100 may also prompt the user to provide comments for each of the vendor product that is being examined.

Still looking at FIG. 6, in some implementations, the method 600 may include displaying (step 614) all of the documents that has been matched between the end-user's uploaded documents and the list of suggested documents (as described in relation to FIG. 8) as well as those documents that are marked to include (as described in relation to FIGS. 9 and 10). FIG. 11 is an example workspace 1100 for preparing the collected document for the examination report in accordance with an embodiment of the invention. The system 100 may display a status label for each of the documents. The status label may include “completed” 1104, “in progress” 1106, “skipped” 1108, “waiting for experts” 1110, “waiting for documents” 1112, and “not started” 1114. The status labels are described in further detail in table 3.

TABLE 3

| Document | |
|---|---|
| Status-Label | Description |
| Not Started | Included in exam but the user has not reviewed it |
| Waiting on expert | Expert has been invited but no response provided |
| Waiting for documents | Document type is included in exam but |
| | document has not been uploaded |
| Skipped | Viewed the document but preformed no actions |
| In Progress | Actions preformed but not marked as complete |
| Complete | Checked the box mark as complete |

In some implementations, the system 100 may provide a navigation function to allow the end-user to scroll through the various selected documents. The navigation function may include an arrow to review the previous selected document (1116) or the next selected document (1118). For each of the selected documents, the system 100 may allow the end-user to add comments (1120), to retrieve an electronic correspondence or note (1122), to invite an expert and/or collaborator to provide comments or to assist in the document preparation (1124), and/or to set reminders (1126).

Upon selection to invite a co-worker/expert (1124), the system 100 may provide a list of co-workers and/or suggested experts for the user to send a message. The system 100 may also prompt the end-user for a name, contact information, and a message to send to a co-worker and/or expert. The system 100 may accept multiple requests for comments.

The system 100 may allow each of the co-workers and/or experts to register and login. After which, the system 100 may only allow the co-worker and/or expert to view and provide comments for the vendors and/or vendor product to which they were asked for comments. The system 100 may send a notification to the end-user subsequent to a comment being provided. The system 100 may also send a notification when the co-worker and/or expert has registered to the system 100.

Upon receipt of comments from a given co-worker and/or expert, the system 100 may label the request as being complete. The system 100 may also update the Exam Prep workspace 1100 with the received solicited comments. To this end, the system 100 may provide an organized and efficient framework to request for comments from internal and external collaborators, to track such requests, and to review and utilize such comments in the examination-preparation process.

Upon selection of an input to retrieve an electronic correspondence or note (1122), the system 100 may display a list of notes and correspondences stored within the system 100. The system 100 may provide a date, a title, a correspondence type (e.g., email, notes, SMS, etc), and an identity of the end-user and/or product manager that performed the uploaded. The system 100 may allow the end-user to filter the list based on the correspondence type.

Still looking at FIG. 11, the system 100 may allow the end-user to retrieve additional documents (1128) related to the vendor product. A selection of this input (1128) may direct the end-user to the document storage page 206, as described and shown in relation to FIG. 5. The end-user may add documents to the examination preparation process from there.

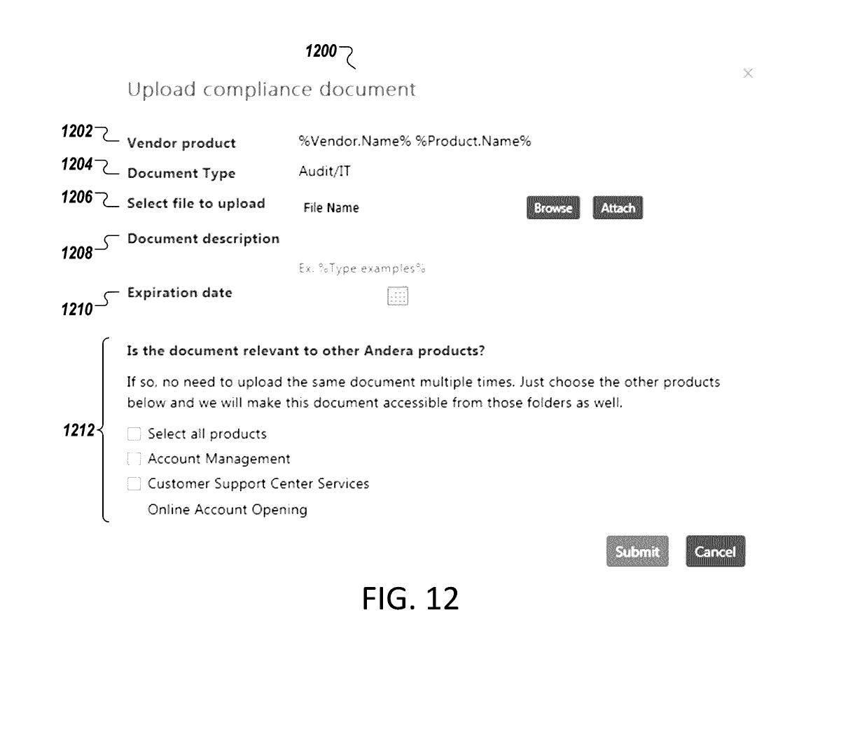

Referring back to FIG. 6, in some implementations, the method 600 may include prompting the end-user to upload documents for the examination (step 616). FIG. 12 is an example workspace 1200 for uploading document to be attached and included in the examination in accordance with an embodiment of the invention. The workspace 1200 may display the vendor product name 1202 and the document type 1204. The workspace 1200 may prompt the end-user for a file (1206), a document description (1208), an expiration date (1210), and a selection to use the document for other products (1212). The selection (1212) allows the end-user to have to upload a given document only once as the document can be applied to multiple products that may be the subject of one or more examinations. The workspace 1200 also allows the end-user to tailor comments and descriptions for each of the documents to be include in the report.

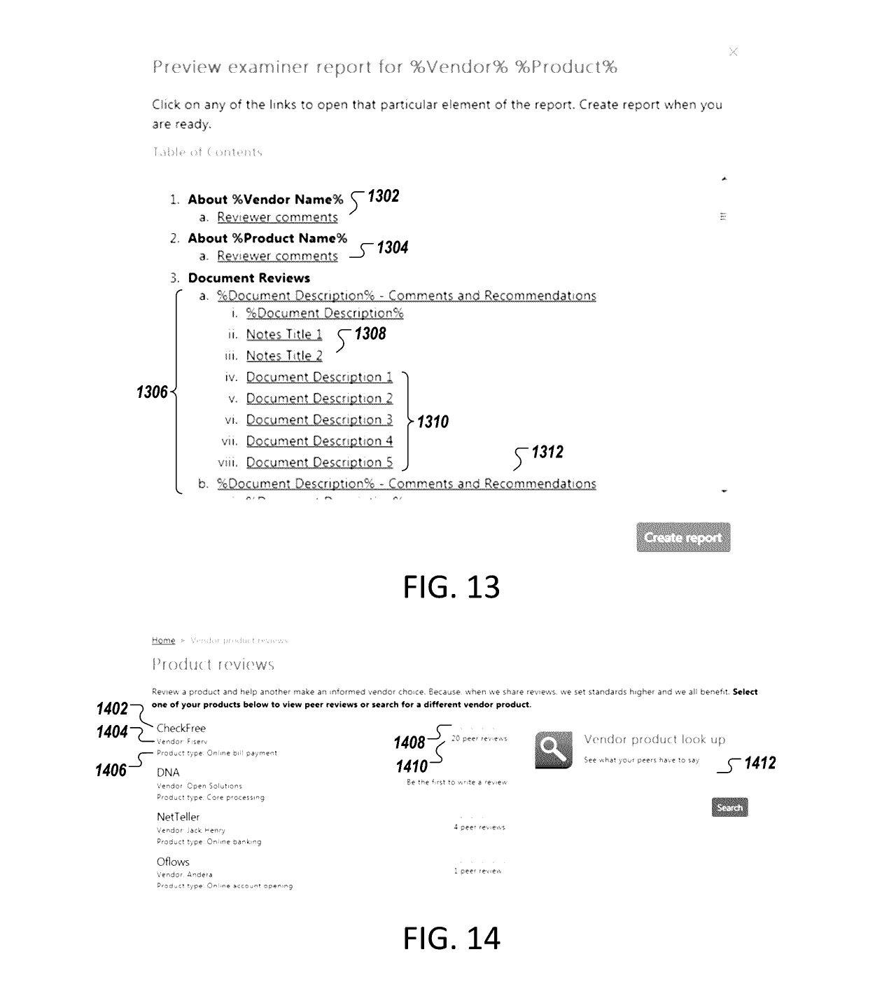

Still looking at FIG. 6, in some implementations, the method 600 may include displaying a summary of contents to include in the examination report (step 618). FIG. 13 is an example workspace 1300 to preview contents to be included in the examination report. The contents may include, for example, but not limited to, the reviewer's comments about the vendor (1302), the reviewer's comments about the products (1304), and the documents to include in the report (1306). The documents 1306 may include notes (1308), documents (1310), and comments and recommendations (1312). The system 100 may allow the end-user to preview any of the uploaded documents, comments, and notes as collected by the system 100.

Still looking at FIG. 6, in some implementations, the method 600 may include generating an examination report in accordance with an embodiment of the invention (step 620). The report may be generated, for example, as a PDF (“portable document format”) file. In some implementations, the report may be generated as a compressed file (e.g., a ZIP (archive file format) file). Upon a creation of the examination report, the system 100 may add the report to an archive section to which the end-user can later review the report. The system 100 may also update the vendor and product dashboard to indicate the recent addition of a new report as well as the status of the last instance that a report had been created. In some implementations, the system 100 may send a notification to the end-user to recommend initiating a new report (in the case of an annual report). The notification may be sent, for example, 9 months after the examination report has been generated.

Vendor Product Review

The system 100 may include a vendor product review workspace to allow the end-user to view and provide reviews/ratings for a given vendor, as described in relation to FIG. 3. In some implementations, the system 100 may display the performance rating and/or the listing of one or more performance comments received from users of the given vendor product and/or one or more corresponding products provided by one or more different vendors.

FIG. 14 is an example workspace 1400 to review vendor products in accordance with an embodiment of the invention. The workspace 1400 may display, at any given instance, a composite of multiple vendor products. The composite may include preferably four to five vendor products. Of course, any of number of vendor products may be displayed on the workspace 1400. For each of the products, the workspace 1400 may display the vendor name (1402), the product (1404), the product type (1406), a rating value 1408, and an indication of the number of reviews (1410). In some implementations, the system 100 may provide a search tool 1412. In some implementations, the system 100 may also provide a rating/review module for a given vendor.

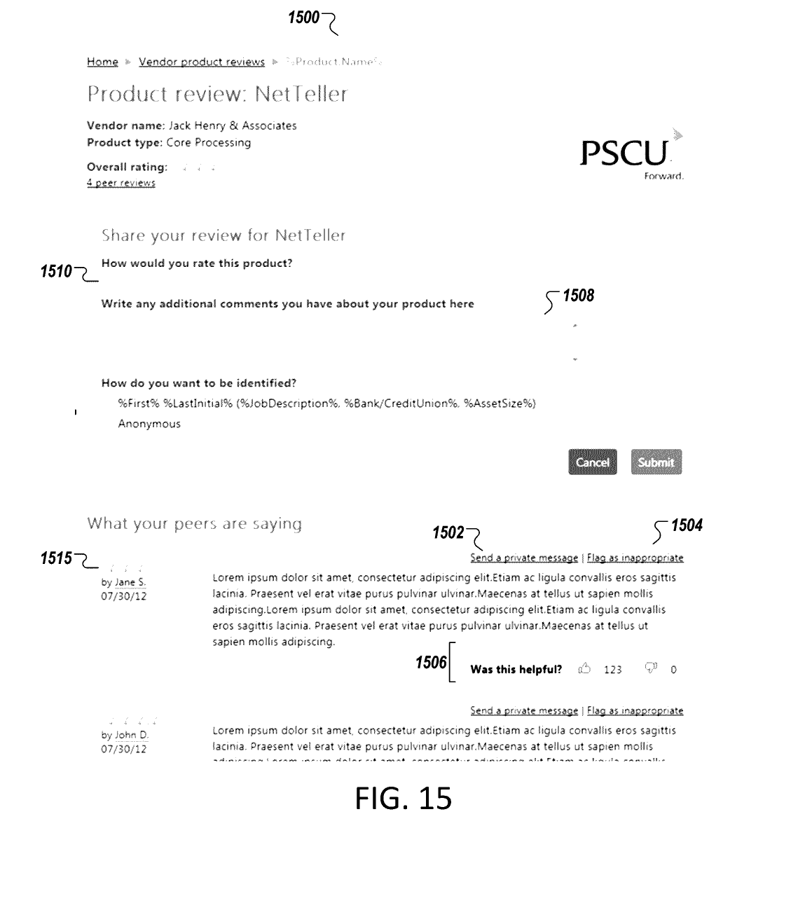

FIG. 15 is an example display 1500 for viewing product reviews in accordance with an embodiment of the invention. In some implementations, the system 100 may provide a prompt 1502 for the end-user to send a private message to the vendor or to the reviewer. The system 100 may also provide a prompt 1504 to flag the review as being inappropriate. The flag may generate a notification to a designated reviewer to determine whether the message is appropriate to display. The system 100 may also display an indicator of the number of people that flagged the review as being helpful and/or unhelpful.

The system 100 may prompt the end-user to provide a review 1508 for a given selected product. The end-user may provide a rating value 1510 (which may a star rating), comments, and identifier/contact information.

In some implementations, the display 1500 may include a listing of performance ratings (1512) received from various end-users and/or product managers of the various vendor products. The listing may be organized (e.g., ordered) on the graphical user interface according to popularity (e.g., number of “likes” received for each of the performance comments).

### News and Alerts

The system 100 may include an alert and/or information feed that provides information about changes that have been made (e.g., new documents uploaded, new reviews added, and status updates for a given examination or preparation process, etc.). The alert may include a progress bar to indicate a given end-user progress with a given task.

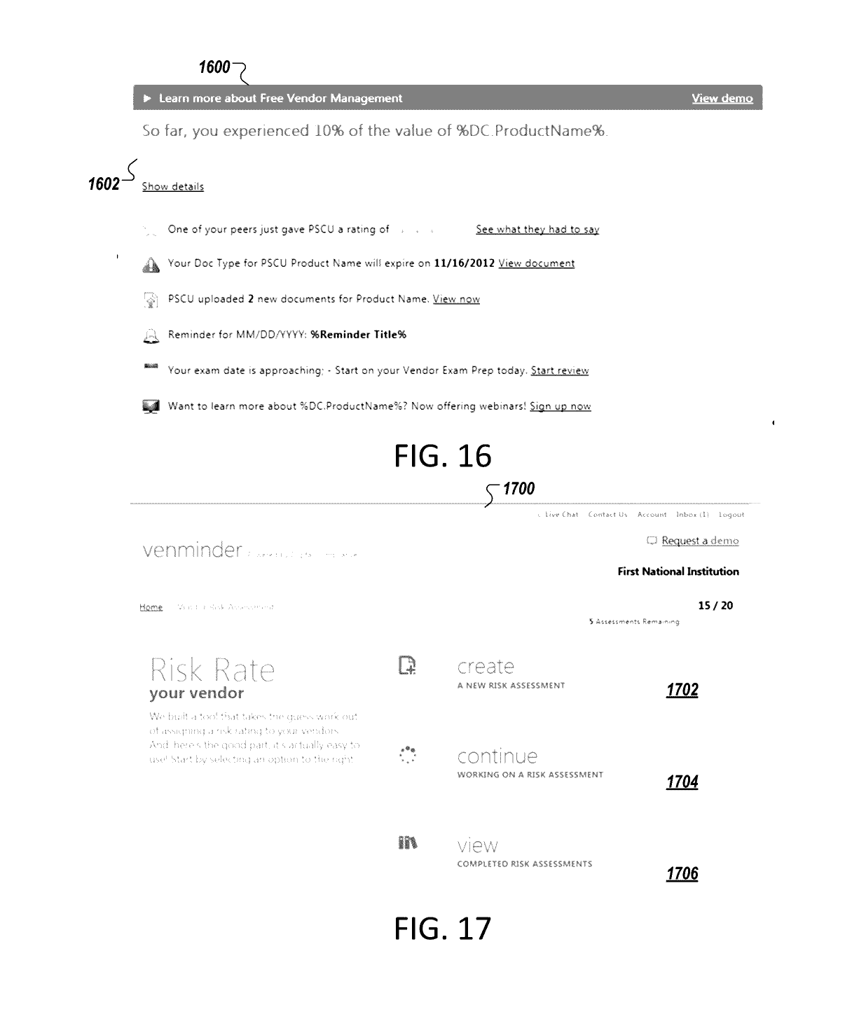

FIG. 16 is an example alert and information display 1600 in accordance with an embodiment of the invention. The display 1600 may include an experience bar 1602 that shows a given user's level of experience with the system 100. The system 100 may calculate the experience bar based on a set of tasks or functions performed by the end-user within the system 100. Each function may be assigned a function value, which may be aggregated to produce a total experience value. The experience bar 1602 may display the total experience value to the user. Examples of assigned values for a set of functions are provided in Table 4.

TABLE 4

| Function | Link | Percentage |
|---|---|---|
| Add Contract | Upload Contract | 10% |
| Add 2 Compliance Documents | Document Storage | 5% each |
| Add a vendor product | Add Vendor Product | 10% |
| Add a collaborator | Vendor Dashboard | 10% |
| Attach an email and Note | Emails and Notes | 5% each |
| Add a reminder | Reminders | 10% |
| Preform Exam Prep | Exam Prep | 20% |
| Write a review | Vendor Product Review | 10% |

Risk-Assessment Module

In another aspect of an embodiment, the system 100 provides a risk-assessment module 214 that may allow the end-user to rate the vendor products and/or vendors in the areas of Information Access, Operational and Financial Dependency and Regulatory Exposure. To this end, the system 100 may provide a graphical user interface configured to display one or more prompts for user entries associated with a risk assessment of a given vendor product where the user entry are in response to a set of questionnaires.

In some implementations, the system 100 stores libraries of pre-defined questionnaires that the end-user can search. In some implementations, the libraries may be defined for a given financial institution. To this end, the libraries may be accessible to end-user associated with the financial institutions. Once a template questionnaire is selected and displayed, the system 100 may allow the end-user to add questions to the template questionnaires. The questionnaires are used to solicit a risk rating about an aspect of the product. The ratings may be aggregated to provide an aggregated risk rating for the product. The aggregated risk rating may be employed in the examination preparation and examination report.

FIG. 17 is an example workspace 1700 for performing a risk assessment of a vendor product in accordance with an embodiment of the invention. The workspace 1700 provide prompts for a user to create a new risk assessment (1702), to continue work on a risk assessment that is in progress (1704), and to view a completed risk assessment (1706).

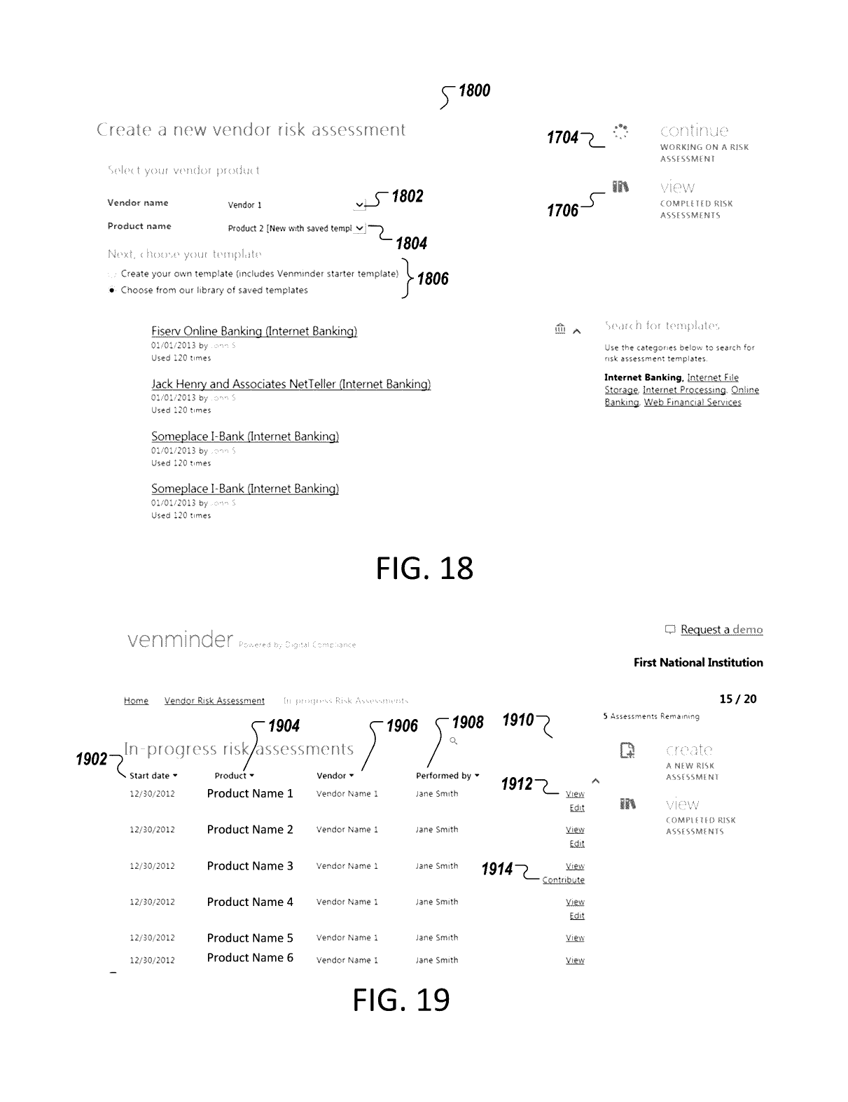

FIG. 18 is an example workspace 1800 to initiate a new risk assessment of a vendor product in accordance with an embodiment of the invention. The workspace 1800 may include a prompt for a vendor name (1802) and a product name (1804).

In some implementations, the system 100 may maintain a list of existing and completed risk assessment. The system 100 may determine whether a request to initiate the risk assessment for the given vendor product is a duplicate of an existing risk-assessment evaluation or a completed risk-assessment evaluation. To this end, the system 100 may use the list to prevent duplicate risk-assessment evaluations from being initiated for a given vendor product for a given end-user and financial institution.

The workspace 1800 may provide the end-user with a prompt (1806) to start i) a new template for a given risk area (e.g., Information Access, Operational and Financial Dependency and Regulatory Exposure), ii) a template used by the end-user the last time a risk assessment was performed, and iii) a template created by other end-users that is accessible to the end-user.

FIG. 19 is an example workspace 1900 to view risk-assessment evaluations that are in-progress in accordance with an embodiment of the invention. The workspace 1900 may display all of the risk-assessment evaluations of vendor products that are currently in-progress by a given financial institution. The workspace 1900 may display a start date associated with a given risk-assessment evaluation (1902), a product name (1904), a vendor name (1906), and an identifier of the end-user that initiated the risk-assessment evaluation (1908). The workspace 1900 may also allow the end-user to view an identifier of other end-users that may edit a risk assessment or have viewing permission of the risk assessment results (1912). The workspace 1900 may also allow the end-user to invite other end-user/product managers to contribute to a given risk-assessment evaluation (1914).

In some implementations, the workspace 1900 may include a search tool 1910 for searching of the vendor or products.

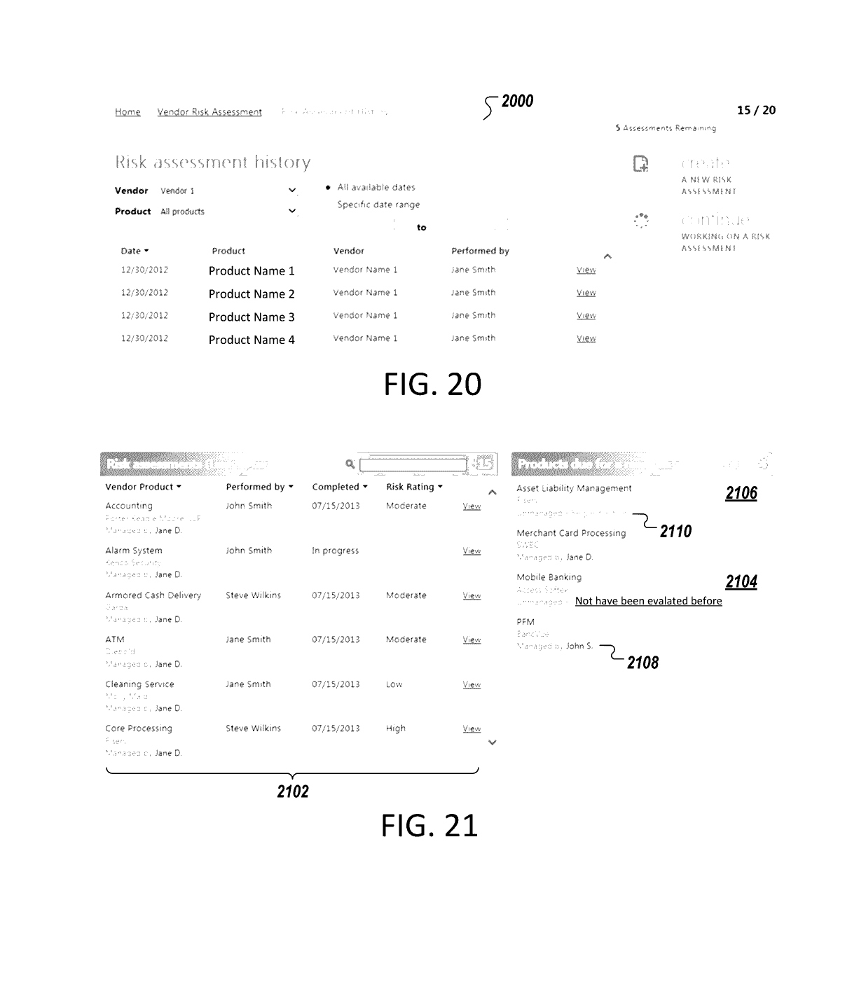

FIG. 20 is an example workspace 2000 to view completed risk-assessment evaluations in accordance with an embodiment of the invention. The workspace 2000 allows an end-user to view a list of all of the completed risk assessments by a given financial institution for a given product or vendor. The workspace 2000 allows the end-user to search for past evaluations, for example, based on the vendor name, the product name, and date that the assessment was initiated or completed.

FIG. 21 is an example dashboard 2100 to manage risk-assessment evaluations of vendors and vendor products in accordance with an embodiment of the invention. In some implementations, the dashboard 2100 may display a summary of risk assessments that are in-progress or have been completed (2102) within the last 12 months. The dashboard 2100 may display a list of vendor products that have never had a risk assessment completed (2104). The dashboard 2100 may display a list of vendor products that are due for a risk assessment (2106) (for example, the product had an assessment performed and/or completed in the past).

The dashboard 2100 may display owners (2108) of risk assessment projects and whether a given risk assessment has not been assigned (2110).

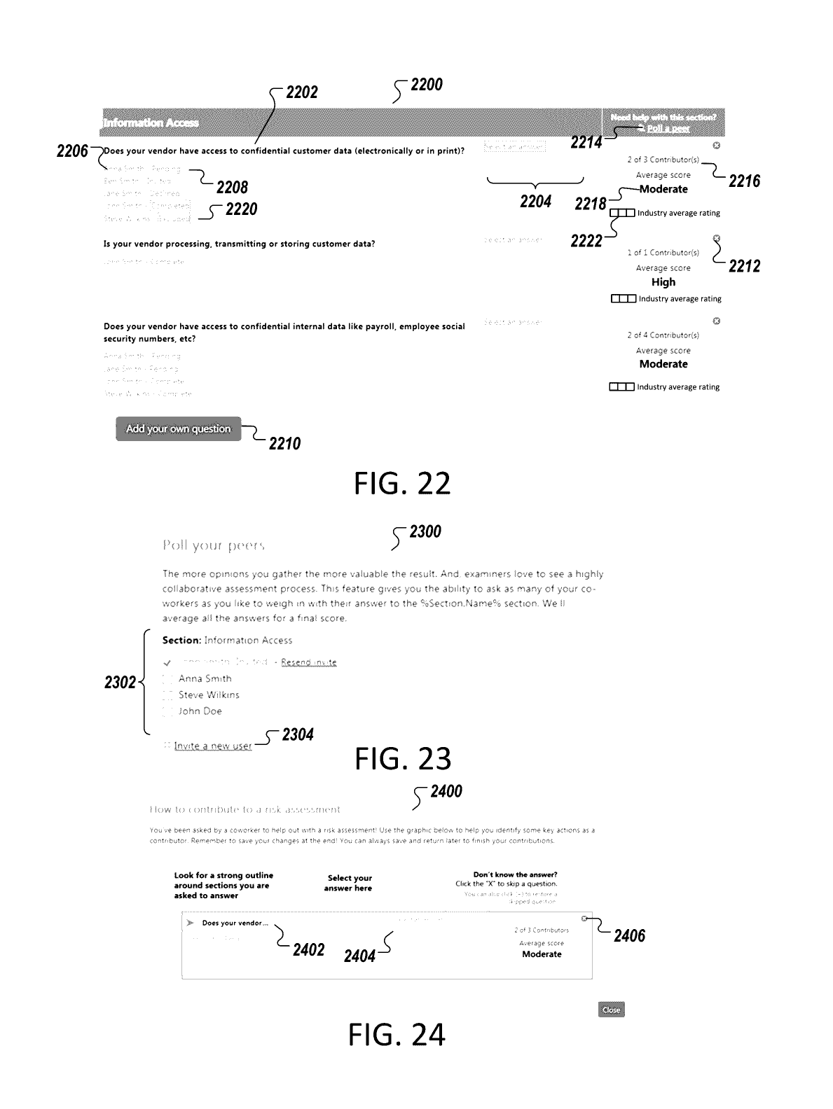

FIG. 22 is an example risk assessment workspace 2200 in accordance with an embodiment of the invention. The workspace 2200 may display a set of questions (2202) and a prompt (2204) for the end-user to select a reply, which may consist of a risk level rating (e.g., low, moderate, high). In some implementations, the workspace 2200 may include prompts (2214) to allow the end-user to invite or poll one or more peers to contribute to the evaluation/assessment.

The workspace 2200 may display a summary rating (2218) for each of the risk assessment questions. The summary rating may be an average (i.e., mean), a mode, or a weighted sum (in which certain “expert” collaborators are assigned higher weights). In some implementations, the workspace 2200 may display a list of collaborators (2206) and their progress in providing their comments (2208). The workspace 2200 may provide a prompt (2216) for the end-user to see individual feedback or input from a given peer or collaborator. In some implementations, the workspace 2200 may allow the end-user to exclude certain peer evaluations from the summary rating (2220). In some implementations, the end-user may include or exclude a certain peer evaluation by selecting the displayed status (e.g., 2220). The workspace 2200 may display an industry rating (2222) for a given vendor product.

The workspace 2200 may include prompts to allow the end-user to add additional questions to the workspace (2210) or remove questions from the workspace (2212).

Upon selection of the prompt to invite or poll a set of peers to contribute to the evaluation/assessment (2214), the system 100 may provide a list of peers for the end-user to select. FIG. 23 is an example invitation-workspace 2300 to invite peers to contribute to a risk-assessment evaluation in accordance with an embodiment of the invention. The workspace 2300 may include a list 2302 of peers who are registered (i.e., another end-user) with the system 100. The workspace 2300 may provide a prompt (2304) for contact information for a new user.

FIG. 24 is an example request message 2400 for comments from a collaborator to a given risk-assessment evaluation in accordance with an embodiment of the invention. The request message 2400 may display the question (2402) as presented in the risk-assessment evaluation and a prompt (2404) for a reply. The request message 2400 may also provide a prompt (2406) to decline to provide a response and/or feedback.

In another aspect of the disclosure, a business model is provided for securing subscriptions from financial institutions for a financial institution/vendor relationship management system. For example, free online tools are offered for vendors to use to securely distribute their sensitive compliance documentation to financial institution clients in a vendor-controlled fashion. When vendors distribute compliance documents through the system, they invite their financial institutions to use the system to retrieve them (also free of charge to the financial institution). The financial institution is given an opportunity to use the system to manage one or more of their vendor products, including a certain amount of storage space. The financial institutions can then upgrade online to various individual user-based packages by credit card, or a system for enterprise-wide, more extensive usage. The enterprise package may be sold to a financial institution, where storage space is shared across the institution, and high volumes of vendor products, contracts, etc. can be managed. The enterprise package may also provide the institution with an unlimited number of users accessing the system. The package may provide the financial institution with administrative controls and executive-level dashboard. Examples of such subscriptions and online tools are provided in Appendices B-D and G of the U.S. Provisional Patent Application No. 61/805,066, which is incorporated herein by reference in its entirety.

In another example, as shown in FIGS. 19-20, the system 100, in some implementations, provides a pre-defined number of complimentary risk assessments for vendors and/or products that a given end-user or financial institution may perform. The system 100 may display a number of remaining complimentary risk assessments to promote an end-user to evaluate and use the tool.

FIG. 25 illustrates a vendor profile graphical user interface (GUI) and/or widget 2500 according to an exemplary embodiment. In some example embodiments, the GUI and/or widget 2500 allows client users of an enterprise (e.g., via their corresponding user computing devices) to manage vendor profiles. That is, client users may be associated with a plurality of vendors for which a variety and large amount of data must be tracked, accessed and modified. In this regard, the GUI and/or widget 2500 allows the client users to add, record and store general information about each of the vendors.

More specifically, in some example embodiments, a client user logs into the enterprise system and wishes to view a list of vendors with which they are associated. One of the vendors may be, as shown in FIG. 25 a vendor named “15th street.” The vendor profile GUI and/or widget 2500 allows a profile associated with “15th street” vendor to be created, modified, viewed, or the like. A profile may be made up of predetermined types of vendor data, including the information shown in Table 5 below:

TABLE 5

| Vendor Profile Field | Description |
|---|---|
| Category | Classification or characterization associated |
| | with the vendor. |
| Address | Street address associated with the vendor. |
| Description | Text description of the vendor. |
| Tax Identifier | Unique tax identification number often |
| | assigned by the Internal Revenue Service to |
| | identify an entity (e.g., the vendor). |
| Website URL | A website address associated with a webpage |
| | of the vendor. |
| Public/Private | An indicator of whether the vendor is |
| | privately or publicly owned. |
| Minority-owned | An indicator of whether the vendor are |
| | owned by individuals of minority groups. |
| Criticality | An indicator of whether the vendor is critical |
| | to the client user and/or financial institution. |
| Outsourced Products | List and/or description of products |
| | outsourced by the vendor. |
| In-house Products | List and/or description of products owned or |
| | maintained in-house. |
| NPI Access | An indicator of whether the vendor has |
| | access to non-public customer data. |
| FFIEC | An indicator of whether the vendor subject to |
| | FFIEC examination. |
| GLBA | An indicator of whether the vendor subject to |
| | GLBA regulation. |
| OFAC | An indicator of whether the vendor is |
| | required to run OFAC checks on new |
| | customers. |
| Financial Review | An indicator of whether a vendor |
| | management policy requires regular financial |
| | health reviews on this vendor. |
| Insurance Certifications | An indicator of whether the vendor is |
| | required to provide insurance certifications. |
| Contract Review | An indicator of whether the vendor contract |
| | requires legal/paralegal review. |
| Red Flag | An indicator of whether the vendor is subject |
| | to Red Flag regulations. |
| PCI | An indicator of whether the vendor is |
| | required to be PCI compliant. |
| SOC 1 | An indicator of whether the vendor |
| | management policy require a periodic review |
| | of a SOC 1 on this vendor. |
| SOC 2 | An indicator of whether the vendor |
| | management policy requires a periodic |
| | review of a SOC 2 on this vendor. |
| BCP | An indicator of whether the vendor |
| | management policy requires a periodic |
| | review of this vendor's BCP and/or Disaster |
| | recovery plans. |
| Information Security | An indicator of whether the vendor |
| Review | management policy requires a periodic |
| | Information Security Review on this vendor. |
| Cyber Security Review | An indicator of whether the vendor |
| | management policy requires a periodic |
| | review of this vendor's Cyber Security |
| | Preparedness. |

Categories and other fields may be used to organize vendors in reports in accordance with the vendors' respective categories (or other fields shown in Table 5). In some example embodiments, stored profile information may be used to provide predictive typing results when creating and/or updating other vendor profiles.

The vendor profile information may be stored in one or both of the enterprise system and user client system memories.

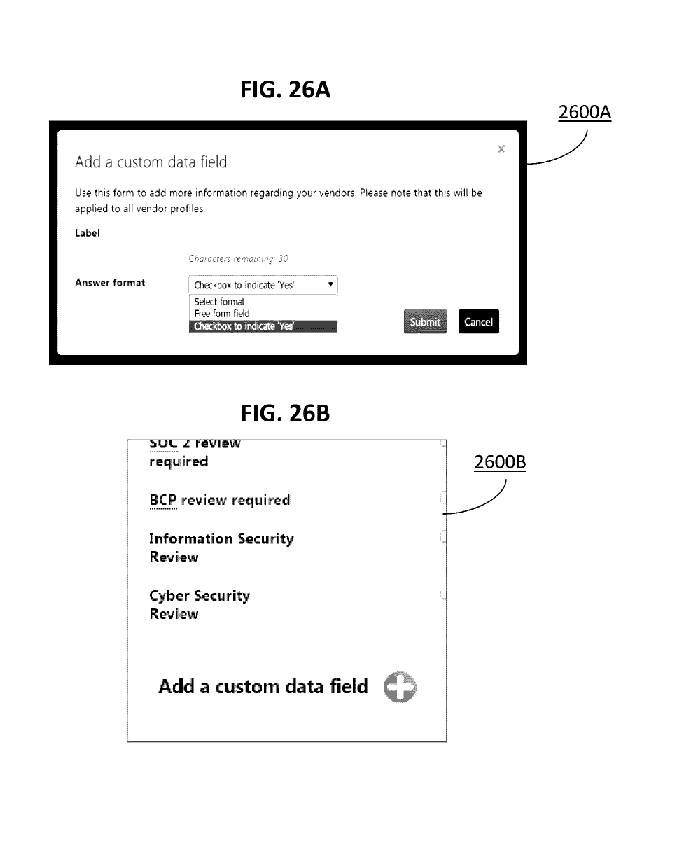

In some example embodiments, the vendor profiles are customizable. FIG. 26A illustrates a GUI and/or widget 2600A for customizing fields in a vendor profile, according to an exemplary embodiment. It should be understood that the GUI and/or widget 2600A may be a part of or separate from the GUI and/or widget 2500. In some example implementations, the GUI and/or widget 2600A is accessed and/or caused to be displayed by selecting a button, icon or the like to add a custom data field. FIG. 26B illustrates a GUI and/or widget 2600B for adding custom data fields to a vendor profile, according to an exemplary embodiment. In some example implementations, the GUI and/or widget 2600B is a part of the GUI and/or widget 2500.

Still with reference to FIG. 26A, the GUI and/or widget 2600A presents, displays and/or includes label and answer format inputs. The label input is used to receive text or the like to be associated with a custom data field to be added to a vendor profile. The answer format input is used to receive text or a selection of the type of answer to be received in association with the custom data field to be added to the vendor profile. The type of answer included in the answer format input may be a free form field (e.g., text input), checkbox, radio button, drop down menu, or the like. It should be understood that other information and/or customization details may be acquired in connection with creating the custom data field.

In some example embodiments, adding a custom data field via the GUI and/or widget 2600A causes all vendor profiles associated with the client user to be updated to include that custom data field. In some example implementations, custom data fields can be added vendor by vendor.

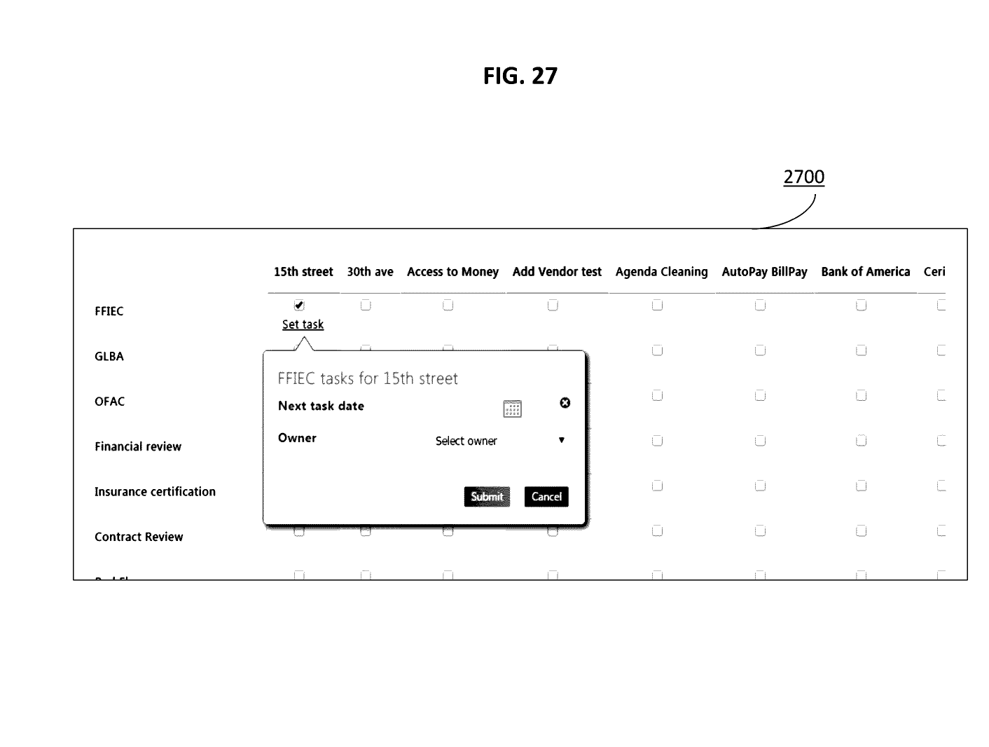

FIG. 27 illustrates a GUI and/or widget 2700 for providing oversight management in a profile grid, according to an exemplary embodiment. The GUI and/or widget 2700 allows client users to, for example, review oversight requirements for vendors. This allows the client users to identify and manage oversight tasks more efficiently (e.g., for all vendors).

As shown in GUI and/or widget 2700, in one example embodiment, vendors are displayed in a top row as column headers in the grid. In FIG. 27, vendors include 15^{th} street, 30^{th} ave, and Access to Money, among others. Oversight requirements are displayed down a first column as row headers. In FIG. 27, oversight requirements include FFIEC, GLBA, OFAC, and Financial Review, among others. It should be understood that oversight requirements and vendors may be arranged in alternate (e.g., reverse) orders.

GUI and/or widget 2700 may also include drop down menus to filter vendors and/or vendor products, for example, by risk (e.g., high risk) and/or count (e.g., 35).

Each vendor-oversight requirement pair has a corresponding check box or the like in the grid. It should be understood that other types of indicators, markers, flags, or the like can be used. Selecting and/or checking a check box causes an oversight task to be generated or initiated. That is, as shown in FIG. 27, selecting the check box associated with vendor 15th Street and FFIEC causes a corresponding task to be generated, indicating that FFIEC oversight and/or examination is required.

More specifically, selecting a check box in the grid of FIG. 27 causes a task GUI and/or widget to be displayed and/or provided to the client user. In some example embodiments, the task and/or GUI widget may be layered on top of the GUI and/or widget 2700 (e.g., as shown in FIG. 27) or may be separately displayed as an independent interface. The task GUI and/or widget prompts the user for information regarding the task, including the next task due date and the owner of the task (e.g., person and/or entity in charge of completing the task). In some example embodiments, an owner of a task is required to be active and/or enrolled at the financial institution or enterprise of the client user.

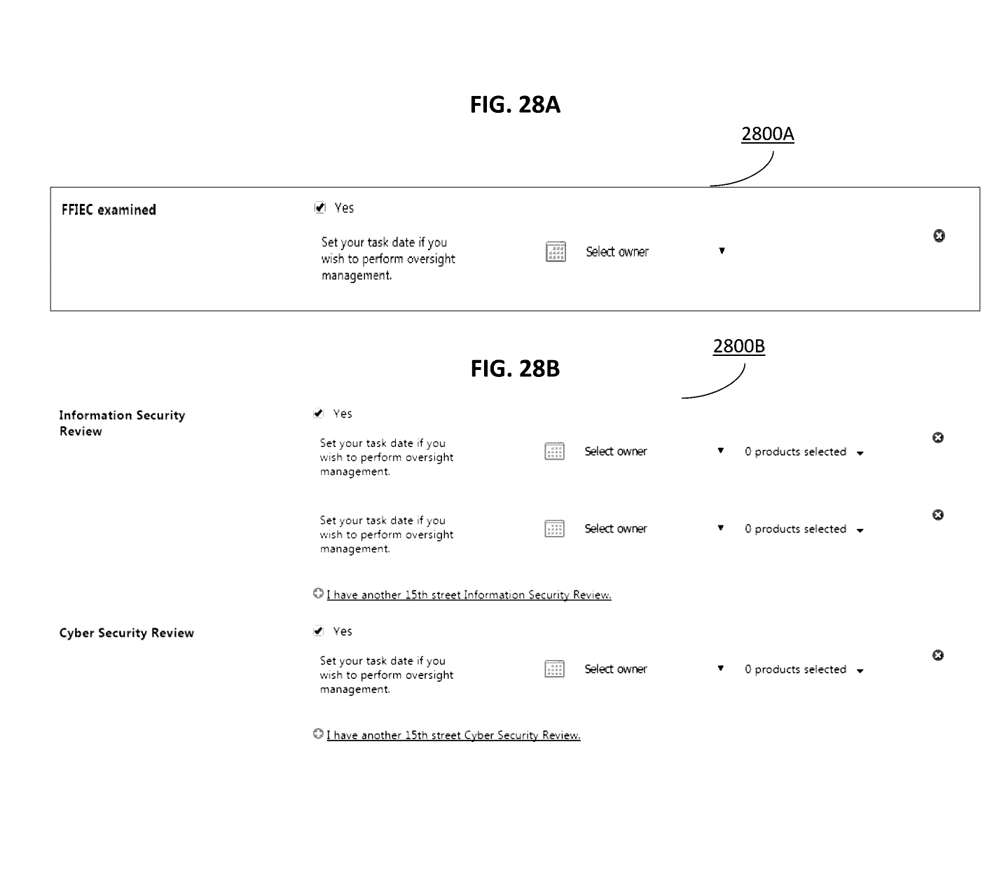

In some example embodiments, the task and/or GUI widget may be displayed as a row on a grid or table, as shown in FIGS. 28A and 28B. FIGS. 28A and 28B illustrate task GUIs and/or widgets for adding oversight tasks, according to exemplary embodiments. FIG. 28A illustrates single task functionality (e.g., a task and/or GUI widget to add one task at a time). FIG. 28B, on the other hand, illustrates multi-task functionality. That is, for example, the multi-task GUI and/or widget of FIG. 28B is presented and/or displayed for an oversight requirement having two or more tasks. Using the multi-task functionality of FIG. 28B, the task information (e.g., due date, owner, products) may be input for each task of an oversight requirement associated with a vendor (or vendor product). In some example embodiments, multi-task functionality for adding oversight tasks is limited to certain types of oversight requirements (e.g., BCP, SCO 2, insurance certifications, information security review).

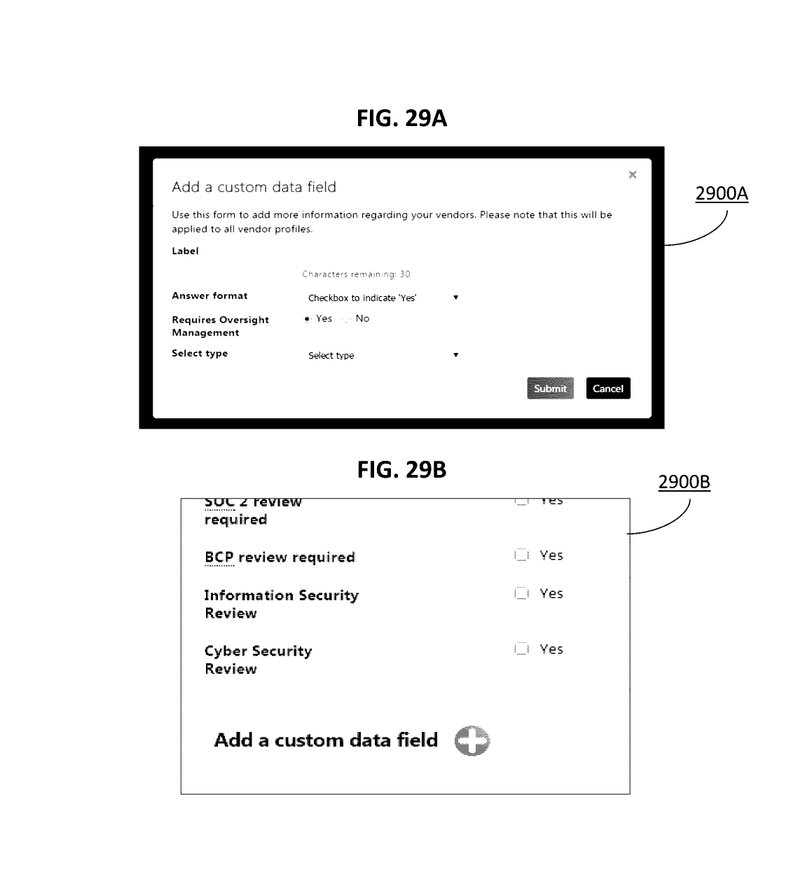

FIG. 29A illustrates a GUI and/or widget 2900A for customizing items and/or tasks associated with an oversight requirement, according to an exemplary embodiment. That is, the GUI and/or widget 2900A may be used to supplement the list of default or pre-provided tasks that may be assigned and/or created for an oversight requirement. For example, as shown in FIG. 29B, tasks that may be assigned with an oversight requirement may include “BCP review required,” “Information Security Review,” and “Cyber Security Review.” GUI and/or widget 2900A thus can be used to add other tasks, for example, by selecting a button, icon or the like to add a custom data field, as shown in FIG. 29B. Selecting the button, icon or the like to add a custom data field, in some example embodiments, causes the GUI and/or widget 2900A to be accessed and/or displayed.

As shown in FIG. 29A, the GUI and/or widget 2900A presents, displays and/or includes a label input, answer format input, requires oversight management input and type input. The label input is used to receive text or the like to be associated with the custom data field to be added to the tasks associated with an oversight requirement. The answer format input is used to receive text or a selection of the type of answer to be received (e.g., checkbox, radio button). The requires oversight management input is used to receive an input indicating whether the task to be created requires oversight management. The select type input is used to receive the type of task (e.g., business continuity, policies). Selecting the submit button causes the custom data field inputs to be stored, and the custom data field to be added to the list of tasks for one or more oversight requirements.

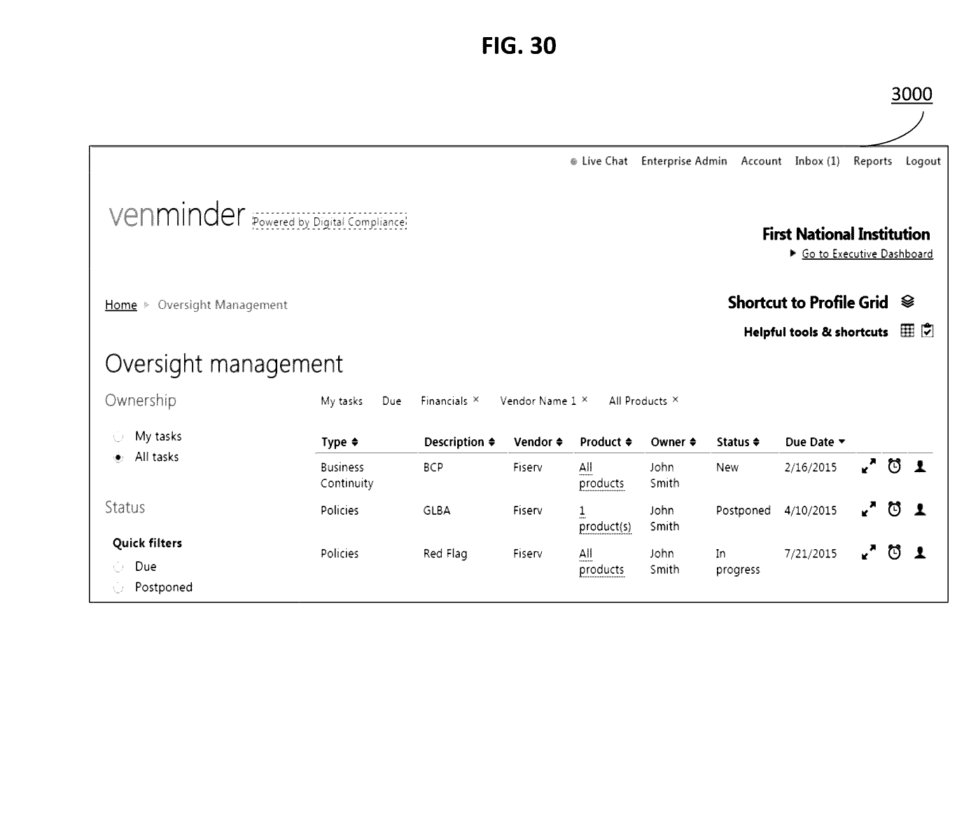

FIG. 30 illustrates an oversight management GUI and/or widget 3000 according to an exemplary embodiment. The GUI and/or widget 3000 may be used by user clients to manage tasks and the like associated with their vendors or vendors' products. As shown in FIG. 30, the GUI and/or widget 3000 includes a primary table, grid, chart or the like 3050. The table 3050 includes tasks associated with a client user. Each task is represented as a row in the table 3050, though it should be understood that tasks may be represented in different forms (e.g., columns) in the table. Information in the table 3050 may be sorted by selecting a column header, to sort the tasks based on the information in that column.

Each task is associated with various data fields including a task type, description, vendor, product, owner, status and due date. The task data fields are shown in corresponding columns in the table 3050, though it should be understood that task data fields may be represented in different forms (e.g., rows) in the table. The task type indicates a category or classification of the type, such as a business continuity task or a policies task. The description field is a brief text summary of the task, including BCP, GLBA and red flag (which are described above in more detail with reference to Table 5). The vendor and product fields indicate the vendor and its product for which the task is to be completed. The product field may include one or more products associated with the vendor, or a link to those products. The owner field indicates the person and/or entity to whom the task is assigned or who must complete the task. The status field indicates the progress of the task at the time of displaying the table 3050. For example, the status field may be new, postponed or in progress. The due date indicates a date, time or the like on which the task is expected and/or required to be completed, if any.

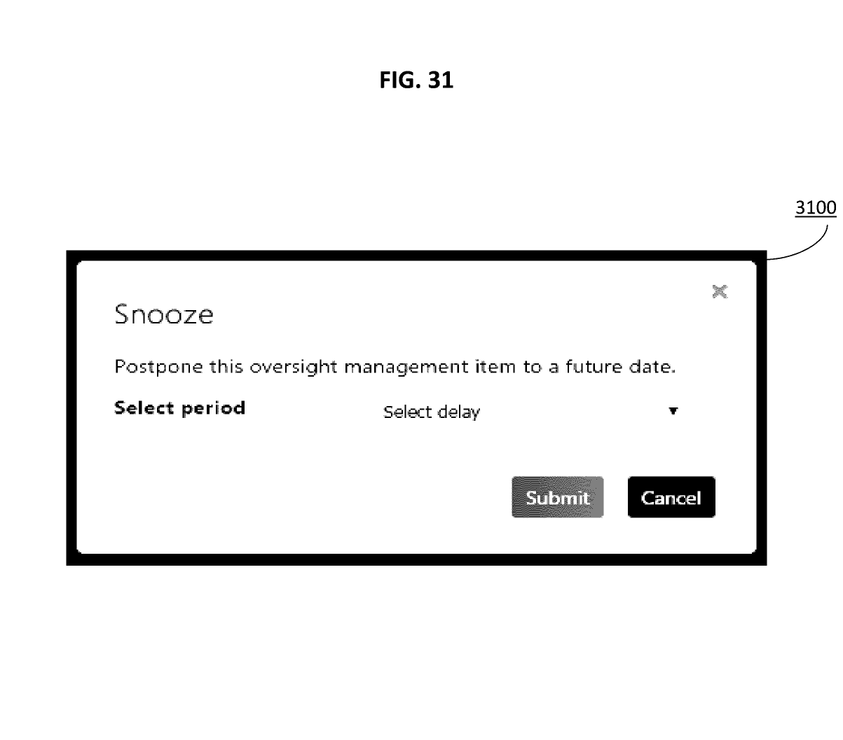

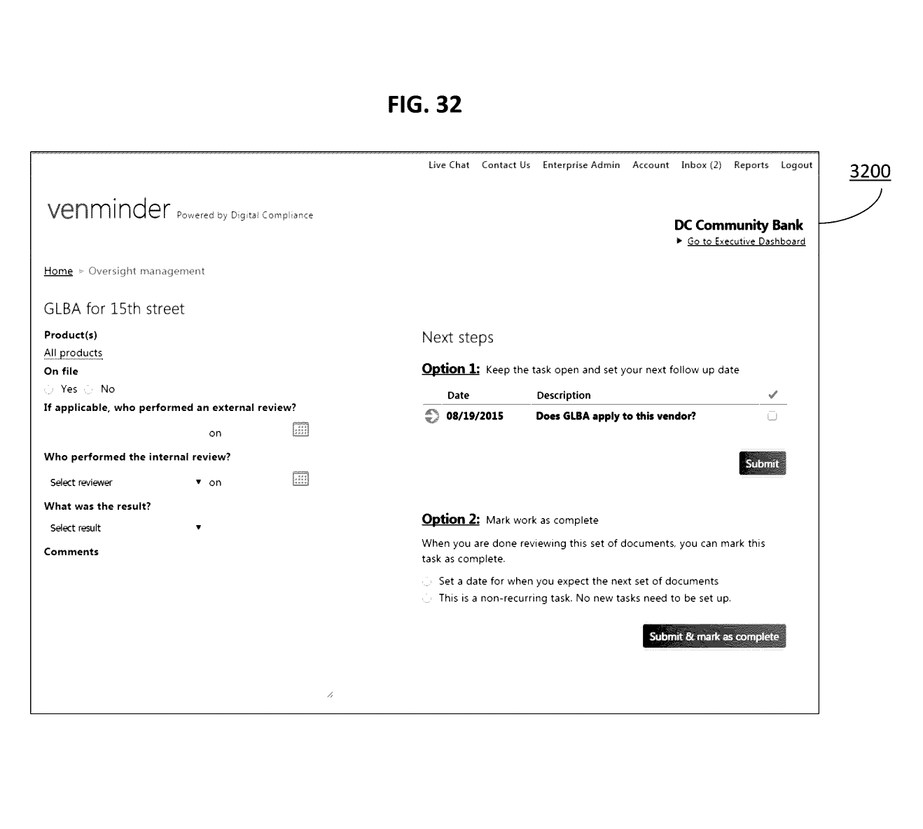

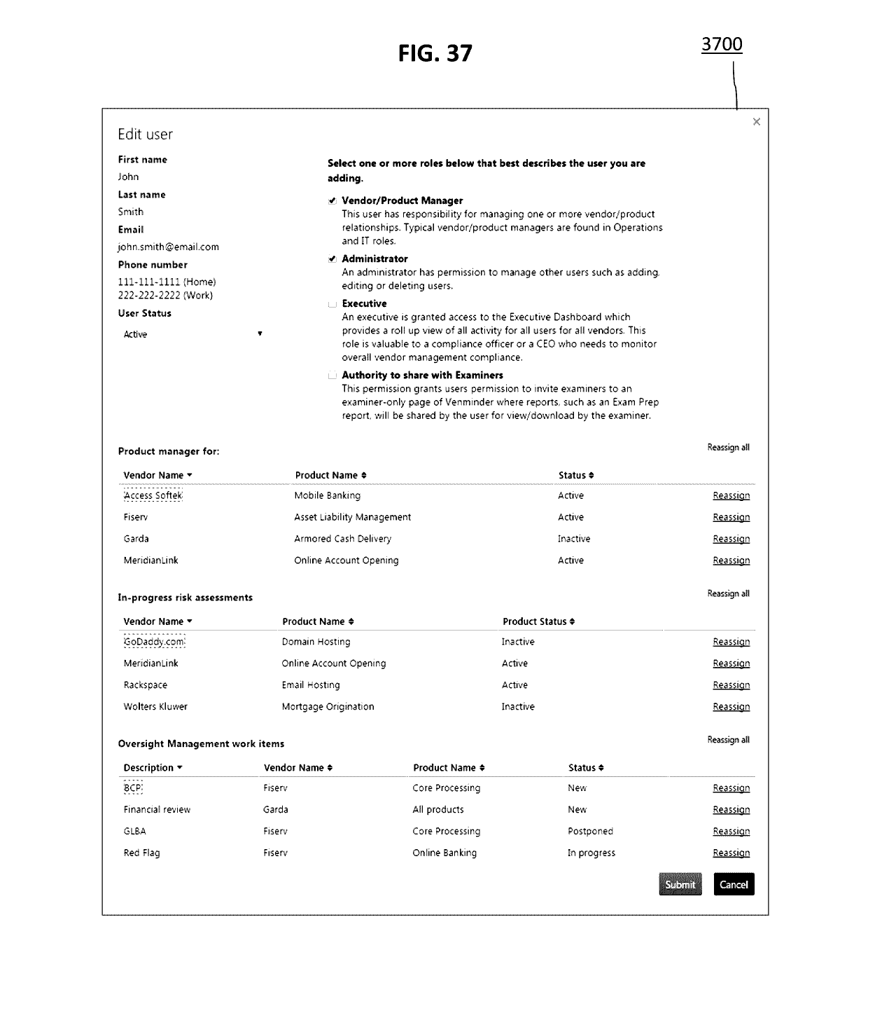

The table 3050 may also include icons 3052a, 3052b and 3052c, arranged in columns corresponding to each task. Selecting (e.g., clicking, tapping) the icon 3052a causes the corresponding task to be expanded, as described in further detail below with reference to FIG. 32 Selecting the icon 3052b causes a snooze GUI and/or widget to be displayed and/or loaded, as described in further detail below with reference to FIG. 31. Selecting the icon 3052c causes a GUI and/or widget for assigning or reassigning the task to another user, as described below in more detail with reference to FIG. 37.

The results displayed in the table 3050 may be filtered by one or more criteria including ownership (e.g., my tasks, all tasks), status (e.g., due, postponed, open tasks, completed tasks), task type (business continuity, FFIEC report of exam, financials, information security, insurance, OFAC, policies), vendors, and products. Filters may be applied by selecting a corresponding radio button, checkbox or the like. Selecting filters causes the tasks displayed in the table 3050 to be narrowed based on the criteria identified in each filter. In some example embodiments, selected filters are summarized and/or displayed as tags above the table 3050 (e.g., my tasks, due, financials, vendor name 1, all products). Tags corresponding to each filter or filter criteria may be closed out in order to remove the filter from the tasks, thereby providing rapid deletion of filter criteria.

FIG. 31 illustrates a snooze GUI and/or widget 3100 for “snoozing” a task according to an exemplary embodiment. Snoozing refers to postponing tasks that are due to a future date. As shown in the GUI and/or widget 3100, tasks may be snoozed and/or postponed using a drop down menu or the like. In some example embodiments, tasks can be snoozed and/or delayed by 30 days, 60 days, or 90 days. Snoozing tasks allows client users to view only those tasks that they are ready to work on at a given time.

FIG. 32 illustrates an expanded task GUI and/or widget 3200 according to an exemplary embodiment. The expanded task GUI and/or widget 3200 may be displayed and/or loaded (or caused to be displayed and/or loaded) when the icon 3052a in the table 3050 of FIG. 30 is selected. The expanded task GUI and/or widget 3200 is used to view and/or manage (e.g., edit) task information.

In some example embodiments, the GUI and/or widget 3200 includes one or more of radio buttons, text boxes, drop down menus, and the like that allow a client user to, among other things: attach relevant documents, record when an external review was performed, record when an internal review was performed, provide comments, set follow-up dates, mark tasks as complete, set up a next task for a vendor product's oversight requirement. Clicking a submit button in the GUI and/or widget 3200 causes any updated information regarding the task to be stored, for example, in a memory associated with an enterprise system.

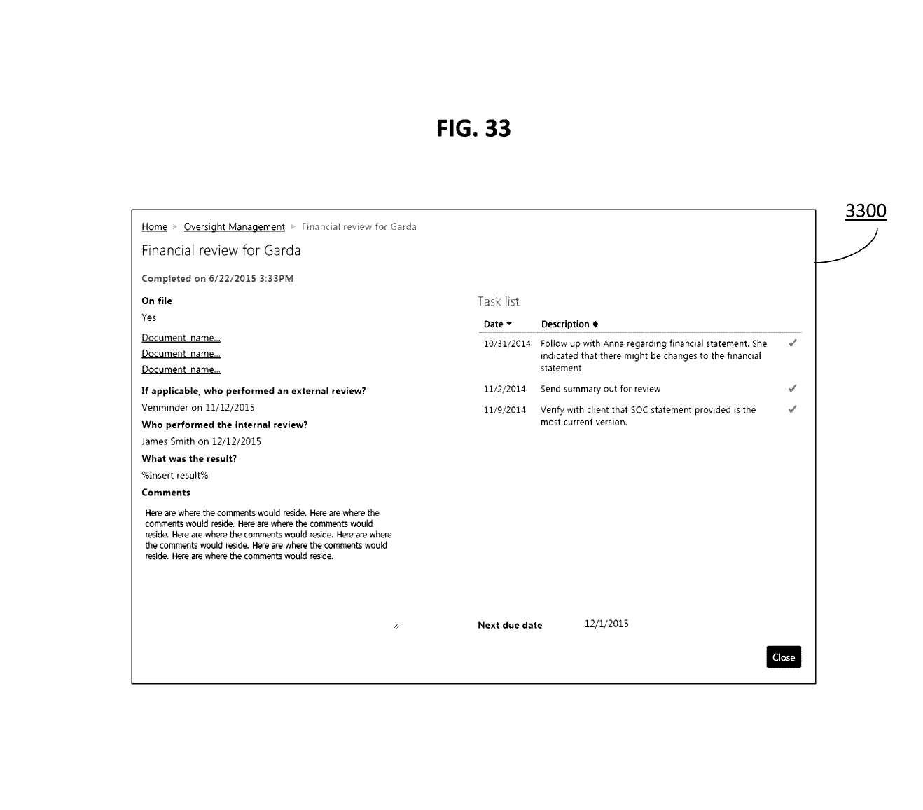

It should be understood that completed tasks may also be expanded. For example, selecting the icon 3052a corresponding to a completed task in the table 3050 of FIG. 30 causes the expanded task GUI and/or widget 3300 shown in FIG. 33 to be displayed and/or loaded. The GUI and/or widget 3300 is used to view or review task information. That is, the task information shown in GUI and/or widget 3300 is displayed, in some embodiments, as read-only data. The GUI and/or widget 3300 may include a time stamp on which a task was completed, and the next due date of the task.

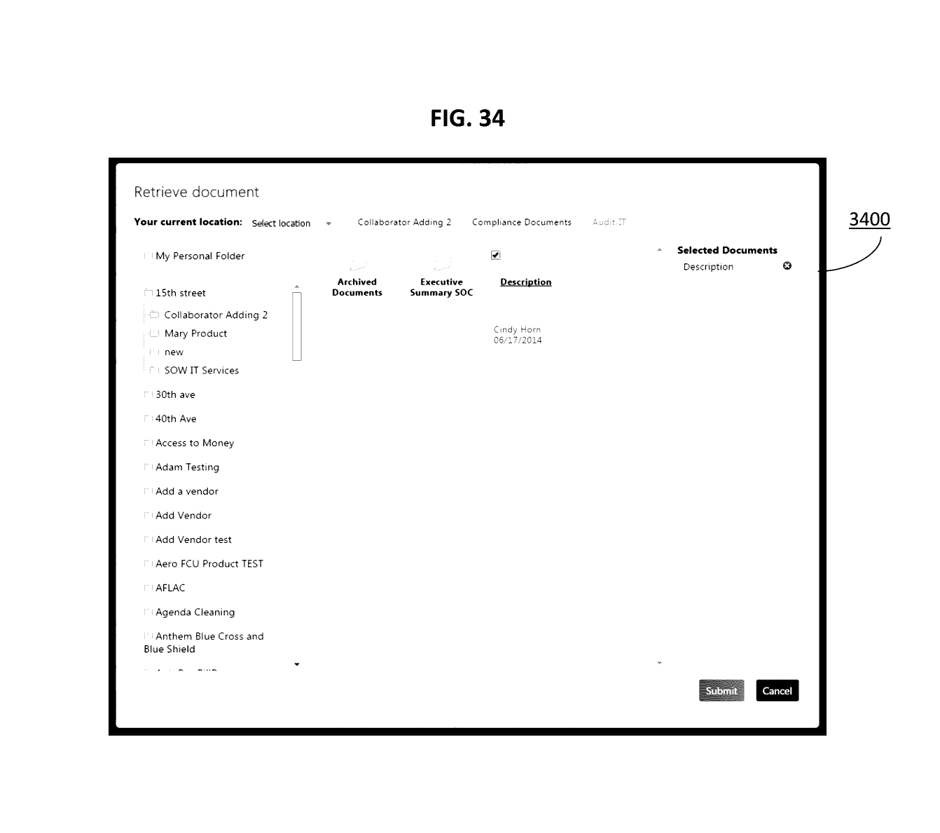

FIG. 34 illustrates a GUI and/or widget 3400 for managing documents associated with oversight tasks, according to an exemplary embodiment. The document management GUI and/or widget may be accessed, for example, via an expanded task GUI and/or widget (e.g., 3200, 3300) by selecting (e.g., clicking) a button or the like to attach relevant documents. Using the GUI and/or widget 3400, client users can view and manage which documents are relevant to and/or associated with tasks, and retrieve documents for viewing.

As shown in FIG. 34, a client user is prompted to retrieve a document to attach to a task (e.g., to associate with a task). The client user may access directories on the client user system or directories stored on the enterprise system. In some example embodiments, the directories are associated with different tasks, vendors, vendor products, or the like. Selecting a directory (e.g., vendor directory) causes sub-directories and/or documents associated with that directory to be displayed for selection. One or more of the displayed documents is selected and attached (e.g., associated with a task) by selecting the submit button in the GUI and/or interface 3400.

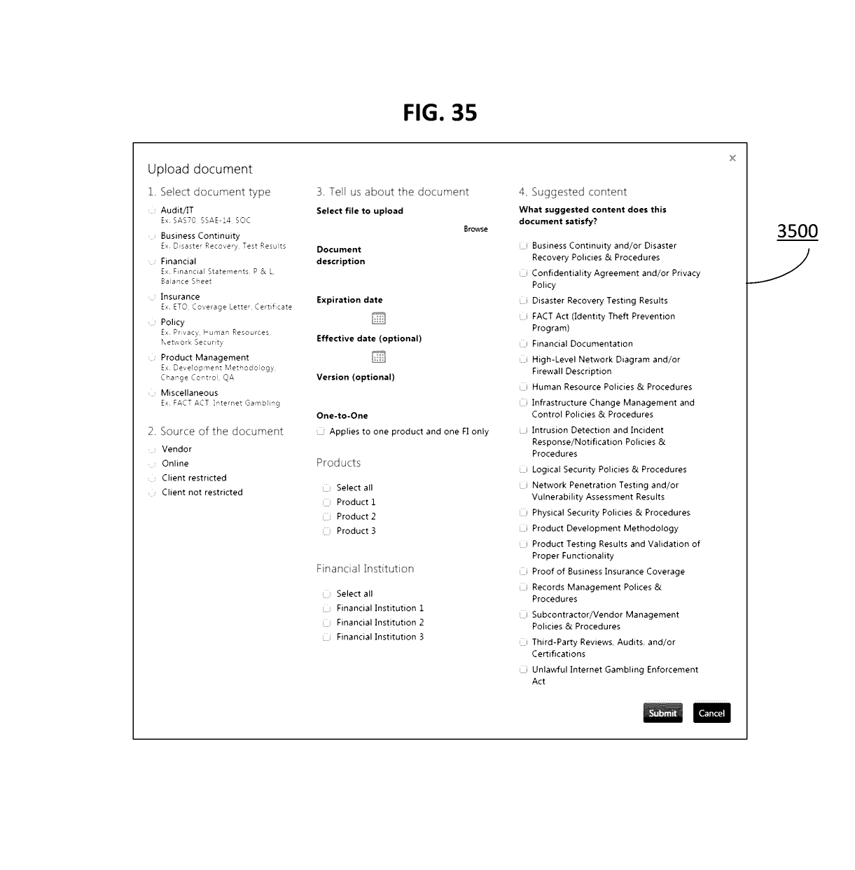

FIG. 35 illustrates a GUI and/or widget 3500 for collecting documents according to an exemplary embodiment. The document collection GUI and/or widget may be used to upload a document and provide information associated with the document. The documents may be received from any computing device including a user client and/or enterprise system, and stored in a memory associated with enterprise system in association with the collected document information.

The document may be uploaded by browsing to the location where the document is stored. In some example implementations, the document information collected via the GUI and/or widget 3500 includes one or more of a document type, source, location of document, description, expiration date, effective date, version, indication of one-to-one correspondence, associated products, associated financial institutions, and suggested content. In some example embodiments, the document type indicates a classification of the document being uploaded, such as audit/information technology (IT), business continuity, financial, insurance, policy, product management and miscellaneous. The source of the document may be a vendor, online, client restricted or client not restricted. A document description is a summary or the like describing the document. The effective and expiration dates indicate dates on which the uploaded document becomes relevant or ceases being relevant to a task, respectively.

As shown in FIG. 35, a document may be associated with one or more products (e.g., Product 1, Product 2, Product 3) and/or financial institution (e.g., Financial Institution 1, Financial Institution 2, Financial Institution 3). This way, a task that is created and/or managed via an oversight management GUI and/or widget (e.g., FIG. 30, widget 3000) will have documents automatically mapped to it if the task and document are associated with matching vendors, financial institutions or the like. That is, uploads of and/or changes to documents via the GUI and/or widget 3500 cause those changes to be automatically reproduced at an oversight management GUI and/or widget (e.g., FIG. 30, widget 3000).

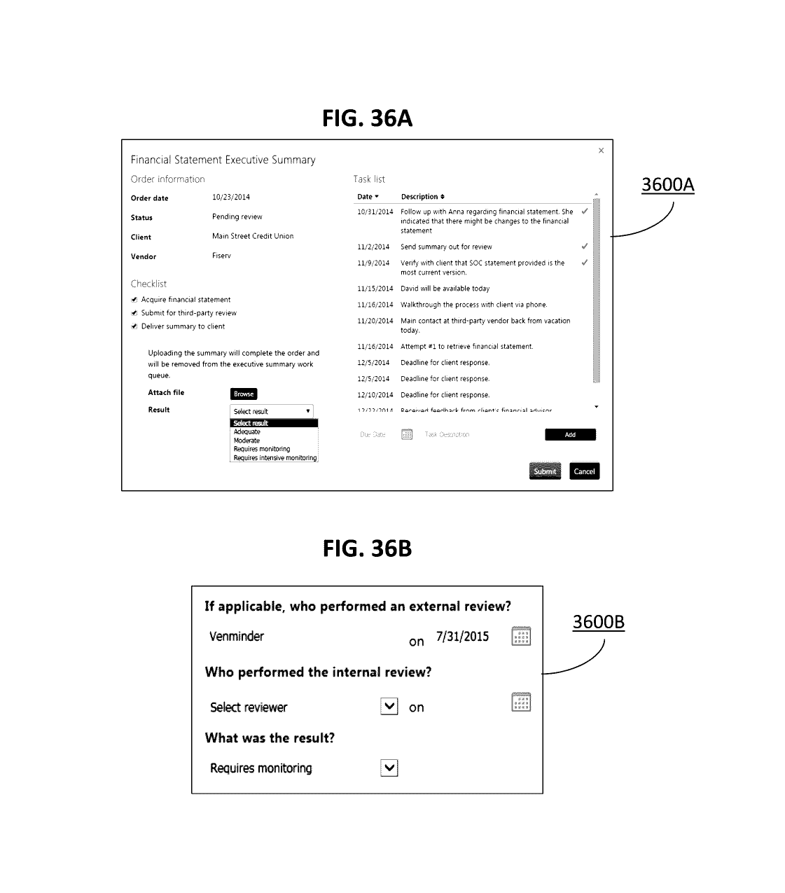

FIG. 36A illustrates a GUI and/or widget 3600A for providing executive level analysis of oversight requirements according to an exemplary embodiment. The GUI and/or widget 3600A) allows user clients to view information associated with an oversight requirement, and review the results and completion date of the oversight requirement. For example, as shown in FIG. 36A, a financial statement executive summary is shown, indicating an order date, status, client, vendor, a checklist of work items, and a result. Submitting and/or uploading an executive level summary (e.g., 3600A) causes a prompt, shown in FIG. 36B to be displayed. The prompt in 36B is used to collect details about the uploaded and/or submitted executive level summary (e.g., FIG. 35), such as who performed the external review, who performed the internal review, dates on which those were performed, and the result.

FIG. 37 illustrates a GUI and/or widget 3700 for managing users according to an exemplary embodiment. The GUI and/or widget 3700 may be used to see a list of oversight tasks owned and/or assigned by a client user. In some example embodiments, the GUI and/or widget 3700 is referred to as an “admin” or “administrator” GUI and/or widget because it requires an administrator-level permissions to be granted to the user in order to access it.

The GUI and/or widget 3700 may be used to view and/or edit a user and/or user information. For example, as shown in FIG. 37, user information may be displayed such as the user's first name, last name, e-mail, phone numbers and status (e.g., active, inactive). Roles associated with the user may be viewed and/or edited. For example, the user may be assigned roles such as vendor/product manager, administrator, executive, and authority to share with examiners (e.g., invitation-level access). The GUI and/or widget 3700 may also display products with which the user is associated, risk assessments associated with the user, and oversight management work items or tasks associated with the user. Products, risk assessments and work items may be arranged in corresponding tables in widget 3700, along with associated information such as product name, vendor name, status, description, and the like. This allows an admin user to easily view and manage a user's workload (e.g., assigned tasks).

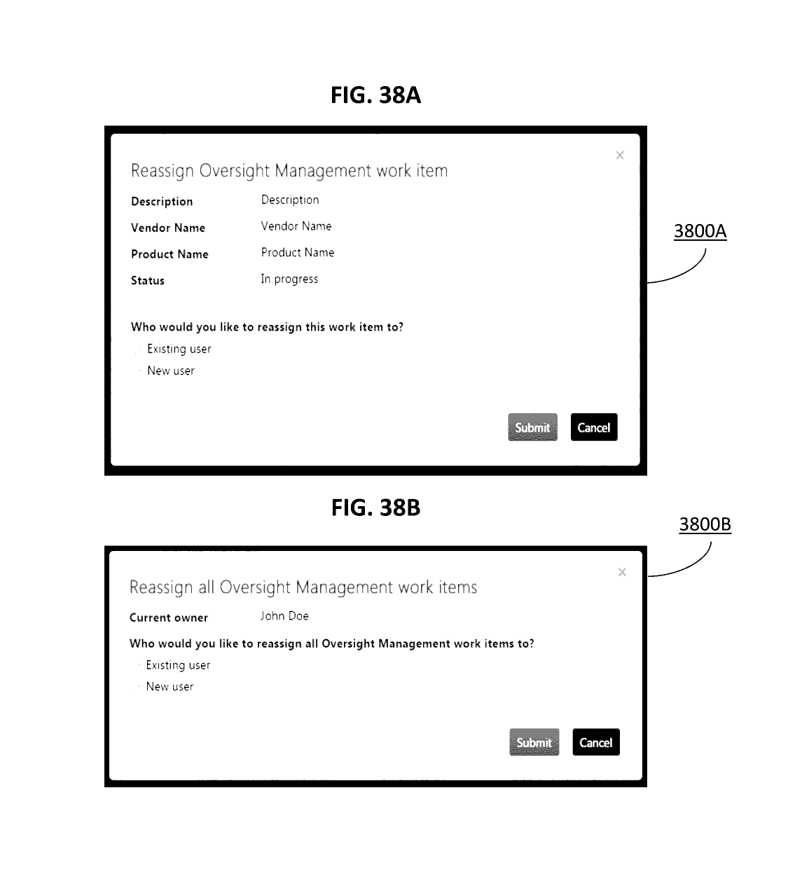

In some example embodiments, products, risk assessments and work items assigned to users may be reassigned to other users, for example, via a reassign button, link or the like on a user management GUI and/or widget (e.g., FIG. 37). Selecting a reassign button, link, or the like causes one or more prompts to be loaded and/or displayed (e.g., FIGS. 38A, 38B).

FIG. 38A illustrates a GUI and/or widget 3800A for reassigning a single task or work item to another user, according to an exemplary embodiment. The GUI and/or widget 3800A includes one or more of a description of the work item, vendor name, product name and status. The GUI and/or widget 3800a may also include selectable options (e.g., radio buttons) to indicate whether the work item (e.g., task) is to be reassigned to a new or existing user. FIG. 38B illustrates a GUI and/or widget 3800B for reassigning all oversight management work items associated with one user to another user, according to an exemplary embodiment. The GUI and/or widget 3800B may indicate the name of the current owner of the work items (e.g., John Doe) and an indication of whether the work items are to be reassigned to a new or existing user.

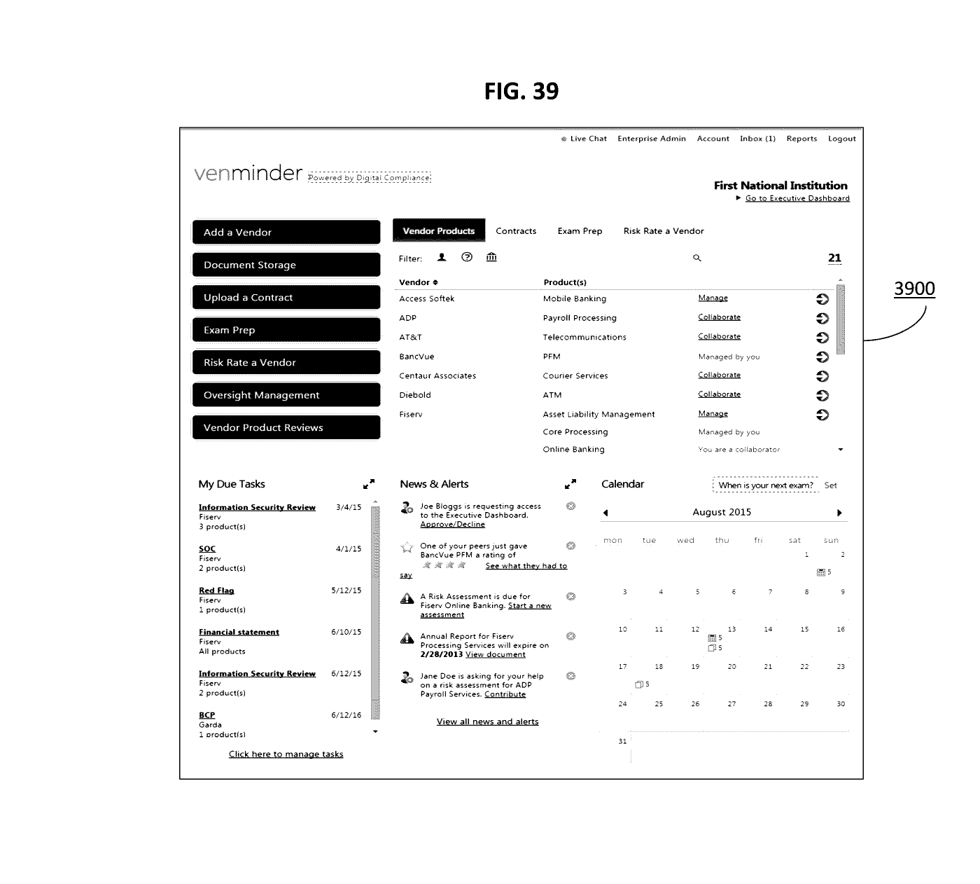

FIG. 39 illustrates an enterprise dashboard GUI and/or widget 3900, according to an exemplary embodiment. The dashboard GUI and/or widget 3900 allows users to centrally visualize and manage a vast amount of information including vendor product information, calendar of exams, news and alerts, and tasks due. The “My Due Tasks” portion or component includes a list of tasks assigned to the user of the dashboard that are in a “due” or “currently due” status. Via the “My Due Tasks” portion or component of the widget 3900, the user may quickly access a task by selecting the corresponding icon and/or button on the list. In some example embodiments, updates and/or notifications regarding tasks due, news, alerts, upcoming exams, or the like can be sent to the user (e.g., via e-mail) when they are pending or modified (e.g., changed, reassigned).

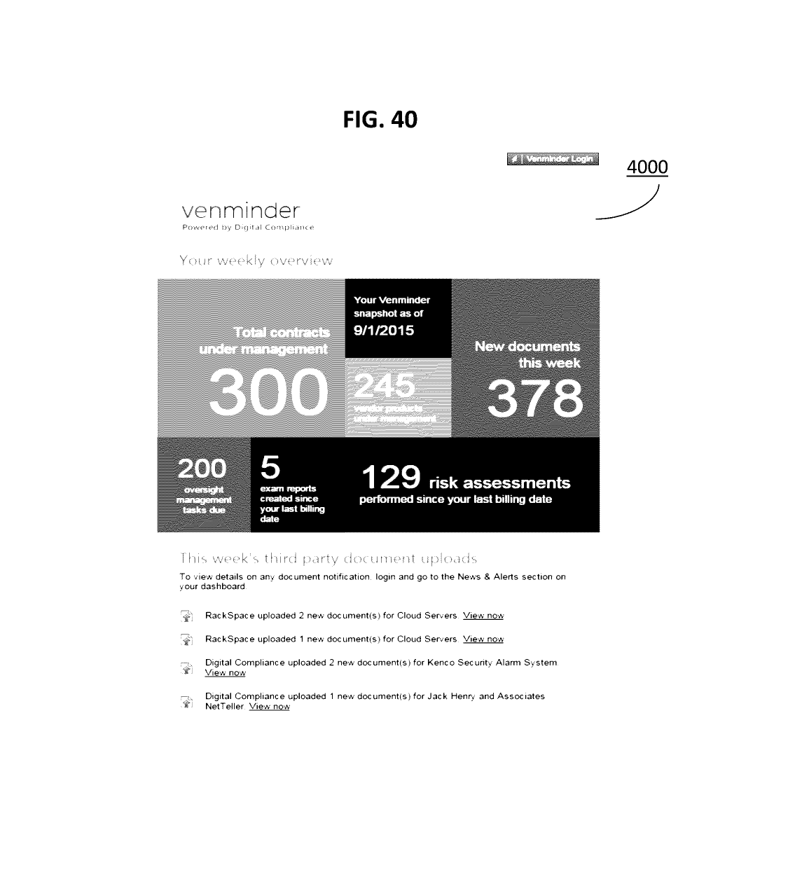

FIG. 40 illustrates a GUI and/or widget 4000 of a weekly overview according to an exemplary embodiment. The weekly overview information may be sent to the user via the user's e-mail or displayed and/or caused to be displayed at the user's computing device. The weekly overview may include information such as oversight management tasks due, contracts under management, exam reports created in a predetermined amount of time, risk assessments performed in a predetermined amount of time, products under management, and new documents. The weekly overview may also include links to new documents, to quickly cause the documents to be retrieved and/or displayed at the client user computing device.

In some example embodiments, client users may generate reports such as oversight status reports, oversight task reports, dashboard reports, and the like. Reports may be generated via one or more GUIs or widgets.

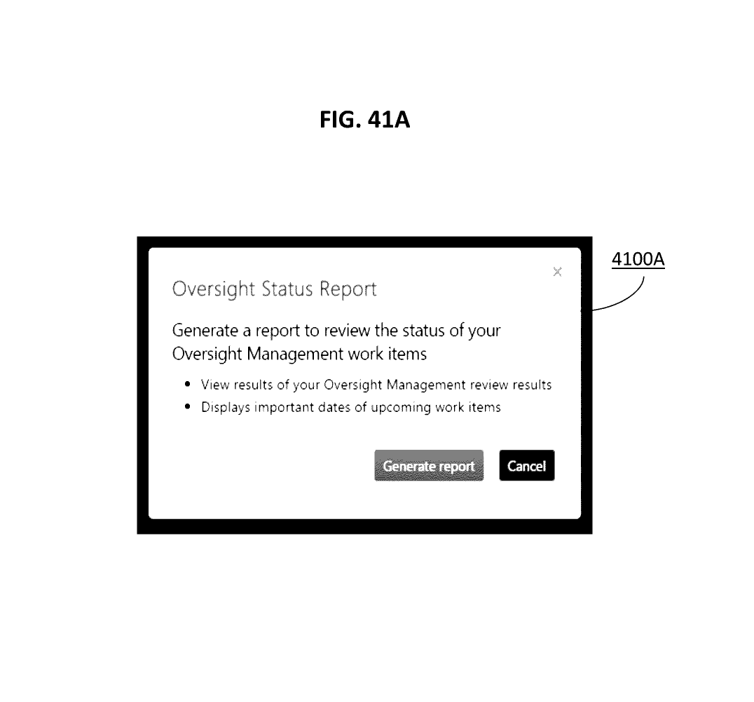

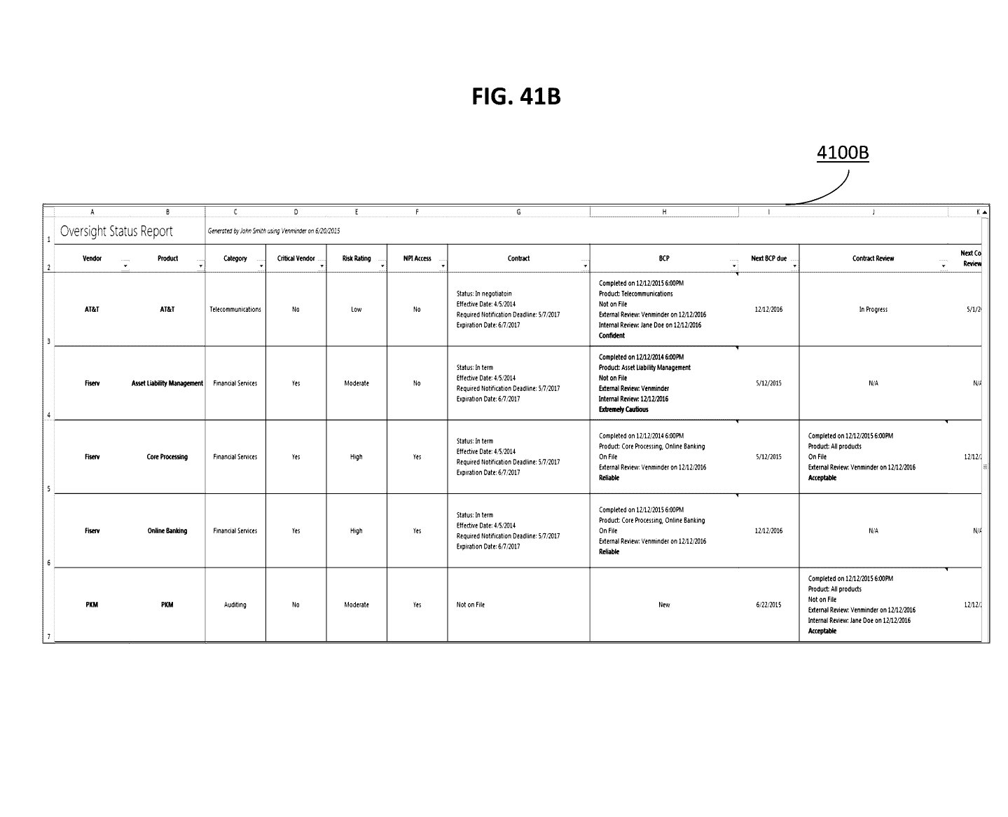

FIG. 41A illustrates a GUI and/or widget 4100A for generating an oversight status report according to an exemplary embodiment. Selecting a “generate report” button or icon in the GUI and/or widget 4100A causes an oversight status report for the client user to be generated and/or displayed, as shown in FIG. 41B. That is, FIG. 41B illustrates an oversight status report 4100B according to an exemplary embodiment. As shown in FIG. 41B, the oversight status report may include one or more of a vendor, product, category, critical vendor indication, risk rating, NPI access indicator, contract information, BCP information, next BCP due date, contract review status, next contract review due date, and the like. This report information may be arranged in a table, in which each row corresponds to a different product. In some example embodiments, the table may be a spreadsheet in which column headers include tabs used to filter and/or narrow down information. Color coding and the like may be used to highlight and or distinguish different statuses and/or data.

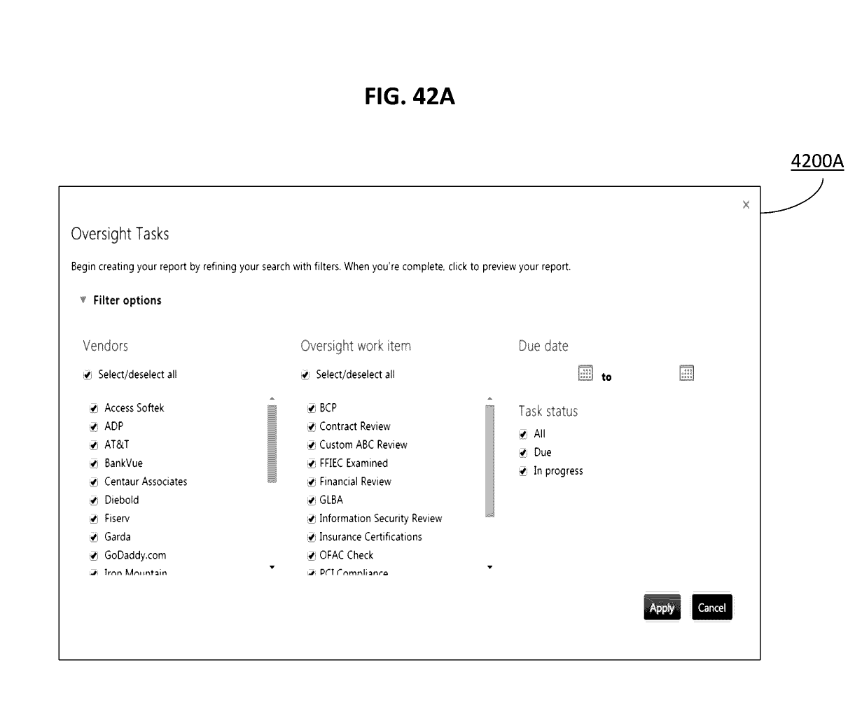

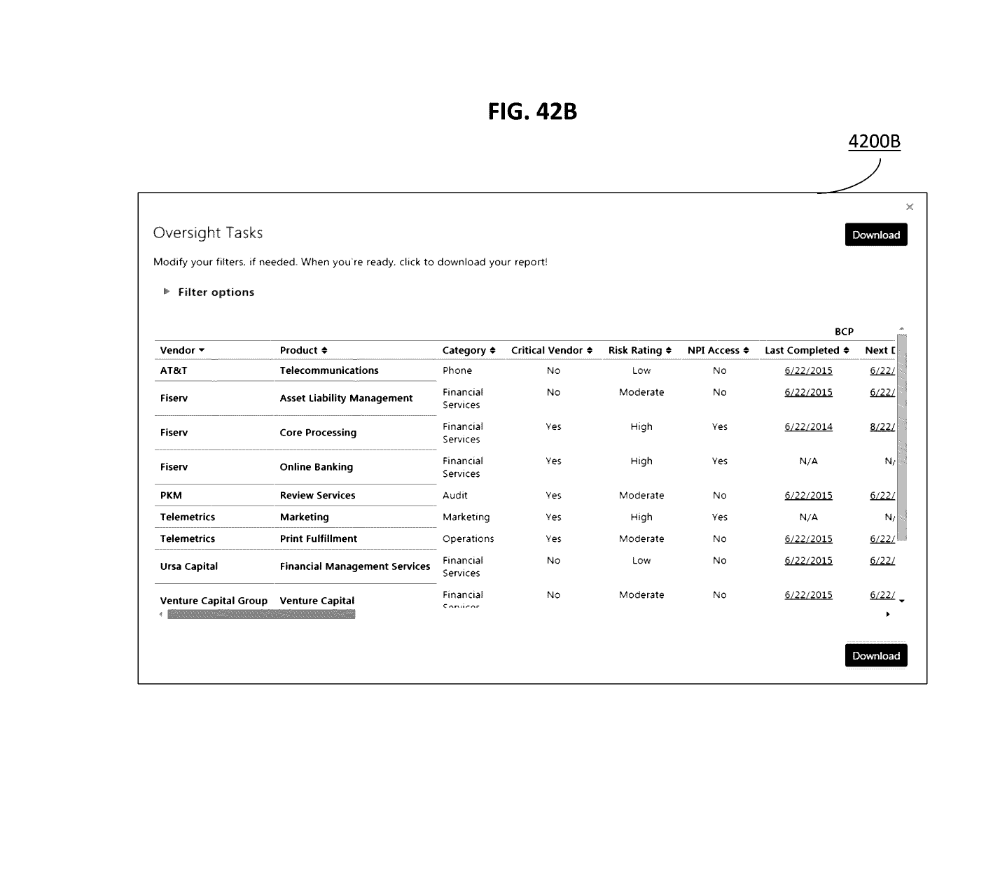

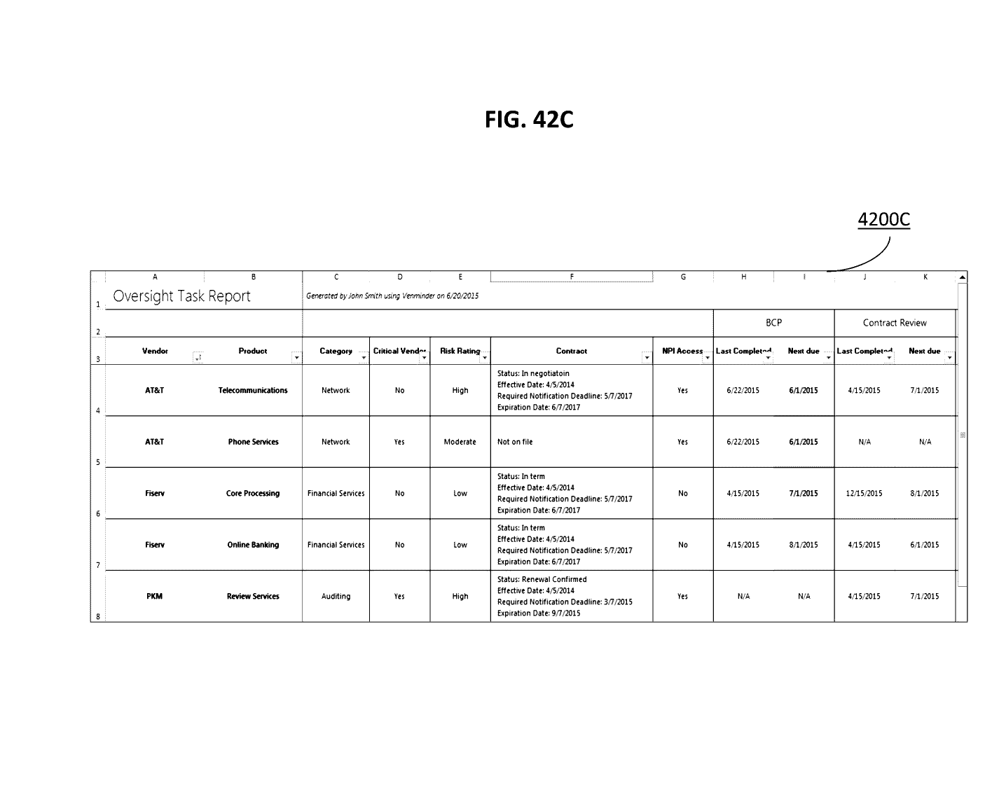

FIG. 42A illustrates a GUI and/or widget 4200A for generating a task report according to an exemplary embodiment. As shown in FIG. 42A, filter options are presented for generating a report. That is, the report can be filtered and/or narrowed by vendor types, types of work items (e.g., tasks), due dates, status, or the like. Selecting the “Apply” button causes the report to be generated in a table, as shown in FIG. 42B. The generated report may be downloaded into a spreadsheet or the like, shown in FIG. 42C, by selecting a download button in FIG. 42B. As shown in FIGS. 42B and 42C, the task report may include vendor name, product information, category, critical vendor indicator, risk rating, contract information, NIP access indicator, last completed BCP date, next BCP due date, last completed contract review date and next contract review due date. Information may be sorted by column by selecting a column header or the like.

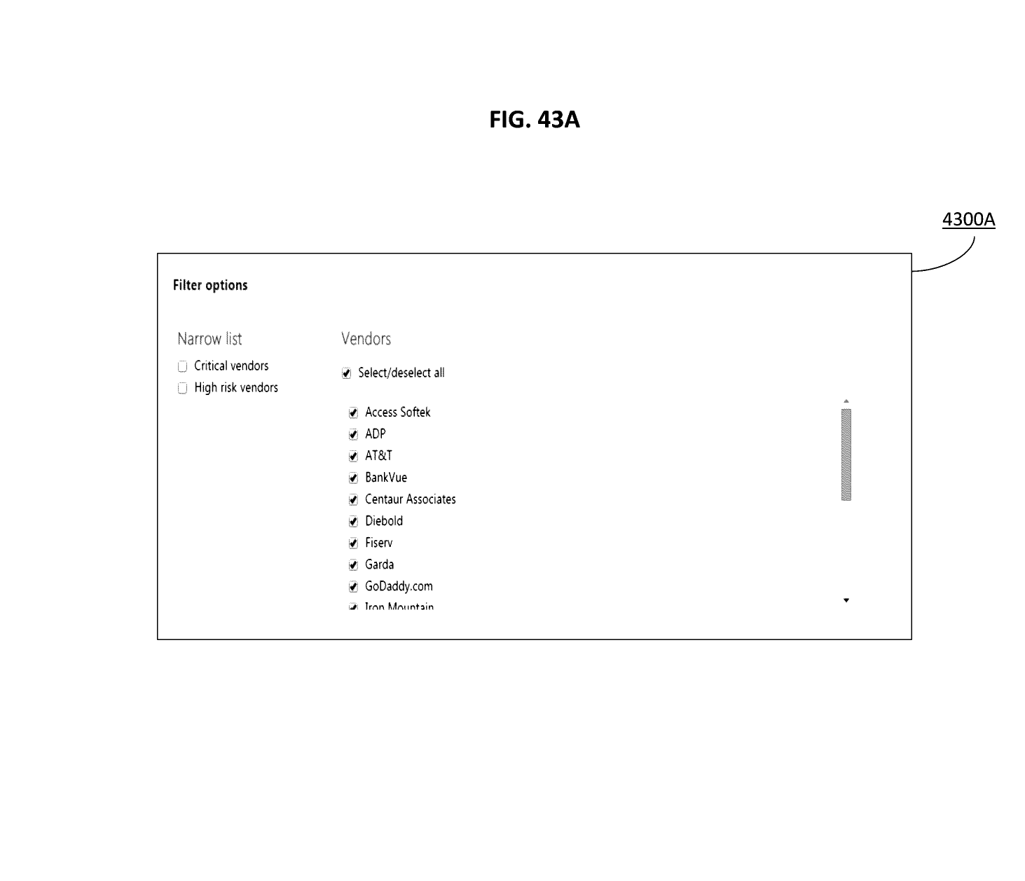

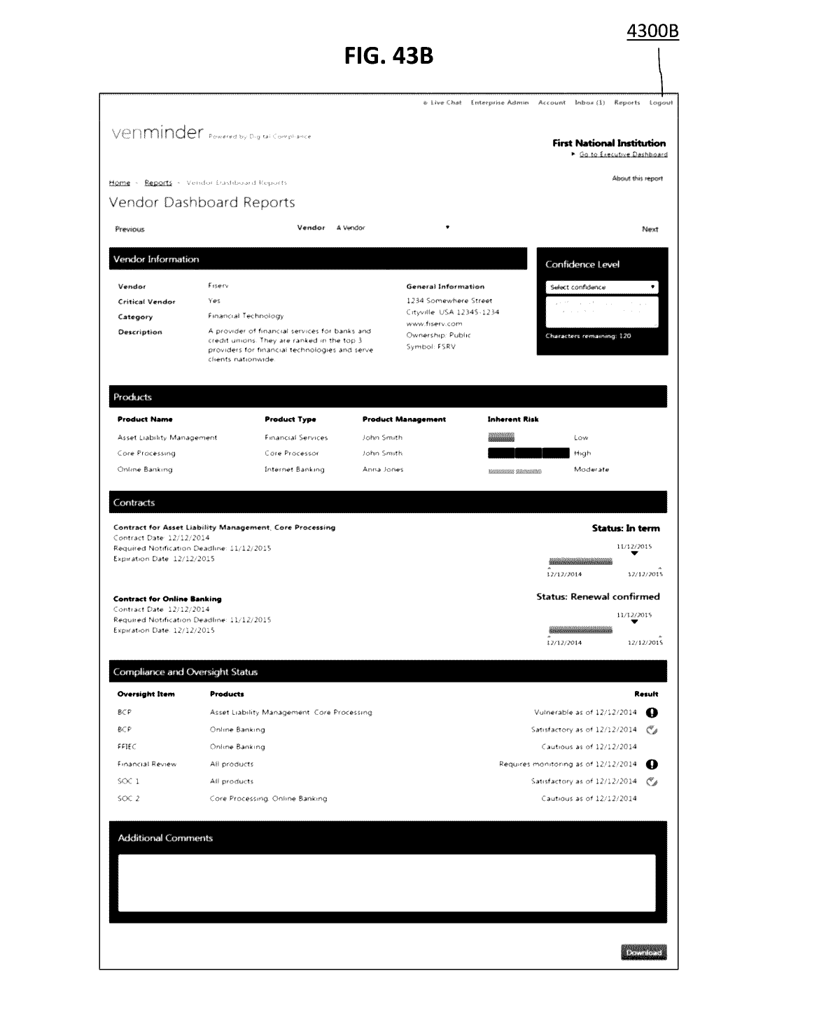

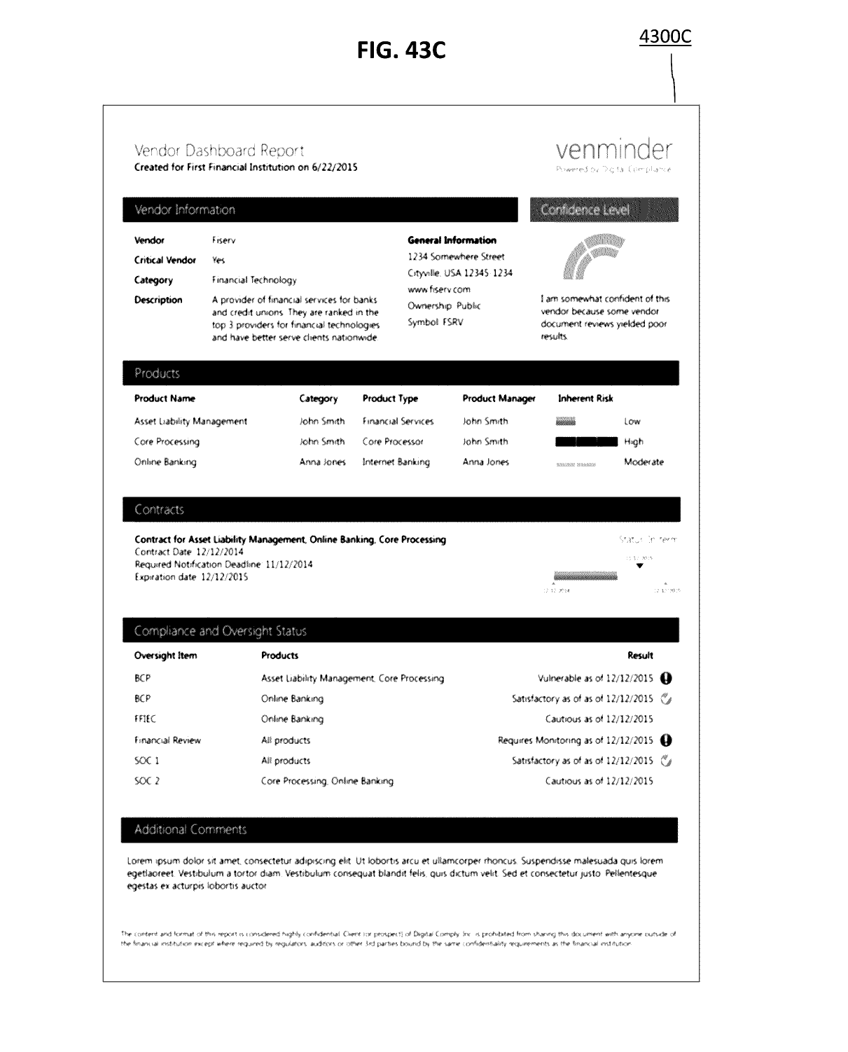

FIG. 43A illustrates a GUI and/or widget 4300A for generating a vendor dashboard report for a particular vendor, according to an exemplary embodiment. The GUI and/or widget 4300A is used to select one or more vendors or vendor types (e.g., critical vendors, high risk vendors) for which to create a vendor dashboard report. Once the vendor or vendors are selected, a button link or the like can be clicked to generate the report. FIG. 43B illustrates a vendor dashboard report generated for vendor “Fiserv.” The venodor dashboard report includes vendor information (e.g., vendor name, critical vendor indicator, category, description, and general contact information), vendor product information (e.g., list of products, product names, types, manager and risk level), contracts information for contracts associated with the vendor (e.g., contract scope, date, notification deadlines, expiration date, status), and compliance and oversight status information (e.g., oversight items, products, and result). Other vendor information stored in memory associated with the enterprise system includes comments about the vendor and a confidence level assigned to the vendor.

The vendor dashboard report shown in FIG. 43B may be downloaded by selecting a download button or the like, which causes a PDF, text file, report file, or the like to be generated and/or stored, as shown in FIG. 43C. The downloaded report may have all, more than, or less than the report shown in FIG. 43B. The downloaded report may then be transmitted, for example, to board members and other interested entities.

Vendor Questionnaire

In another aspect of an embodiment, the system 100 further provides a vendor questionnaire that provides a client with the ability to send questionnaires to a vendor and review the vendor's responses as a basic component of performing due diligence and oversight management of a relationship. Although similar to risk assessment questionnaires, a vendor questionnaire differs in key aspects.

A vendor questionnaire can cover a wide range of topics. In some implementations, a vendor questionnaire can include industry standard sets of questions such as Infosec or SIG/SIG Light. In some implementations, a vendor questionnaire can help establish a relationship with key vendor contacts. In some implementations, a vendor questionnaire can be a mechanism for obtaining specific types of documentation. In some implementations, a vendor questionnaire can assist the vendor in reviewing their own policies and procedures. In some implementations, a vendor questionnaire can be a conduit for any comments the vendor wishes to make to their client. In some implementations, a vendor questionnaire can be a key part of performing a deeper risk assessment exercise. In some implementations, a vendor questionnaire can make the task of vendor selection much easier.

Although a client may rely on existing vendor contracts and public information as sources of data relating to a vendor, not all contracts may include provisions covering the small details of such things as internal disaster recovery plans or IT breach protocols. In addition, a number of client/vendor relationships never go beyond the fee-for-service model that can overlook some elements of risk or weakness.

In some implementations, a system as described herein comprising a questionnaire function can be designed to assist vendor management and compliance personnel with the detailed and time-consuming effort of gathering and reviewing information about a vendor prior to entering into a contractual relationship, and can be repeated during the course of a contract term. In some implementations, a vendor questionnaire can simplify the process of creating global questionnaire attributes, building and customizing reusable questionnaires, managing distribution, monitoring progress, reviewing responses, and storing documents. In some implementations, it is based on a set of workflows that follows the natural progression from creating a first questionnaire template through storing and archiving reviewed responses.

In some implementations, a system as described herein comprising a questionnaire function is a part of the overall management of vendors, and has not only value as a stand-alone effort, but also plays a key role in an Enterprise solution by dovetailing with Risk Assessment, Oversight Management, and Exam Prep. In some implementations, a completed questionnaire can be shared across the organization and with examiners, and can also support reporting to senior management.

In some implementations, because of the proprietary nature of the solution, the functionality of sending questionnaires is domain locked, i.e., a client cannot just send a questionnaire to anyone at the client's discretion. In some implementations, a client is constrained to send a questionnaire to a potential vendor with a known contact/domain or with whom the client may have an established relationship. A recipient vendor cannot then circulate the questionnaire (e.g., using a supplied login) outside of the vendor's own organization. Without wishing to be bound by theory, this is to protect the overall design, workflows, and feature functionality from piracy or the inappropriate release of proprietary information. Additionally, in some implementations, neither a client nor a vendor can use a vendor questionnaire function to send and share questionnaires to certain generic email domains, such as free mail servers or the like, reducing the likelihood that such materials end up in the hands of anyone outside of a vendor or client domain.

In some implementations, download for a client is presented as a zip file containing a PDF of the filled-out questionnaire, a folder containing attached documents, and an Excel spreadsheet containing the questionnaire and including a tab for the client-supplied confidentiality statement.

To this end, the system 100 may provide a graphical user interface configured to display one or more prompts for user entries associated with a vendor questionnaire as described herein.

### Client Side

In some implementations, when a client intends to create a first questionnaire, a client can create a template that is used for all subsequent questionnaires. From a single template, a client can create any number of questionnaires by building out the sections and questions within the sections. In some implementations, every questionnaire can use the same global template variables (e.g., introduction and confidentiality agreement).

In some implementations, a questionnaire can be built from scratch, or a client may use a standardized example provided in some implementations and edit as desired. A client may build up a library of questionnaires that are reusable and editable, and that can be used as a basis for creating new questionnaires, e.g., to save time and work via cloning.

In some implementations, to send a questionnaire, a client user can first select a vendor, then choose a questionnaire deadline, and finally select an addressee (vendor contact from the client's address book). In some implementations, vendor contact information can be added if desired.

In some implementations, next, a client can select which questionnaire to send. A client can preview any questionnaire in the client's list of available final version questionnaires before committing to use it. The client can rename any questionnaire should the client feel that the internal name originally supplied will not be as suitable.

In some implementations, a client will be presented with a template displaying an email that will be distributed to a vendor when a questionnaire is sent. The client can update this email by providing customized introductory text and/or a custom message that will be inserted into this email.

In some implementations, prior to sending, a client will be able to view the finalized version an email to be sent. In some implementations, once sent, a confirmation of the send can be generated for the client and the questionnaire can appear, e.g., in the Manage Responses area.

In some implementations, a client can review the progress of a sent questionnaire by viewing the Manage Responses grid, which is, e.g., a sortable list of all sent questionnaires with their status and other information. In some implementations, this list can include sent, completed, in progress, and/or declined questionnaires. In some implementations, the view can be filtered to shorten the list.

In some implementations, a completed questionnaire can be editable by a client in that the client is able to add comments to it at the question level, and can add an attachment, e.g., the client's own attachment. In some implementations, a completed questionnaire can be downloaded. In some implementations, a completed questionnaire can be downloaded only after any client changes are saved.

In some implementations, when a questionnaire is saved by a client, a copy is placed, e.g., in the client's Document Storage area in a root folder named, e.g., “Questionnaires.” In some implementations, the same questionnaire may be saved multiple times. In some implementations, the same questionnaire may be saved multiple times, wherein a newer version replaces a previous version that is moved to an archive folder.

In some implementations, a template may be changed at any time, but all existing questionnaires can retain the original template's format.

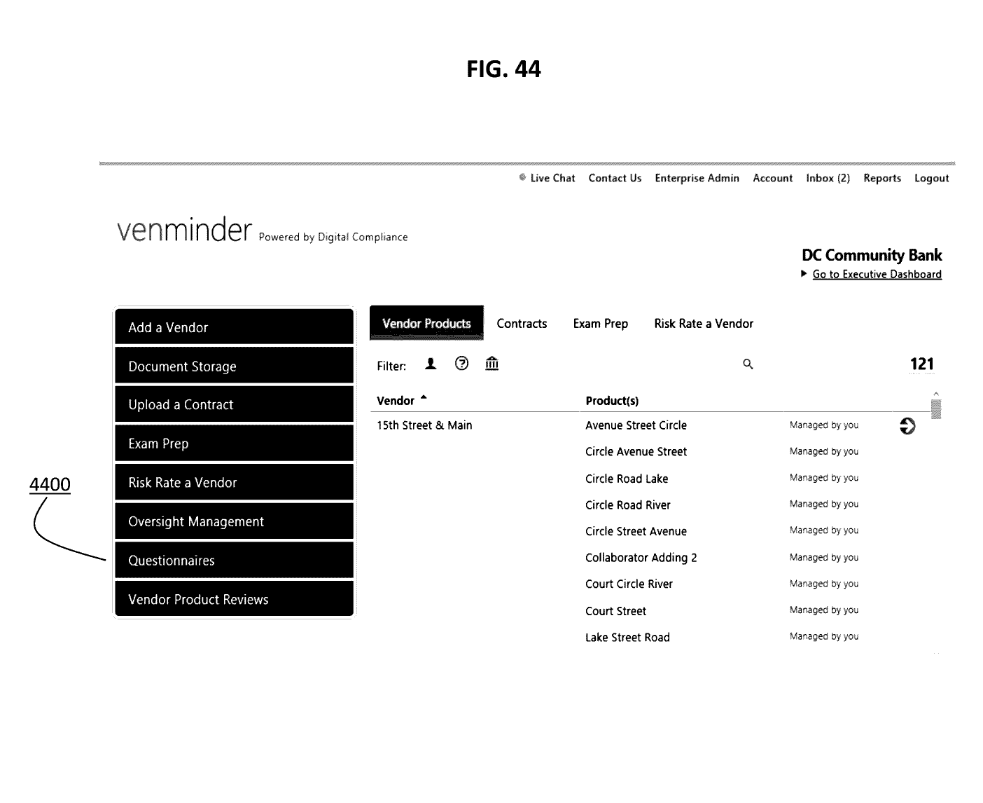

FIG. 44 illustrates a Main Dashboard GUI according to an exemplary embodiment. In some implementations, the Main Dashboard GUI can comprise a tab 4400 to navigate to a questionnaire function.

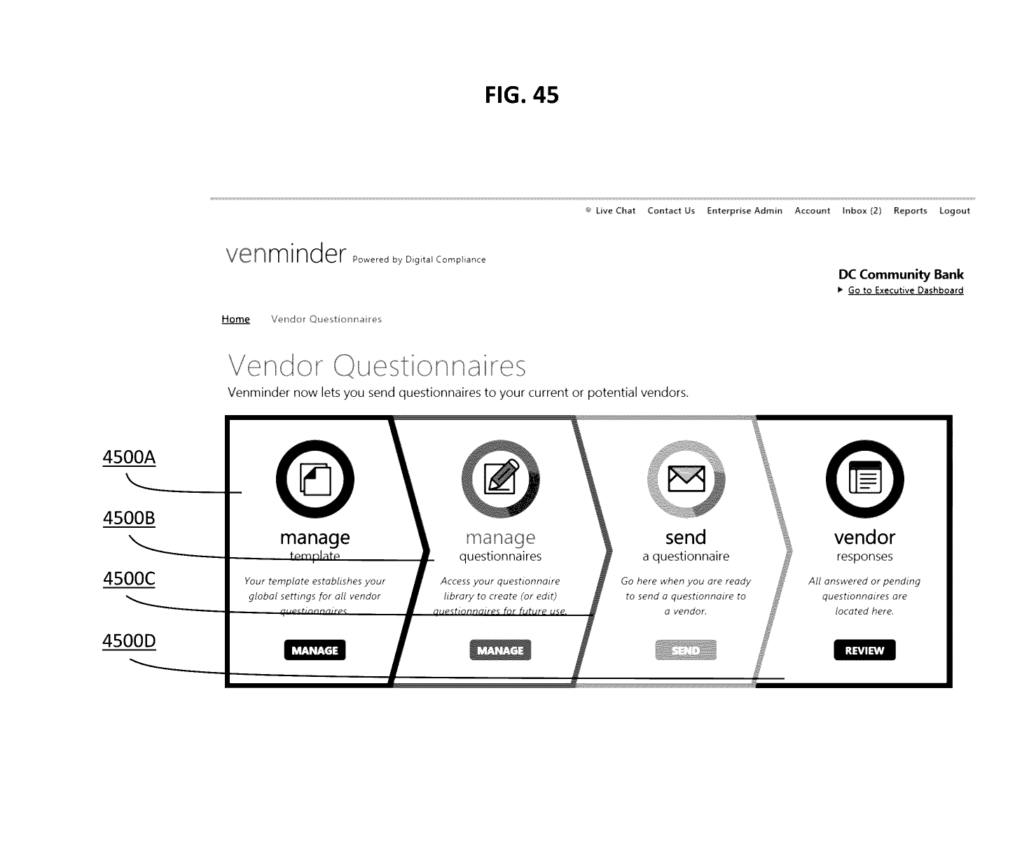

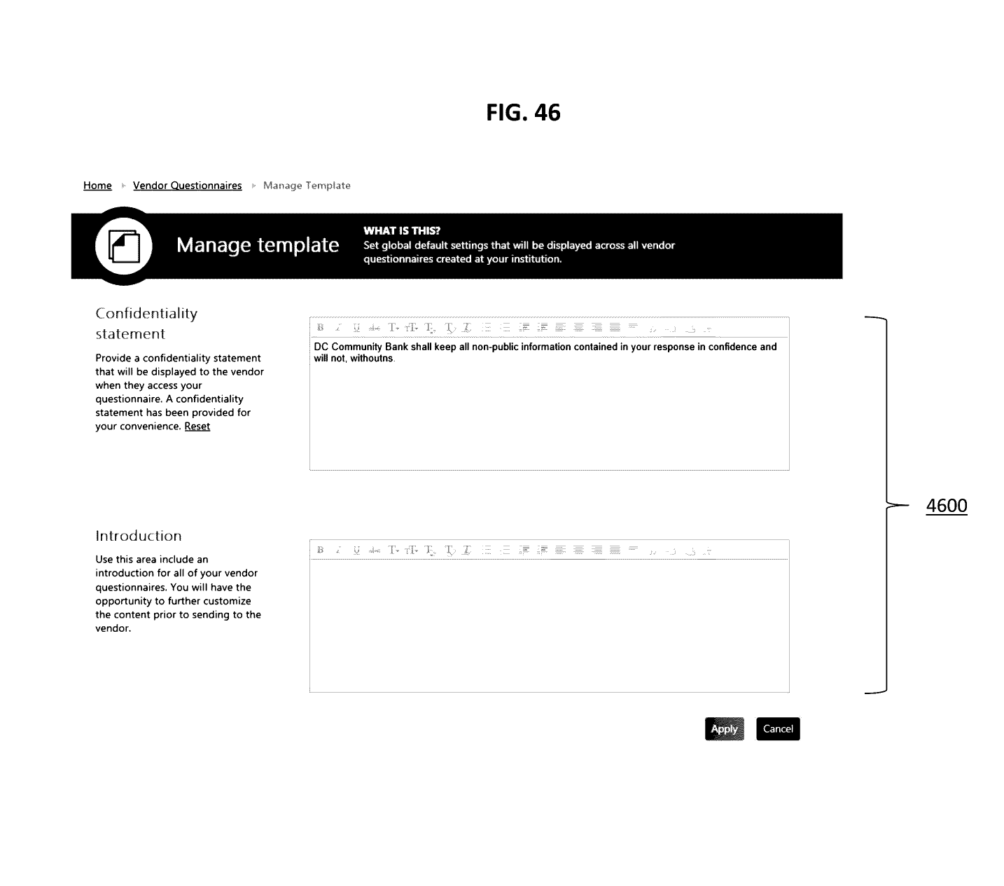

FIG. 45 illustrates a Questionnaire Landing Page GUI according to an exemplary embodiment. In some implementations, a user can use the Questionnaire Landing Page GUI to navigate a questionnaire process, e.g., navigate to a section where questionnaire templates can be built (4500A), questionnaires can be built and managed (4500B), questionnaires can be sent (4500C), and/or questionnaire responses from vendors can be tracked (4500D).

FIG. 46 illustrates a Manage templates GUI for managing a questionnaire template according to an exemplary embodiment. In some implementations, a user can set a global parameter that can apply to every questionnaire, e.g., to include an introductory comment and/or a client confidentiality statement (4600). In some implementations, a user can navigate here, e.g., by selecting Manage Template from the Questionnaire Landing Page.

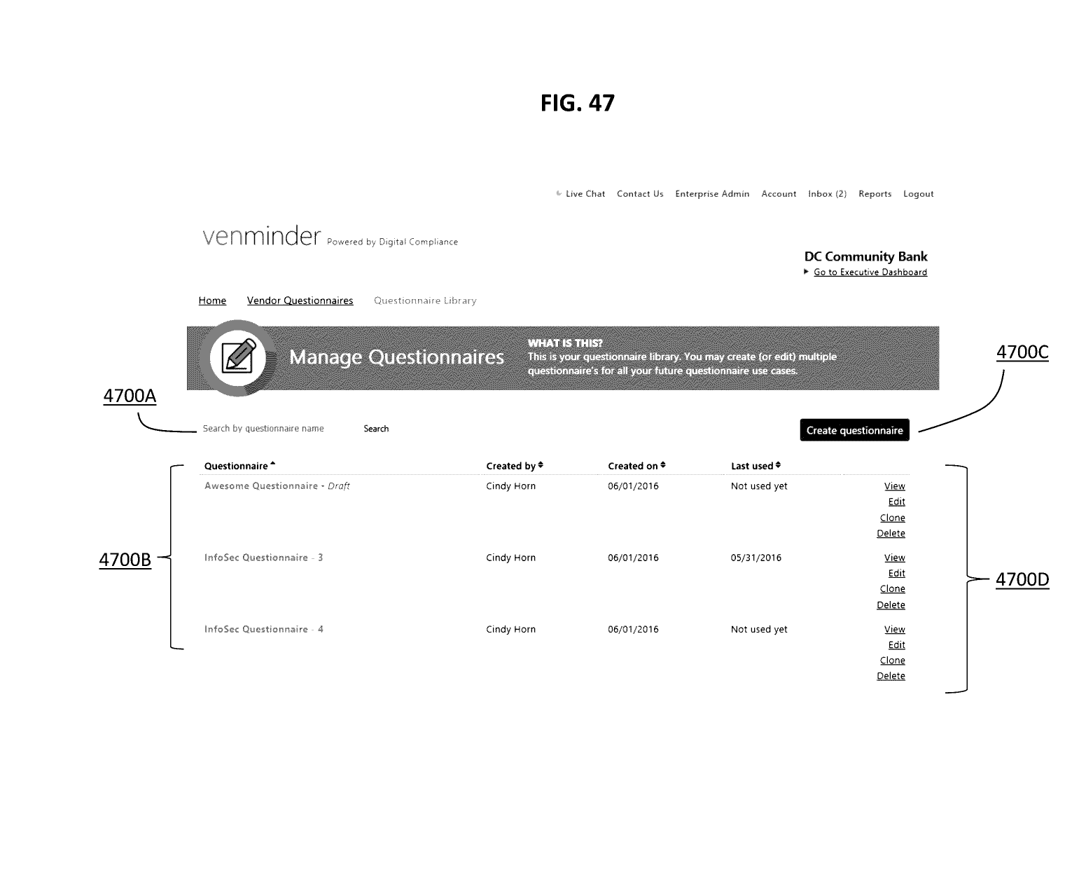

FIG. 47 illustrates a Manage Questionnaires GUI to manage questionnaires according to an exemplary embodiment. In some implementations, the Manage Questionnaires GUI comprises a searchable (4700A) grid of all existing questionnaires with actions that can be taken (Manage Questionnaires) (4700B). In some implementations, a user can navigate here, e.g., by selecting “Manage Questionnaires” (4500B) on the Questionnaire Landing Page GUI. In the absence of existing questionnaires, a message can be displayed to that effect.

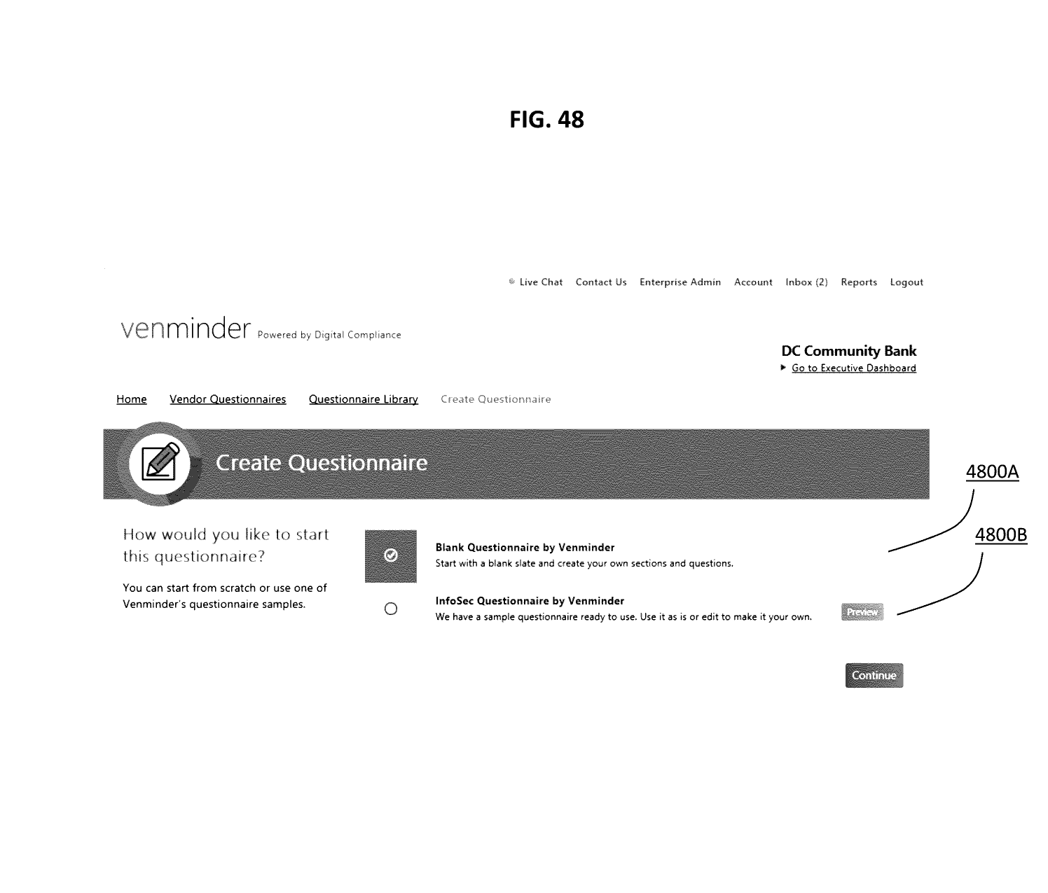

FIG. 48 illustrates a Create Questionnaire GUI to create a questionnaire according to an exemplary embodiment: a user may select a blank questionnaire 4800A to fill in with sections/questions and view a sample. In some implementations, a user can navigate here, e.g., by selecting “Create Questionnaire” (4700C) on the Manage Questionnaires GUI. In some implementations, a user can choose to begin with a blank slate 4800A or a standardized Infosec sample that can be edited (4800B).

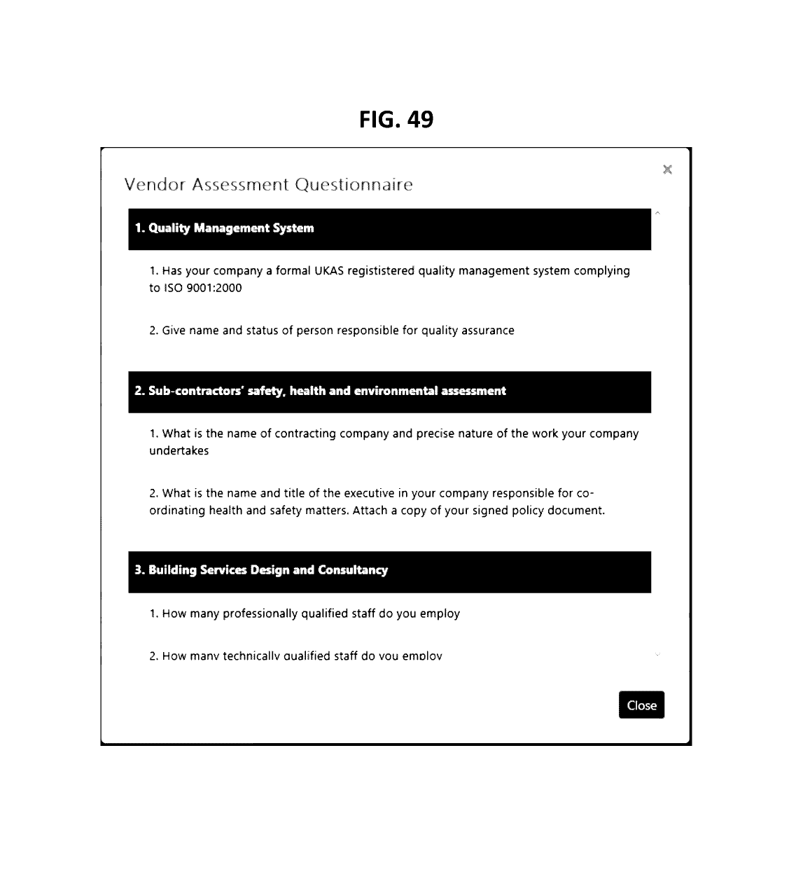

FIG. 49 illustrates a GUI and/or widget to preview a questionnaire according to an exemplary embodiment. In some implementations, the GUI and/or widget comprises a read-only view of a questionnaire that can be used throughout the function at various stages, e.g., Sample Questionnaire Modal/View Questionnaire Modal/Preview Select Questionnaire Modal. In some implementations, if a questionnaire exists, a user can navigate here, e.g., by selecting “View” (4700D) from the questionnaire on the Manage Questionnaires GUI.

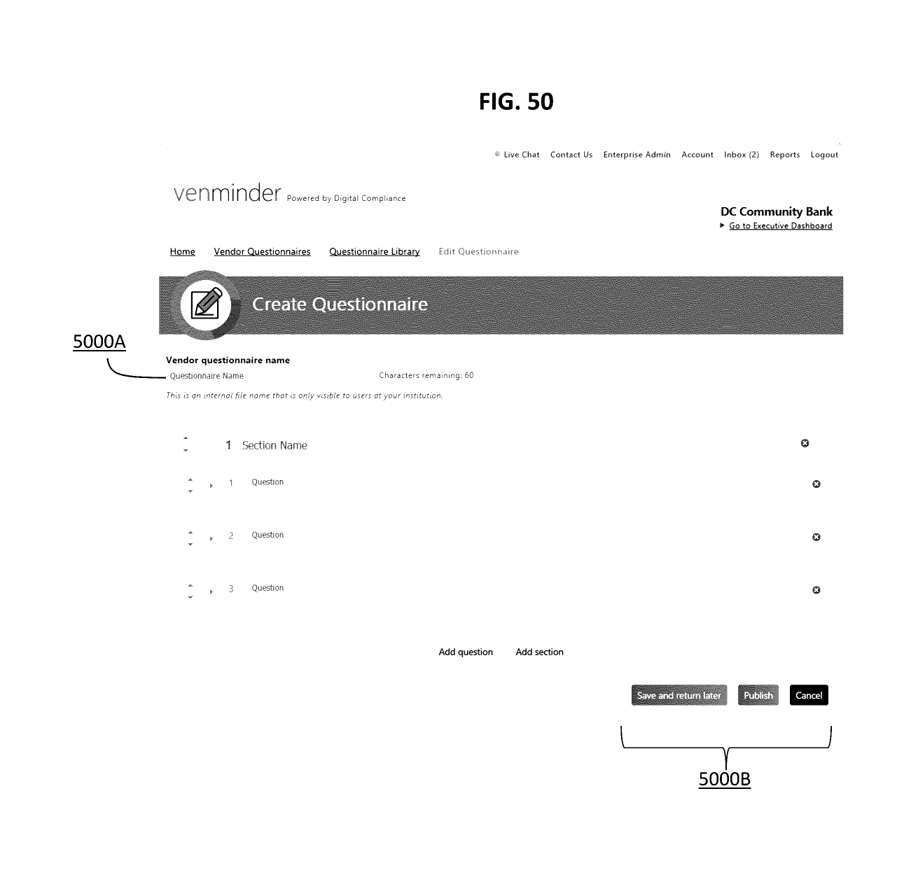

FIG. 50 illustrates a Create Questionnaire Landing Page GUI according to an exemplary embodiment. In some implementations, a user can create multiple sections containing multiple questions and supply an internal (display) name if desired. In some implementations, a user can name the questionnaire, build sections and questions. In some implementations, a user can navigate here, e.g., by clicking “Next” on the “Create Questionnaire” GUI.

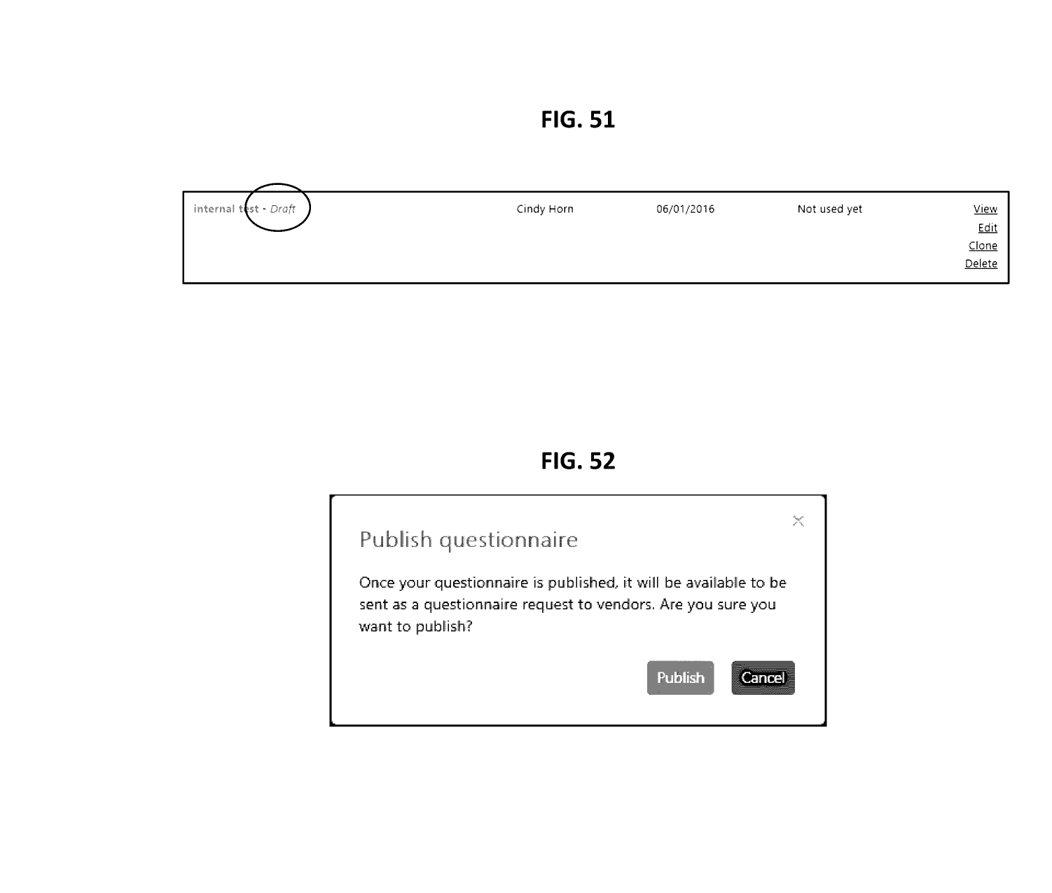

FIG. 51 illustrates a GUI and/or widget for a saved but unpublished questionnaire grid listing according to an exemplary embodiment. In some implementations, when the user selects “Save and Return Later” (5000B) from the previous screen (Create Questionnaire Landing Page), the questionnaire is saved as a draft.

FIG. 52 illustrates a GUI and/or widget for publishing a questionnaire (Publish Confirmation Modal) according to an exemplary embodiment. In some implementations, a user can navigate here by clicking “Publish” on Create Questionnaire Landing Page (5000B) or Edit Questionnaire Page.

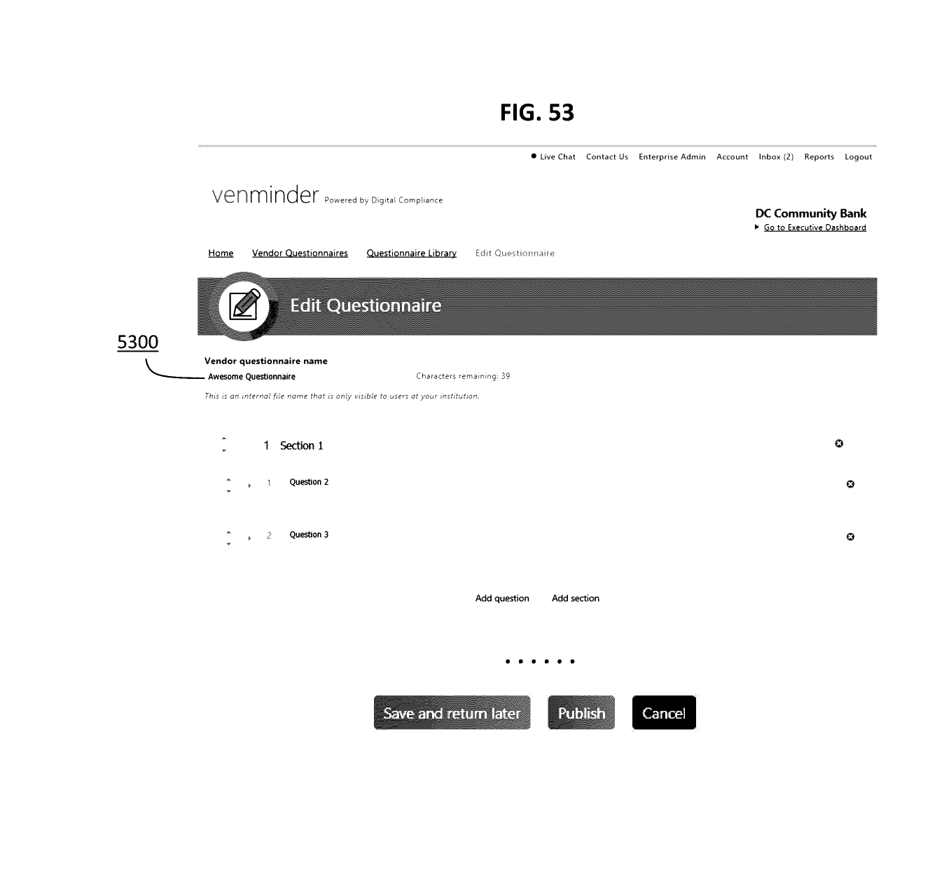

FIG. 53 illustrates an Edit Questionnaire GUI for editing and constructing a questionnaire (5300) according to an exemplary embodiment. In some implementations, a user can add, delete, rearrange, or otherwise modify sections and/or questions. In some implementations, the GUI can be identical to the Create Questionnaire Landing Page. In some implementations, a user can navigate here, e.g., by clicking “Edit” on the Manage Questionnaires GUI (4700D).

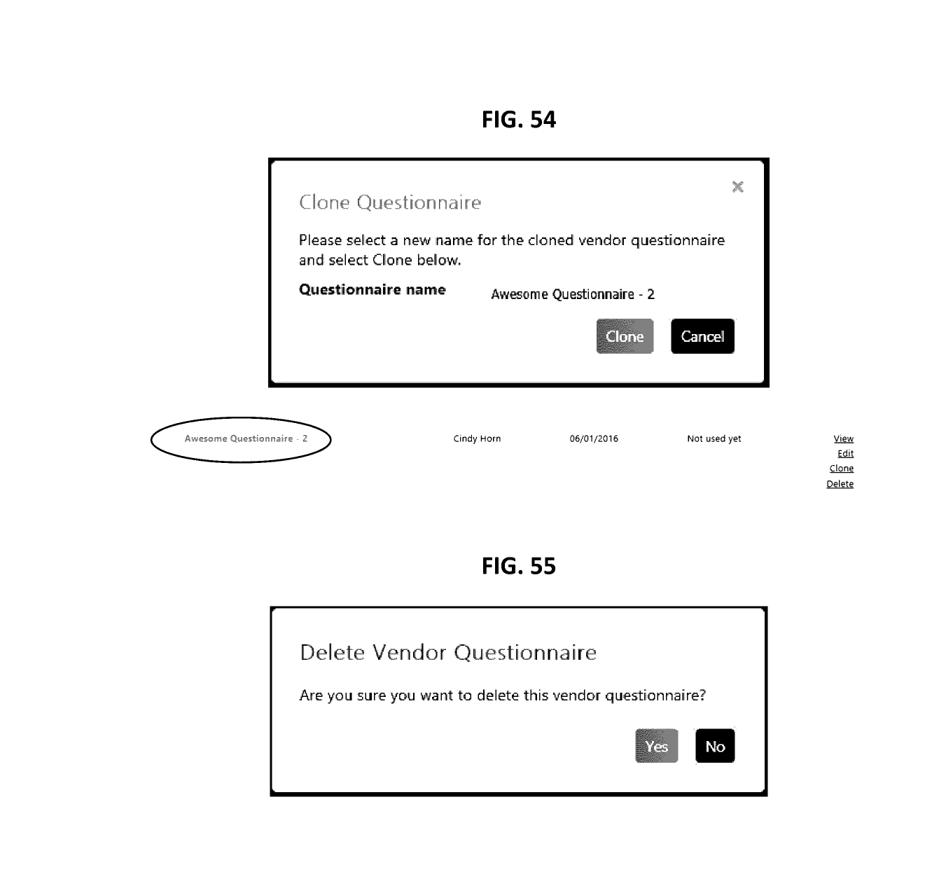

FIG. 54 illustrates a GUI and/or widget for cloning a questionnaire (Clone Confirmation Modal). In some implementations, a user can select a unique name for a clone. In some implementations, the system can prefill using the current name and append an ordinal number to make it unique, or a client can rename as desired. In some implementations, a user can navigate here, e.g., by clicking Clone on the Manage Questionnaires GUI (4700D).

FIG. 55 illustrates a GUI and/or widget for deleting a questionnaire and optionally confirming deletion (Delete Confirmation Modal). In some implementations, a user can delete a questionnaire. In some implementations, a user can delete a questionnaire and confirm deletion. In some implementations, a user can navigate here, e.g., by clicking “Delete” on the Manage Questionnaires GUI (4700D).

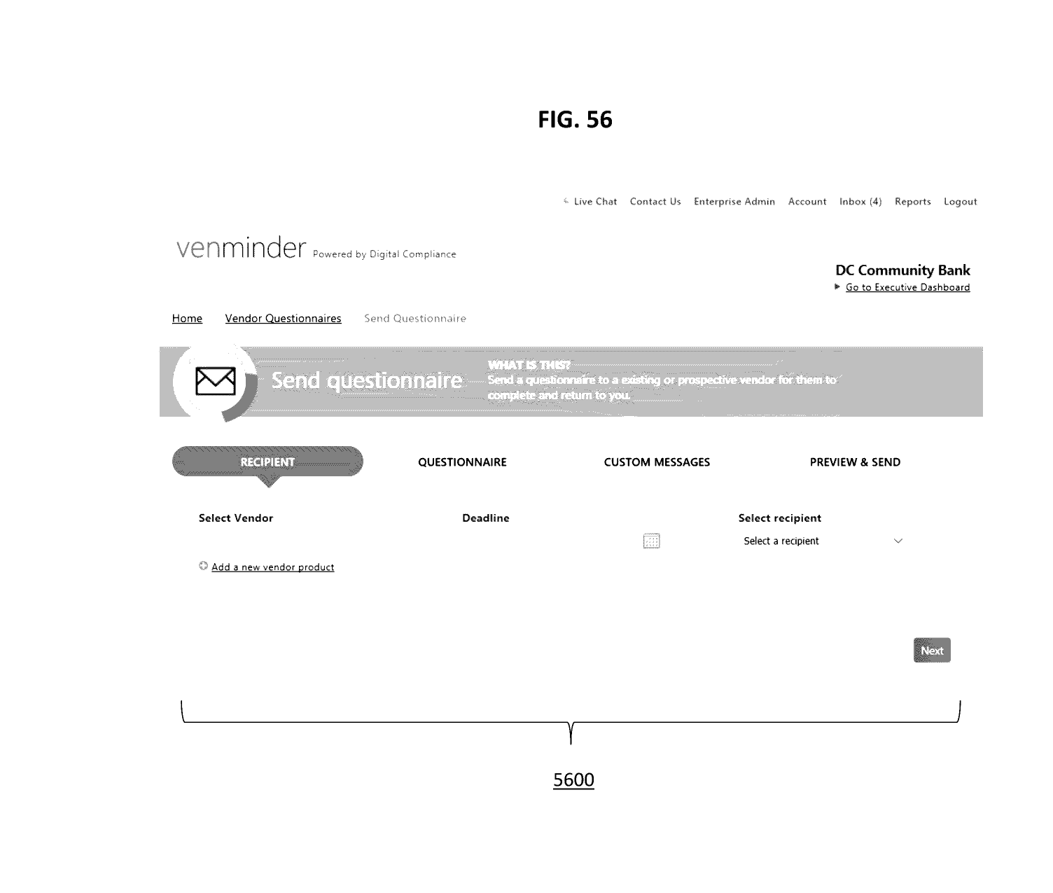

FIG. 56 illustrates a Send Questionnaire GUI 5600 to send a questionnaire according to an exemplary embodiment. In some implementations, a user can carry out an initial step, e.g., the Recipient Selection step, e.g., by selecting a vendor, selecting a due date, and/or selecting a recipient. In some implementations, a user can navigate here, e.g., by selecting “Send Questionnaire” on the Questionnaire Landing Page GUI (4500C).

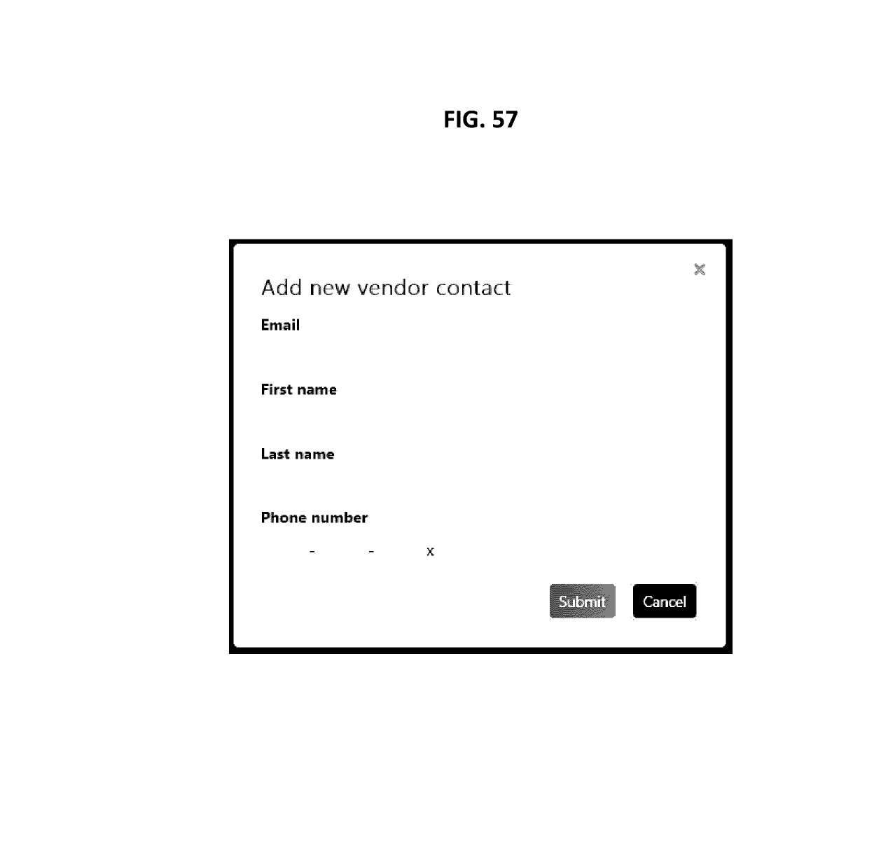

FIG. 57 illustrates a GUI and/or widget for adding a new vendor (Add New Vendor Contact Modal) according to an exemplary embodiment. In some implementations, contact information entered here can be reflected in a vendor contact dropdown list. In some implementations, a user can navigate here, e.g., by clicking “Add a new vendor contact” on the Send Questionnaire GUI. In some implementations, this step can add a contact to a client's address book, and can be displayed on future drop-down lists when selecting a recipient.

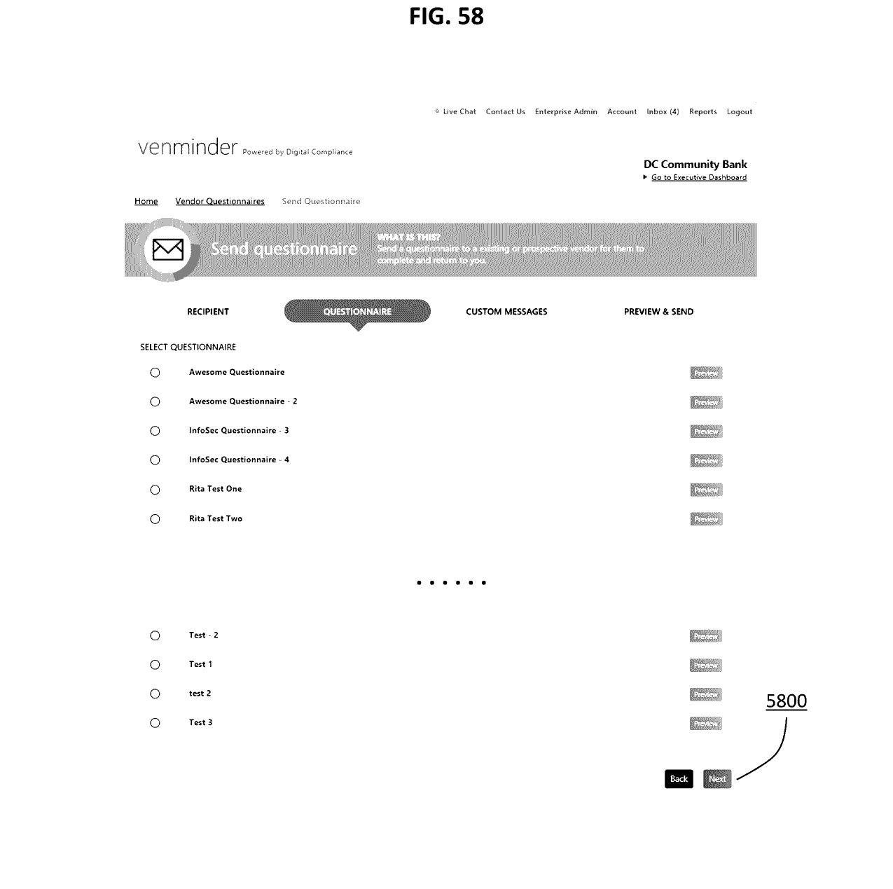

FIG. 58 illustrates a GUI and/or widget for sending a questionnaire and selecting a questionnaire to be sent (Send Questionnaire selection screen) according to an exemplary embodiment. In some implementations, a user can navigate here, e.g., by clicking “Next” on the Send Questionnaire GUI (5800).

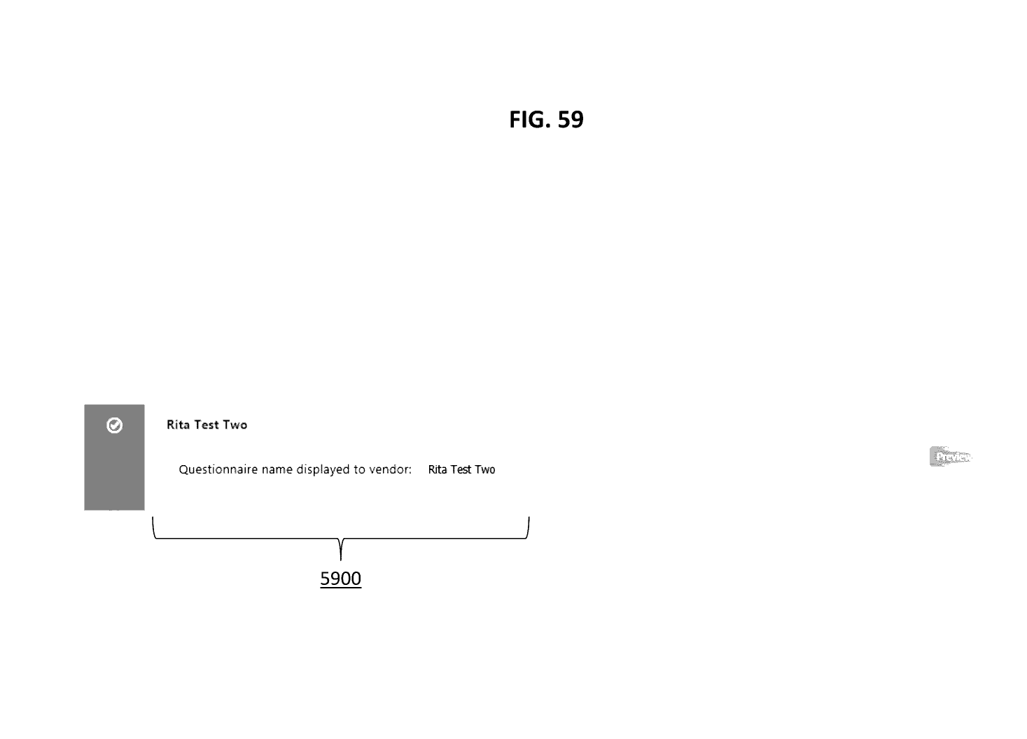

FIG. 59 illustrates a GUI and/or widget for entering a display name and/or rename a questionnaire according to an exemplary embodiment. In some implementations, this entry can open up, e.g., when a questionnaire is selected on the Send Questionnaire selection screen. In some implementations, a user can supply an external name for a vendor to see (5900).

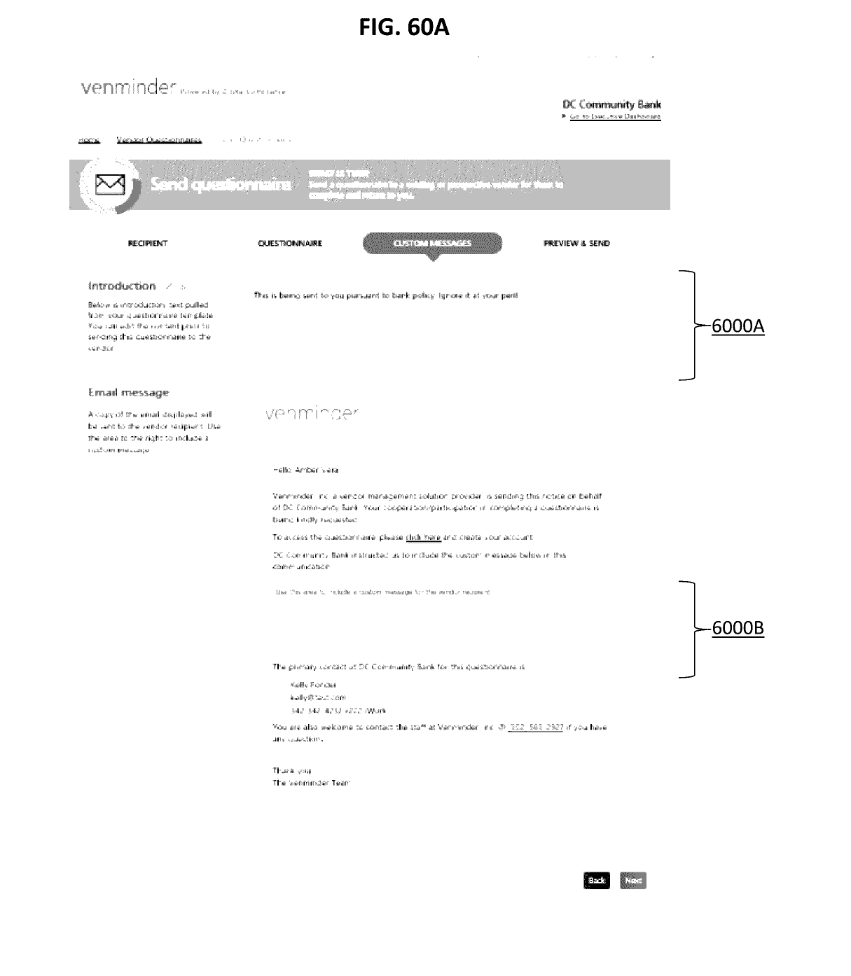

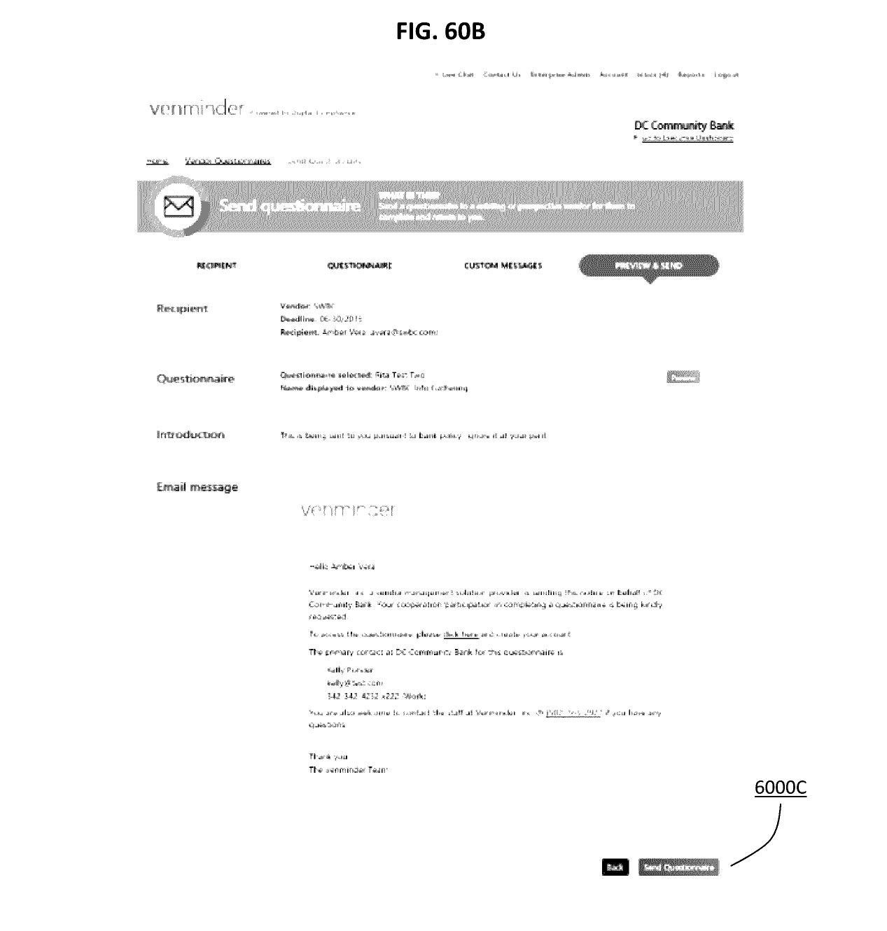

FIG. 60A illustrates a GUI and/or widget for providing a custom message (Custom Messages) according to an exemplary embodiment. In some implementations, a user can supply a new introductory text (6000A) and/or customize an email notification (6000B). In some implementations, A user can navigate here, e.g., by clicking “Next” on the Send Questionnaire GUI (e.g. 5800).

FIG. 60B illustrates a GUI and/or widget to preview and send a questionnaire according to an exemplary embodiment. In some implementations, a user navigates here by clicking “Next” on the Send Questionnaire GUI (e.g. 5800).

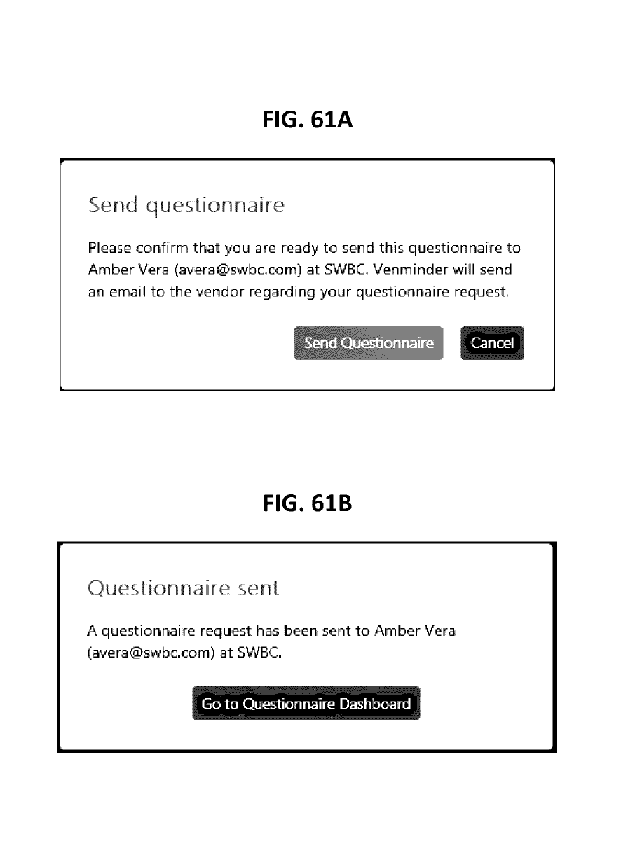

FIG. 61A illustrates a GUI and/or widget to confirm that a questionnaire is to be sent (Send Confirmation Modal) according to an exemplary embodiment. In some implementations, the Send Confirmation Modal can appear when a user selects “Send” on the Send Questionnaire GUI (6000C).

FIG. 61B illustrates a GUI and/or widget to confirm that a questionnaire has been sent (Send Acknowledgement Modal) according to an exemplary embodiment. The Send Acknowledgement Modal can appear when “Send” is selected on the Send Confirmation Modal.

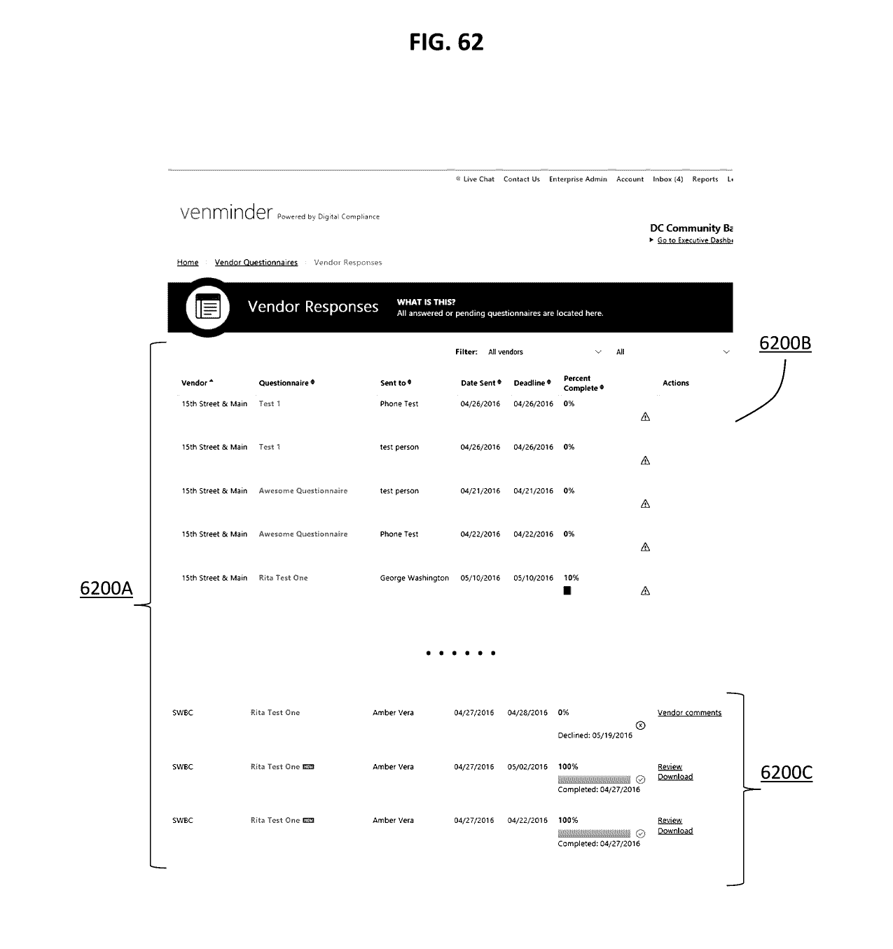

FIG. 62 illustrates a Vendor Responses GUI to monitor status and/or select individual responses to review or edit. In some implementations, a user can navigate here by selecting “Vendor Responses” on the Questionnaire Landing Page GUI (4500D).

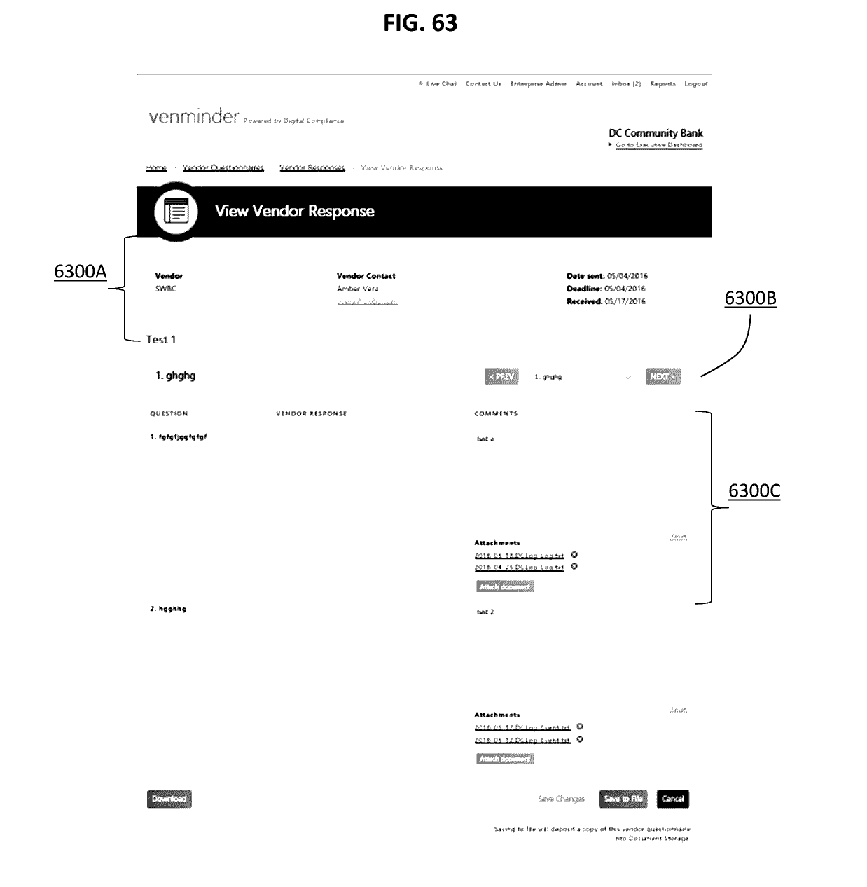

FIG. 63 illustrates a View Vendor Response GUI according to an exemplary embodiment. In some implementations, with a questionnaire selected (6300A), a user can, e.g., edit a response, navigate between sections, can provide general questionnaire-specific dates, can display questions, vendor response, client comments, and/or attached documents. A user can navigate here by selecting “Review” on the Vendor Responses GUI (6200C).

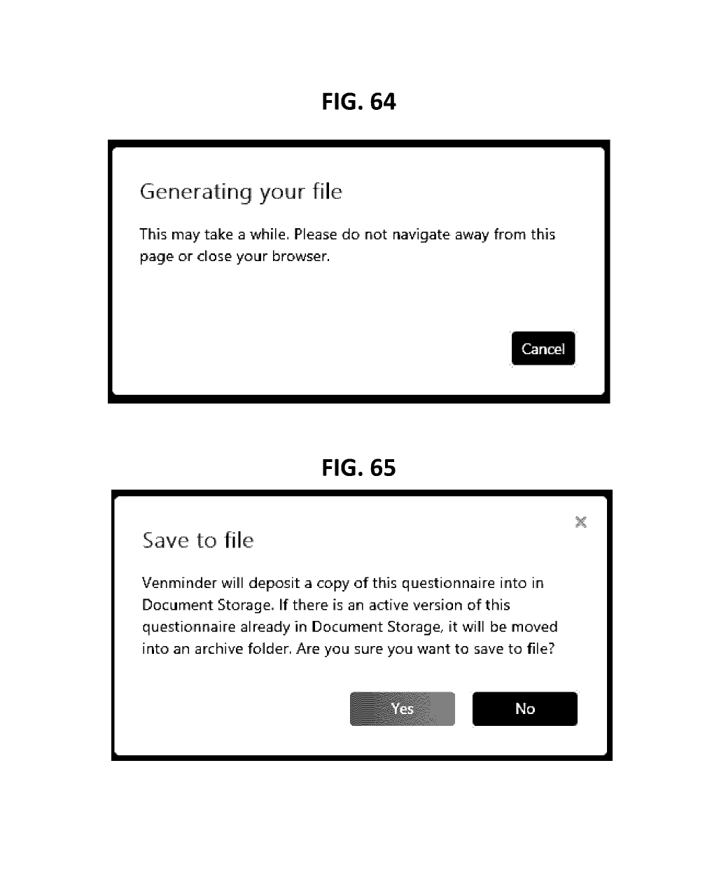

FIG. 64 illustrates a GUI and/or widget to generate and/or download a file (Download (Generate) Confirmation Modal or Download Generating Modal) according to an exemplary embodiment. In some implementations, this modal can appear when “Download” is selected from either Vendor Response GUI or View Vendor Response GUI (e.g., 6200C), and can be replicated in the Vendor Experience for download actions. In some implementations, a progress bar can load and a user can be asked whether to view the download by the OS.

FIG. 65 illustrates a GUI and/or widget to save a file (Save Questionnaire Confirmation Modal/Save to File Confirmation Modal) according to an exemplary embodiment. In some implementations, this modal can appear when “Save to File” is selected on the View Vendor Response GUI.

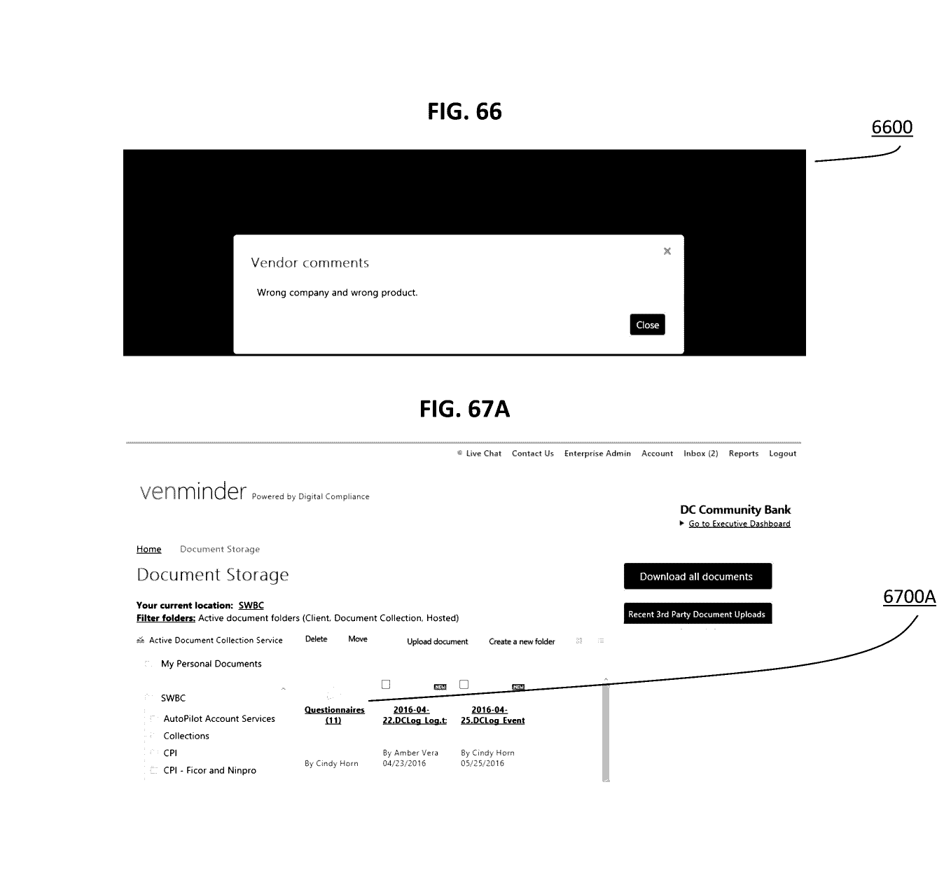

FIG. 66 illustrates a GUI and/or widget to view vendor comments (Vendor Comments) 6600 according to an exemplary embodiment. In some implementations, when a vendor Declines a questionnaire, the vendor can have the opportunity to enter a comment for a client. In some implementations, the Vendor Comment is viewable from a grid screen for questionnaires that have been declined by a vendor. These comments can be specific to a Decline action. In some implementations, a client can view vendor comments by selecting the Vendor Comments on Vendor Responses GUI.

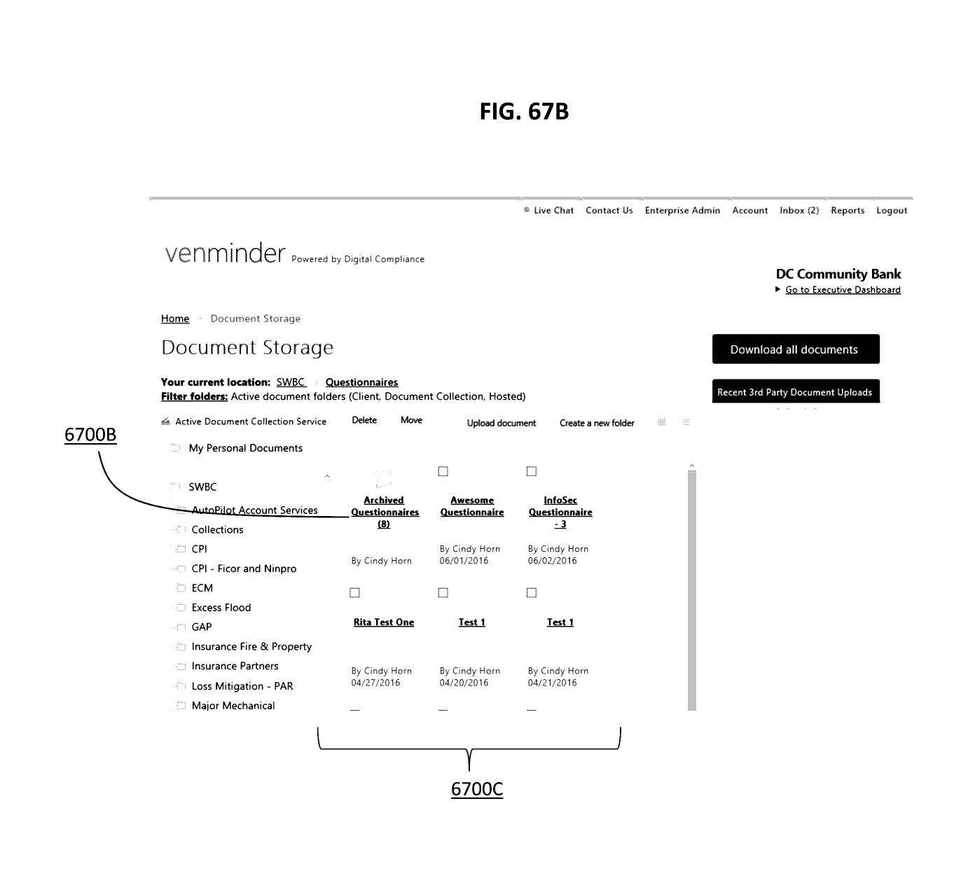

FIG. 67A illustrates a Document Storage GUI according to an exemplary embodiment. In some implementations, this can be a high level vendor questionnaire folder. In some implementations, when a vendor response is saved (e.g., when a user selects Save to File on View Vendor Response GUI), a copy can be placed in, e.g., the Questionnaires root folder 6700A in a client's Document Storage area. In some implementations, Document Storage can be reached, e.g., via the Main Dashboard GUI.

FIG. 67B illustrates a Document Storage GUI, wherein Questionnaire folders, archived and current, can be displayed, according to an exemplary embodiment. Within the Questionnaires folder in Document Storage, all saved questionnaires can be stored. Previous copies of questionnaires can be moved into the archived folder 6700B.

Vendor Side

In some implementations, a vendor can receive an email notification that the vendor has been sent a questionnaire to fill out. In some implementations, a hosted vendor, e.g., who has an existing system logon, can go to the vendor's home page and select the Questionnaires button to be redirected to the questionnaires area. In some implementations, a non-hosted vendor can be prompted by the email to create a system account. In some implementations, a non-hosted vendor only has access to the questionnaires area.

In some implementations, all questionnaires received by a vendor reside on the questionnaires grid. From here, a vendor has the option to Edit (fill out), Download, or Decline a questionnaire.

In some implementations, Edit allows a vendor to, e.g., navigate through a questionnaire, answer a question, attach a document, add a contact to assist the vendor with answering a question, monitor the progress towards completion, and/or download an Excel spreadsheet of the questionnaire to review the document or share it, e.g., with another person within the vendor's organization. In some implementations, when one or more tasks are completed, a questionnaire can be marked as complete. In some implementations, this generates a notification to a client that all questions have been answered.

In some implementations, a vendor can download an in-progress questionnaire or completed questionnaire for future reference. In some implementations, a completed questionnaire can generate a PDF version of the document.

In some implementations, by declining a questionnaire, a vendor notifies a client that for whatever reason the vendor will not be responding. In some implementations, a vendor has the option to enter a comment for this action.

In some implementations, a vendor is able to view and download previously completed questionnaires, e.g., to assist in responding to new questionnaires.

In some implementations, the system generates reminder emails to a vendor contact as a questionnaire deadline approaches.

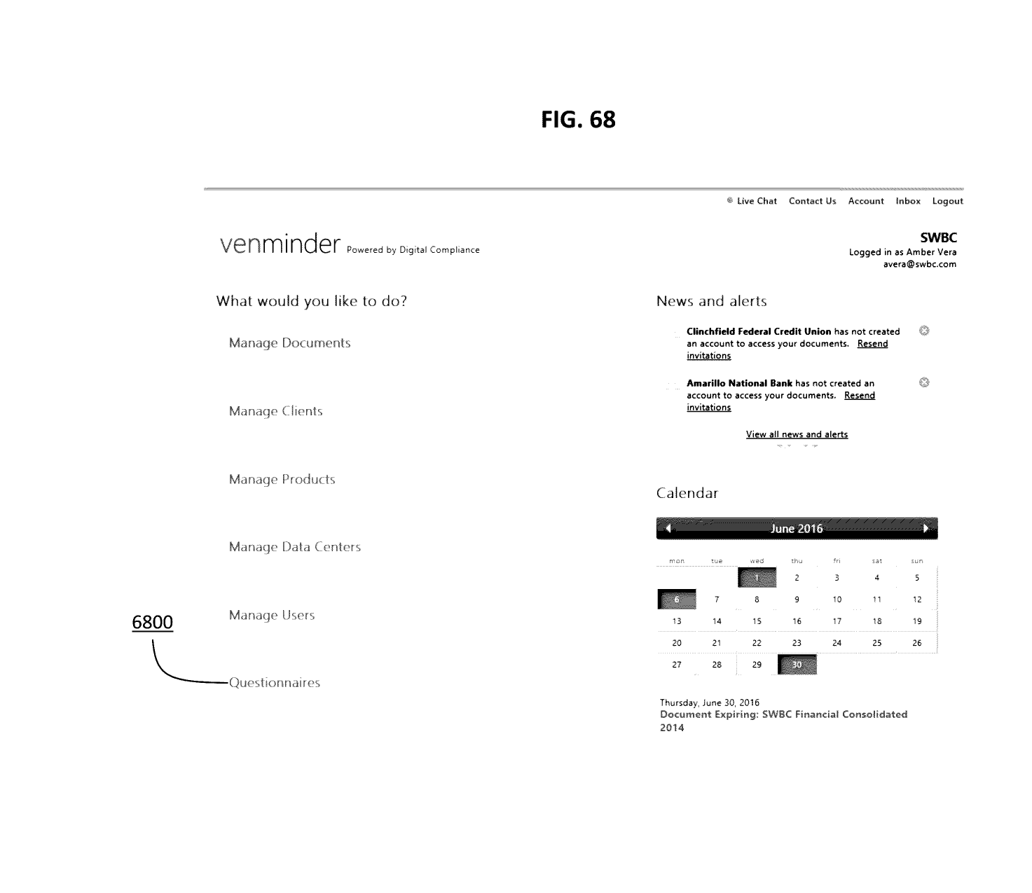

FIG. 68 illustrates a Vendor Home Page/Vendor Dashboard GUI according to an exemplary embodiment. In some implementations, this GUI can include a selection to navigate to a questionnaire (6800).

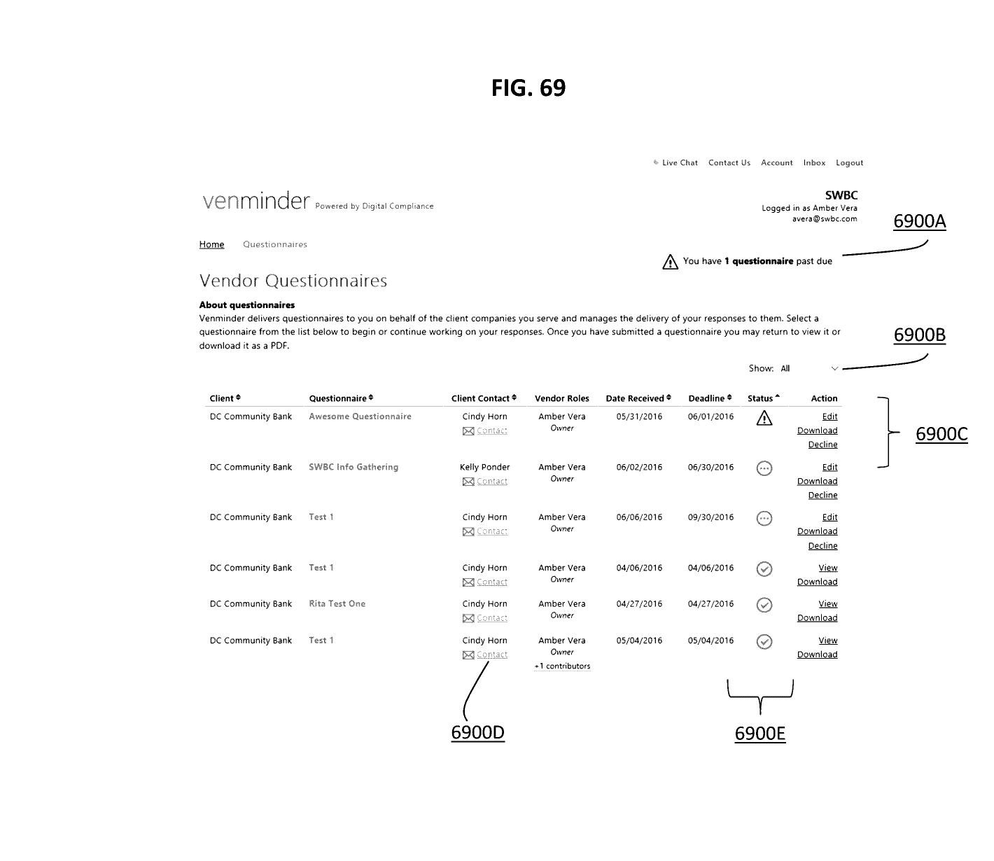

FIG. 69 illustrates a Vendor Questionnaire Grid GUI according to an exemplary embodiment. In some implementations, this GUI can be a landing page for hosted and non-hosted vendors. A hosted vendor can navigate to this GUI by selecting Questionnaires on the Main Dashboard. A non-hosted vendor who creates an account specifically to process questionnaires can be sent directly to this page. All questionnaires can listed with their status (6900E).

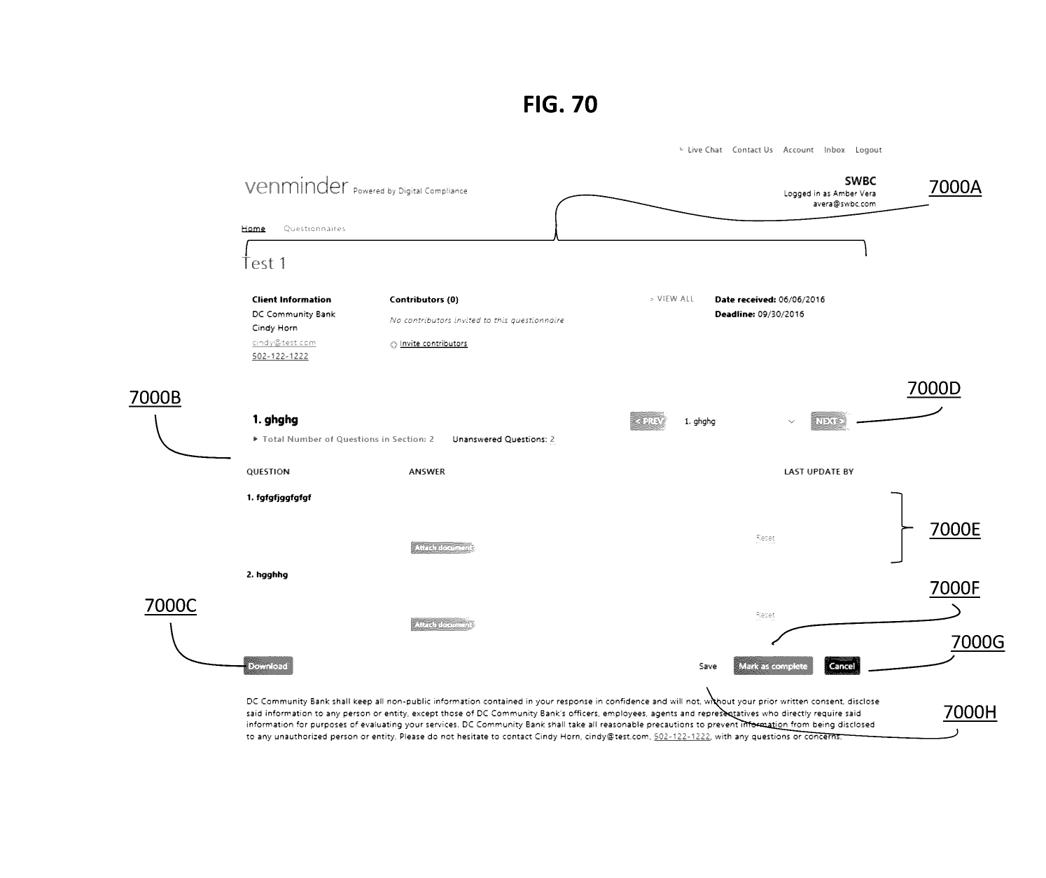

FIG. 70 illustrates an Edit Vendor Questionnaire GUI, where a vendor can supply answers to the questions presented in a questionnaire (7000E), according to an exemplary embodiment. In some implementations, a user navigates here by selecting Edit on the Vendor Questionnaire Grid GUI (6900C). In some implementations, an Edit Vendor Questionnaire GUI comprises functions and/or buttons for selecting a next questionnaire (7000D), for downloading a questionnaire and/or a response to a question (7000C), and/or to save a questionnaire and/or a response to a question (7000H).

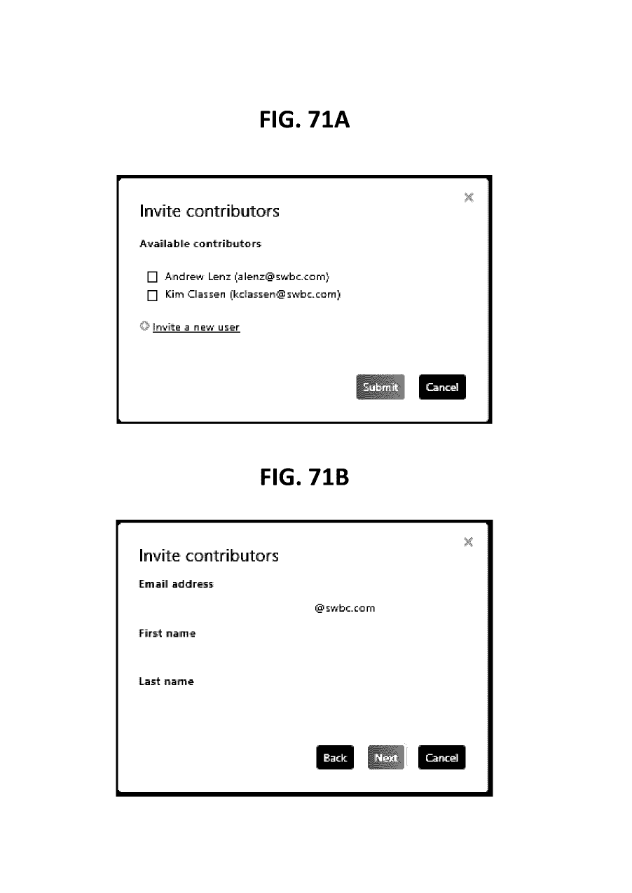

FIG. 71A illustrates a GUI and/or widget to invite a contributor (Invite Contributor Modal) according to an exemplary embodiment. In some implementations, a vendor user can see this when clicking on Invite Contributors on the Edit Vendor Questionnaire GUI (7000A). In some implementations, a user can select from existing users via a drop down or add a new user.

FIG. 71B illustrates a GUI and/or widget to add new contact and/or user according to an exemplary embodiment. In some implementations, a vendor user can see this when clicking on Invite a New User on the Invite Contributor Modal.

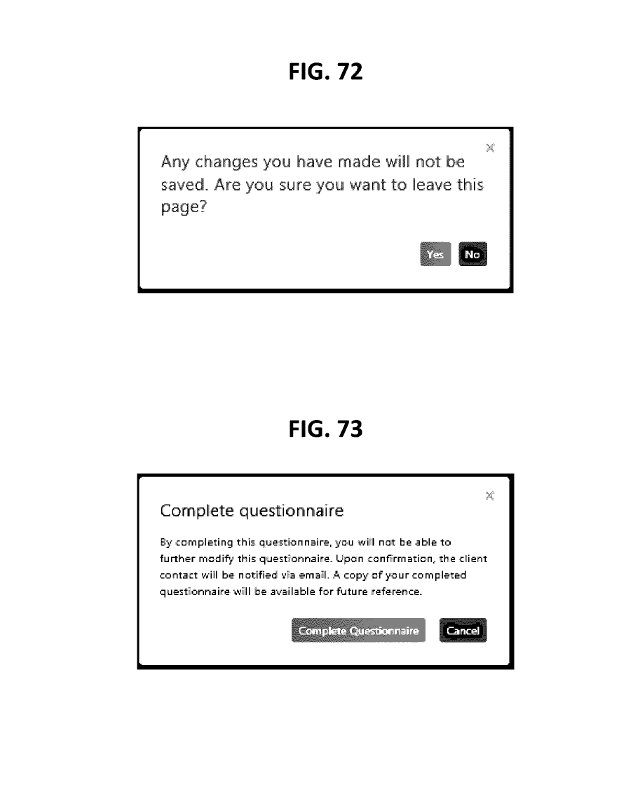

FIG. 72 illustrates a GUI and/or widget to cancel an operation (Cancel Modal) according to an exemplary embodiment. In some implementations, a user can see this modal when/after selecting a Cancel option from multiple locations throughout the vendor experience.

FIG. 73 illustrates a GUI and/or widget to mark a questionnaire as complete (Complete Questionnaire Confirmation Modal) according to an exemplary embodiment. In some implementations, a user can see this modal when/after select Mark as Complete on the Edit Vendor Questionnaire GUI (7000F). Once marked, a vendor can no longer edit the questionnaire.

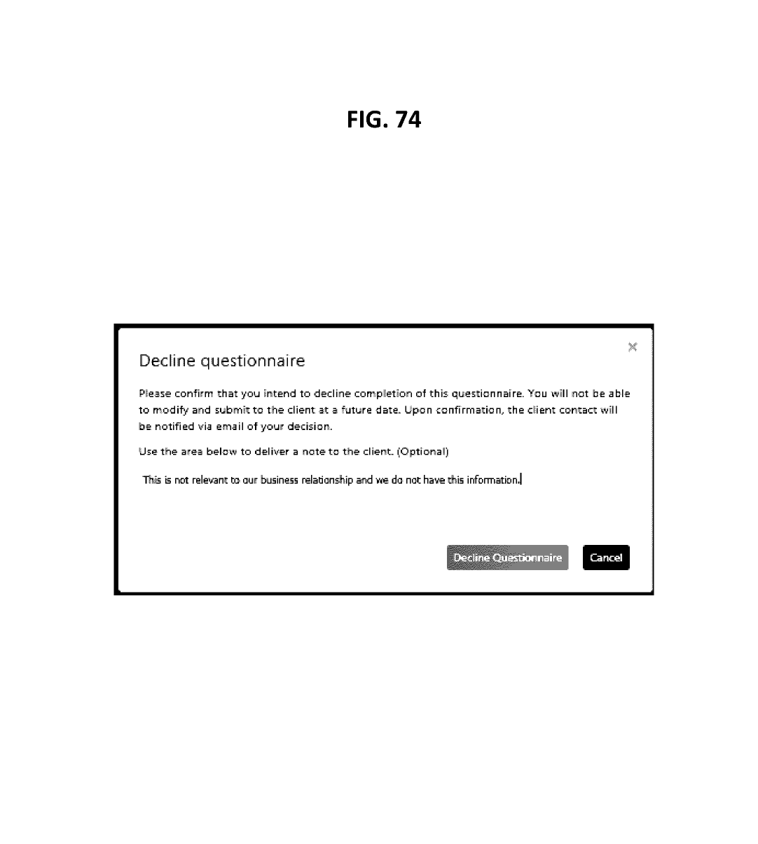

FIG. 74 illustrates a GUI and/or widget to decline to complete a questionnaire (Decline Questionnaire Confirmation Modal) according to an exemplary embodiment. In some implementations, a user can see this modal when/after opting to decline a questionnaire and selecting the corresponding option on Vendor Questionnaire Grid GUI (6900C).

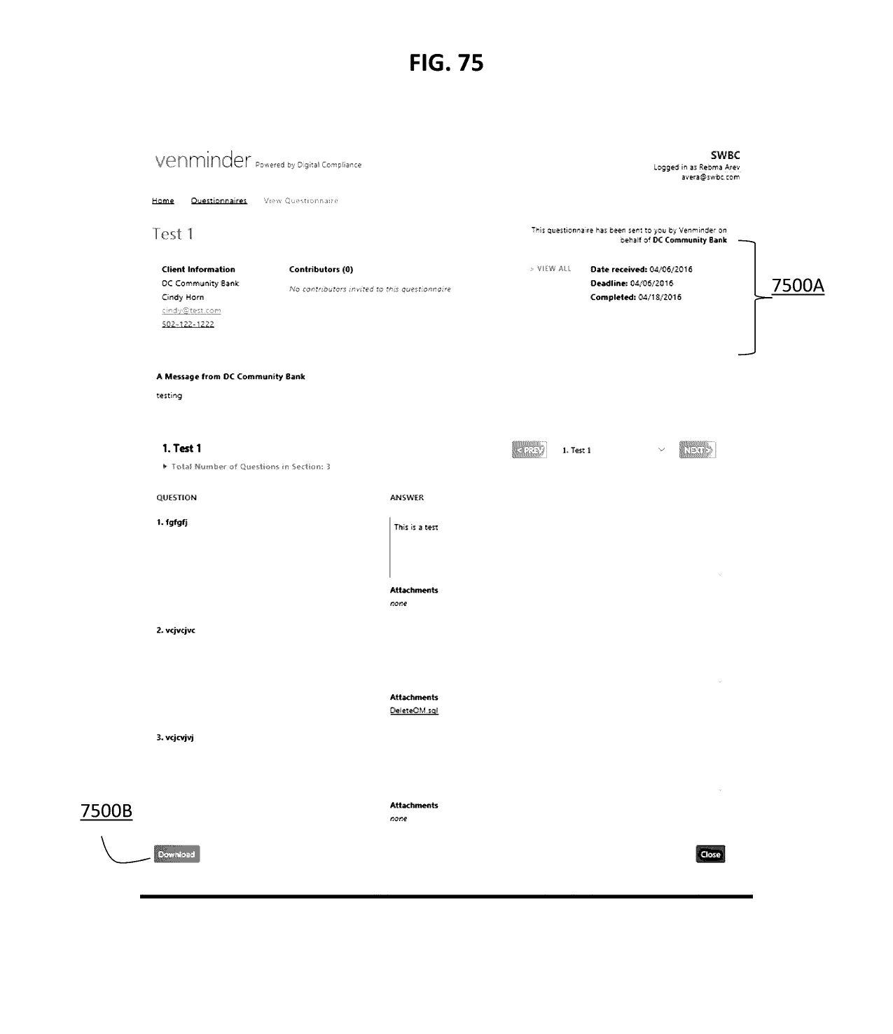

FIG. 75 illustrates a GUI and/or widget to view a vendor questionnaire (View Vendor Questionnaire), e.g., view a complete questionnaire, according to an exemplary embodiment. In some implementations, a user can be navigated to a read-only screen when selecting View on the Vendor Questionnaire Grid GUI (6900C).

In some implementations, the system comprises a library of draft email communications that can be sent by either client or vendor. An exemplary list of email communications is described in Table 6.

TABLE 6

| Name | Trigger | Recipient | Frequency |
|---|---|---|---|
| QuestionnaireSent | Client sends questionnaire | Vendor contact to whom | One time |
| | | questionnaire was | |
| | | addressed | |
| QuestionnaireDeclined | Vendor declines to | Client contact who sent | One time |
| | respond to questionnaire | questionnaire | |
| VendorQuestionnaire | Client sends questionnaire | Client contact who sent | One time |
| InvitationConfirmation | | questionnaire | |
| 5DayReminderNotice | Five days prior to | Vendor contact to whom | One time |
| | questionnaire deadline | questionnaire was | |
| | | addressed | |
| 1DayReminderNotice | One day prior to | Vendor contact to whom | One time |
| | questionnaire deadline | questionnaire was | |
| | | addressed | |
| QuestionnaireCompleted | Questionnaire marked as | Client contact who sent | One time |
| | complete by vendor | questionnaire | |
| AddContributor | Vendor adds/invites | Vendor contact selected as | One time |
| | contributor to | a contributor | |
| | questionnaire | | |

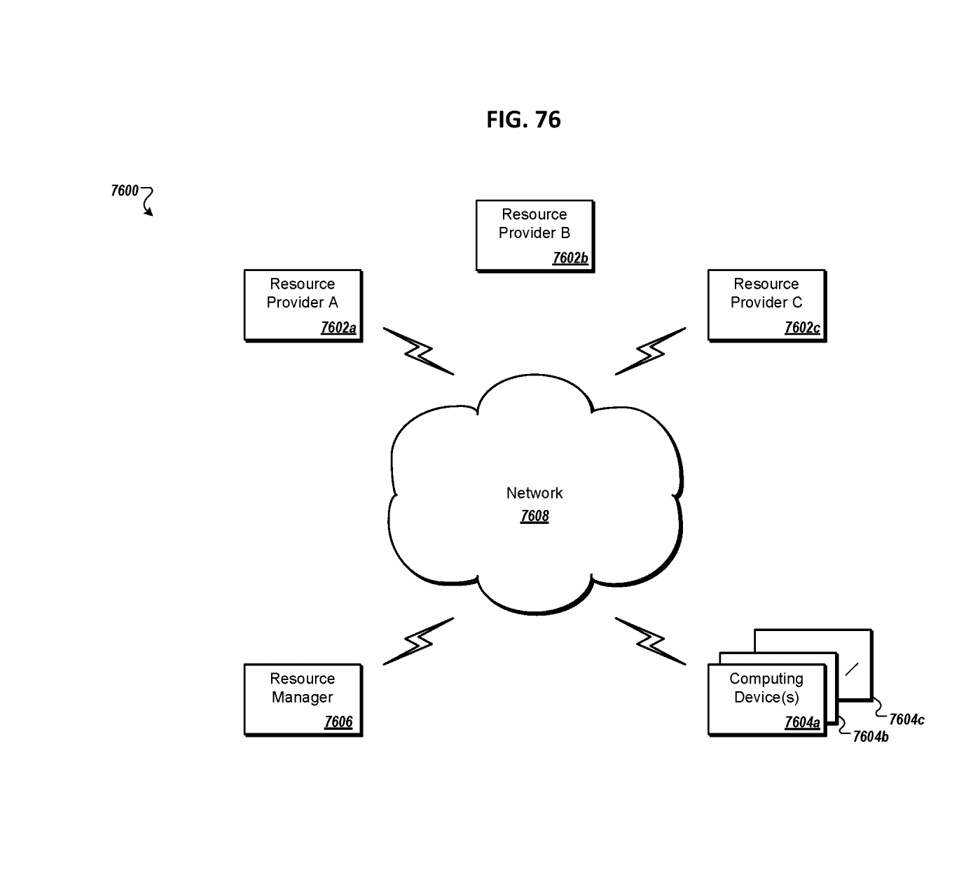

FIG. 76 shows an illustrative network environment 7600 for use in the methods and systems described herein. In brief overview, referring now to FIG. 76, a block diagram of an exemplary cloud computing environment 7600 is shown and described. The cloud computing environment 7600 may include one or more resource providers 7602a, 7602b, 7602c (collectively, 7602). Each resource provider 7602 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 7602 may be connected to any other resource provider 7602 in the cloud computing environment 7600. In some implementations, the resource providers 7602 may be connected over a computer network 7608. Each resource provider 7602 may be connected to one or more computing device 7604a, 7604b, 7604c (collectively, 7604), over the computer network 7608.

The cloud computing environment 7600 may include a resource manager 7606. The resource manager 7606 may be connected to the resource providers 7602 and the computing devices 7604 over the computer network 7608. In some implementations, the resource manager 7606 may facilitate the provision of computing resources by one or more resource providers 7602 to one or more computing devices 7604. The resource manager 7606 may receive a request for a computing resource from a particular computing device 7604. The resource manager 7606 may identify one or more resource providers 7602 capable of providing the computing resource requested by the computing device 7604. The resource manager 7606 may select a resource provider 7602 to provide the computing resource. The resource manager 7606 may facilitate a connection between the resource provider 7602 and a particular computing device 7604. In some implementations, the resource manager 7606 may establish a connection between a particular resource provider 7602 and a particular computing device 7604. In some implementations, the resource manager 7606 may redirect a particular computing device 7604 to a particular resource provider 7602 with the requested computing resource.

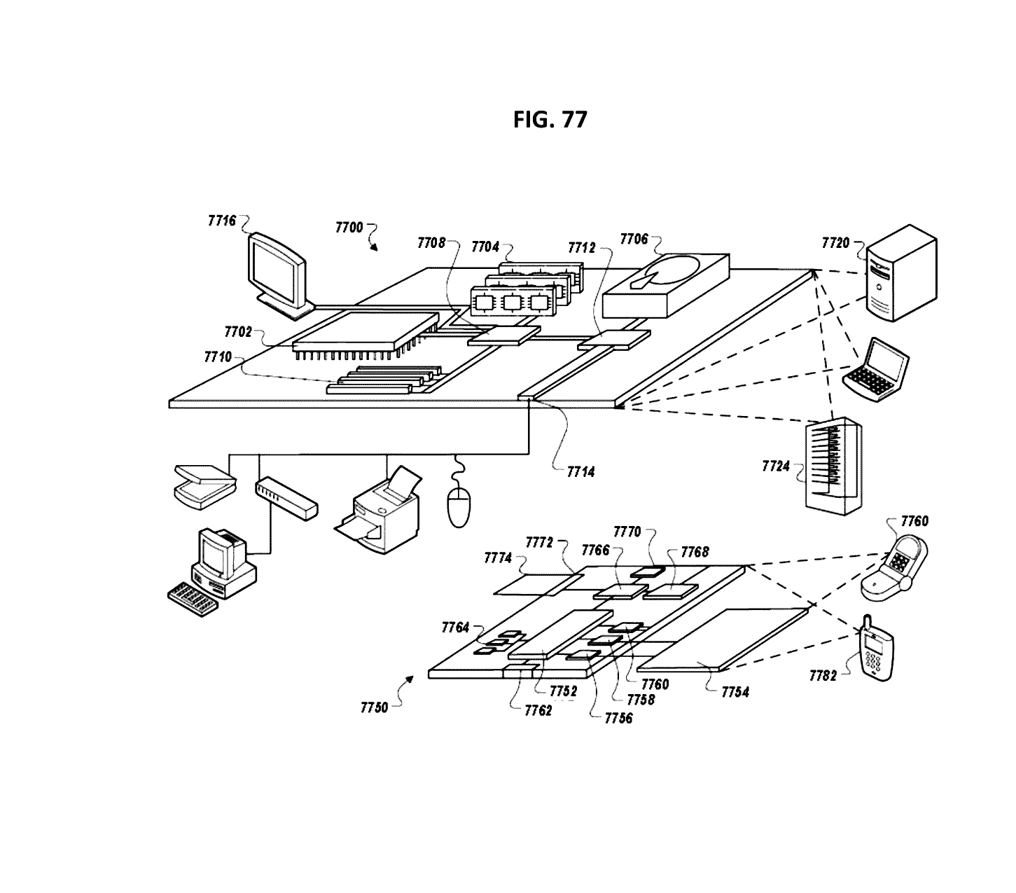

FIG. 77 shows an example of a computing device 7700 and a mobile computing device 7750 that can be used in the methods and systems described in this disclosure. The computing device 7700 is intended to represent various forms of digital computers, such as laptops, desktops, workstations, personal digital assistants, servers, blade servers, mainframes, and other appropriate computers. The mobile computing device 7750 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 7700 includes a processor 7702, a memory 7704, a storage device 7706, a high-speed interface 7708 connecting to the memory 7704 and multiple high-speed expansion ports 7710, and a low-speed interface 7712 connecting to a low-speed expansion port 7714 and the storage device 7706. Each of the processor 7702, the memory 7704, the storage device 7706, the high-speed interface 7708, the high-speed expansion ports 7710, and the low-speed interface 7712, are interconnected using various busses, and may be mounted on a common motherboard or in other manners as appropriate. The processor 7702 can process instructions for execution within the computing device 7700, including instructions stored in the memory 7704 or on the storage device 7706 to display graphical information for a GUI on an external input/output device, such as a display 7716 coupled to the high-speed interface 7708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 7704 stores information within the computing device 7700. In some implementations, the memory 7704 is a volatile memory unit or units. In some implementations, the memory 7704 is a non-volatile memory unit or units. The memory 7704 may also be another form of computer-readable medium, such as a magnetic or optical disk.

The storage device 7706 is capable of providing mass storage for the computing device 7700. In some implementations, the storage device 7706 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 7702), perform one or more methods, such as those described above. The instructions can also be stored by one or more storage devices such as computer- or machine-readable mediums (for example, the memory 7704, the storage device 7706, or memory on the processor 7702).

The high-speed interface 7708 manages bandwidth-intensive operations for the computing device 7700, while the low-speed interface 7712 manages lower bandwidth-intensive operations. Such allocation of functions is an example only. In some implementations, the high-speed interface 7708 is coupled to the memory 7704, the display 7716 (e.g., through a graphics processor or accelerator), and to the high-speed expansion ports 7710, which may accept various expansion cards (not shown). In the implementation, the low-speed interface 7712 is coupled to the storage device 7706 and the low-speed expansion port 7714. The low-speed expansion port 7714, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 7700 may be implemented in a number of different forms, as shown in the figure. For example, it may be implemented as a standard server 7720, or multiple times in a group of such servers. In addition, it may be implemented in a personal computer such as a laptop computer 7722. It may also be implemented as part of a rack server system 7724. Alternatively, components from the computing device 7700 may be combined with other components in a mobile device (not shown), such as a mobile computing device 7750. Each of such devices may contain one or more of the computing device 7700 and the mobile computing device 7750, and an entire system may be made up of multiple computing devices communicating with each other.

The mobile computing device 7750 includes a processor 7752, a memory 7764, an input/output device such as a display 7754, a communication interface 7766, and a transceiver 7768, among other components. The mobile computing device 7750 may also be provided with a storage device, such as a micro-drive or other device, to provide additional storage. Each of the processor 7752, the memory 7764, the display 7754, the communication interface 7766, and the transceiver 7768, are interconnected using various buses, and several of the components may be mounted on a common motherboard or in other manners as appropriate.

The processor 7752 can execute instructions within the mobile computing device 7750, including instructions stored in the memory 7764. The processor 7752 may be implemented as a chipset of chips that include separate and multiple analog and digital processors. The processor 7752 may provide, for example, for coordination of the other components of the mobile computing device 7750, such as control of user interfaces, applications run by the mobile computing device 7750, and wireless communication by the mobile computing device 7750.

The processor 7752 may communicate with a user through a control interface 7758 and a display interface 7756 coupled to the display 7754. The display 7754 may be, for example, a TFT (Thin-Film-Transistor Liquid Crystal Display) display or an OLED (Organic Light Emitting Diode) display, or other appropriate display technology. The display interface 7756 may comprise appropriate circuitry for driving the display 7754 to present graphical and other information to a user. The control interface 7758 may receive commands from a user and convert them for submission to the processor 7752. In addition, an external interface 7762 may provide communication with the processor 7752, so as to enable near area communication of the mobile computing device 7750 with other devices. The external interface 7762 may provide, for example, for wired communication in some implementations, or for wireless communication in other implementations, and multiple interfaces may also be used.

The memory 7764 stores information within the mobile computing device 7750. The memory 7764 can be implemented as one or more of a computer-readable medium or media, a volatile memory unit or units, or a non-volatile memory unit or units. An expansion memory 7774 may also be provided and connected to the mobile computing device 7750 through an expansion interface 7772, which may include, for example, a SIMM (Single In Line Memory Module) card interface. The expansion memory 7774 may provide extra storage space for the mobile computing device 7750, or may also store applications or other information for the mobile computing device 7750. Specifically, the expansion memory 7774 may include instructions to carry out or supplement the processes described above, and may include secure information also. Thus, for example, the expansion memory 7774 may be provided as a security module for the mobile computing device 7750, and may be programmed with instructions that permit secure use of the mobile computing device 7750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 7752), perform one or more methods, such as those described above. The instructions can also be stored by one or more storage devices, such as one or more computer- or machine-readable mediums (for example, the memory 7764, the expansion memory 7774, or memory on the processor 7752). In some implementations, the instructions can be received in a propagated signal, for example, over the transceiver 7768 or the external interface 7762.

The mobile computing device 7750 may communicate wirelessly through the communication interface 7766, which may include digital signal processing circuitry where necessary. The communication interface 7766 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 7768 using a radio-frequency. In addition, short-range communication may occur, such as using a Bluetooth®, WiFi™, or other such transceiver (not shown). In addition, a GPS (Global Positioning System) receiver module 7770 may provide additional navigation- and location-related wireless data to the mobile computing device 7750, which may be used as appropriate by applications running on the mobile computing device 7750.

The mobile computing device 7750 may also communicate audibly using an audio codec 7760, which may receive spoken information from a user and convert it to usable digital information. The audio codec 7760 may likewise generate audible sound for a user, such as through a speaker, e.g., in a handset of the mobile computing device 7750. Such sound may include sound from voice telephone calls, may include recorded sound (e.g., voice messages, music files, etc.) and may also include sound generated by applications operating on the mobile computing device 7750.

The mobile computing device 7750 may be implemented in a number of different forms, as shown in the figure. For example, it may be implemented as a cellular telephone 7780. It may also be implemented as part of a smart-phone 7782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A method for providing centralized management of vendor questionnaires, the method comprising the steps of:
causing to display, by the processor of the enterprise system, one or more graphical user interfaces (GUIs) associated with the one or more vendor questionnaire modules, the vendor questionnaire modules comprising one or more members selected from the group consisting of:
(i) a template management module for managing questionnaire templates;
(ii) a questionnaire management module for managing questionnaires;
(iii) a send questionnaire module for sending questionnaires to one or more vendors; and
(iv) a vendor response module for managing responses from one or more vendors; and
receiving, by a processor of an enterprise system, a first input from a first client (e.g., said first client having been authorized to access the enterprise system, e.g., said first client one member of a network of subscribed clients), the first input comprising instructions to access a selected module of the one or more vendor questionnaire modules;
receiving, by the processor of the enterprise system, subsequent input from the first client specific to the selected vendor questionnaire module; and
updating, in a memory of the enterprise system, vendor questionnaire management information stored in association with the first client, based on the subsequent input.

2. The method of claim 1, wherein the first input comprises instructions to access the template management module,
and wherein the subsequent input comprises custom data field information for a vendor questionnaire template (e.g., received via a graphical user interface widget), the custom data field information including a confidentiality statement and/or an introduction statement.

3. The method of claim 2, comprising creating, by the processor, one or more questionnaire templates incorporating the confidentiality statement and/or the introduction statement.

4. The method of claim 1, wherein the first input comprises instructions to access the questionnaire management module,
and wherein the subsequent input comprises a questionnaire selection.

5. The method of claim 4, wherein the first input comprises instructions to access the questionnaire management module, and wherein the subsequent input comprises custom data field information for a vendor questionnaire template (e.g., received via a graphical user interface widget), the custom data field information including edits to a questionnaire.

6. The method of claim 4, wherein the subsequent input comprises a questionnaire selection, wherein the selected questionnaire is created from a questionnaire template or by cloning an existing questionnaire.

7. The method of claim 1, wherein the first input comprises instructions to access the send questionnaire module,
and wherein the subsequent input comprises a recipient vendor selection (e.g., an in-network, authorized, or otherwise registered vendor).

8. The method of claim 7, wherein a subsequent input comprises, a questionnaire selection.

9. The method of claim 7, wherein the method comprises providing, to a user, an editable email template.

10. The method of claim 9, wherein a subsequent input comprises custom data field information for an email template (e.g., received via a graphical user interface widget), the custom data field information including edits to an email.

11. The method of claim 7, wherein a subsequent input comprises a send command (e.g., received via a graphical user interface widget), and wherein the method comprises attaching, by the processor, a selected questionnaire to an email message and sending, via a network, said email message to the selected vendor having a vendor email address.

12. The method of claim 11, wherein the method comprises
searching, by the processor, prior to sending the email message, the vendor email address in a database of vendor email addresses of known contacts and,
if (e.g., and only if) a match is found, releasing the email message to be sent to the vendor email address; and
optionally, if no match is found, preventing the email message from being sent to the vendor email address.

13. The method of claim 11, wherein the method comprises providing functionality to the email message that prevents the email message from being forwarded to an unauthorized recipient.

14. The method of claim 11, wherein the method comprises providing functionality to the email message that prevents the email message from being sent to a generic email address (e.g. @gmail.com, @hotmail.com).

15. The method of claim 1, wherein the first input comprises instructions to access the vendor response module,
and wherein the subsequent input comprises custom data field information for a vendor questionnaire template (e.g., received via a graphical user interface widget), the custom data field information including user comment text.

16. The method of claim 15, wherein the method comprises providing, (e.g., via the vendor response GUI), status information of each sent questionnaire (e.g., sent, completed, in progress).

17. The method of claim 15, wherein the method comprises displaying, via a vendor response GUI, a grid comprising a sortable list of sent questionnaires.
